(19) United States
(12) Patent Application Publication
(10) Pub. No.: US 2011/0055192 A1
(43) Pub. Date: Mar. 3, 2011

(54) FULL TEXT QUERY AND SEARCH SYSTEMS AND METHOD OF USE

(75) Inventors: YUANHUA TOM TANG, San Jose, CA (US); Qianjin Hu, Castro Valley, CA (US); Yonghong Grace Yang, San Jose, CA (US); Chunnuan Chen, Sunnyvale, CA (US); Minghua Mei, Wujiang (CN)

(73) Assignee: INFOVELL, INC., Menlo Park, CA (US)

(21) Appl. No.: 12/943,358

(22) Filed: Nov. 10, 2010

Related U.S. Application Data
(63) Continuation of application No. 11/740,247, filed on Apr. 25, 2007, now abandoned.
Application No. 11/740,247 is a continuation-in-part of application No. 11/259,468, filed on Oct. 25, 2005, now abandoned.
(60) Provisional application No. 60/621,616, filed on Oct. 25, 2004.
(60) Provisional application No. 60/681,414, filed on May 16, 2005.
(60) Provisional application No. 60/745,604, filed on Apr. 25, 2006.
(60) Provisional application No. 60/745,605, filed on Apr. 25, 2006.

(51) Int. Cl. G06F 17/30

(52) U.S. Cl. 707/706; 707/E17.108; 707/E17.014

(57) ABSTRACT

Roughly described, a database searching method for searching a database, in which hits are ranked in dependence upon an information measure of itoms shared by both the hit and the query. The information measure can be a Shannon information score, or another measure which indicates the information value of the shared itoms. An itom can be a word or other token, or a multi-word phrase, and can overlap with each other. Synonyms can be substituted for itoms in the query, with the information measure of substituted itoms being derated in accordance with a predetermined measure of the synonyms' similarity. Indirect searching methods are described in which hit from other search engines are re-ranked in dependence upon the information measures of shared itoms. Structured and completely unstructured databases may be searched, with hits being demarcated dynamically. Hits may be clustered based upon distances in an information-measure-weighted distance space.

### CROSS-REFERENCE TO RELATED APPLICATIONS

This application is a continuation-in-part of U.S. patent application Ser. No. 11/259,468 filed 25 Oct. 2005 entitled “FULL TEXT QUERY AND SEARCH SYSTEMS AND METHODS OF USE”, which claims the benefit of U.S. provisional application Ser. No. 60/621,616 filed 25 Oct. 2004 entitled “SEARCH ENGINES FOR TEXTUAL DATABASES WITH FULL-TEXT QUERY” and U.S. provisional application Ser. No. 60/681,414 filed 16 May 2005 entitled “FULL TEXT QUERY AND SEARCH METHODS”.

This application also claims the benefit of U.S. provisional application Ser. No. 60/745,604 filed 25 Apr. 2005 entitled “FULL-TEXT QUERY AND SEARCH SYSTEMS AND METHODS OF USE” and U.S. provisional application Ser. No. 60/745,605 filed 25 Apr. 2005 entitled “APPLICATION OF ITOMIC MEASURE THEORY IN SEARCH ENGINES”. All of the above provisional and non-provisional applications are incorporated herein by reference in their entirety.

### FIELD OF THE INVENTION

The present invention relates to information, and more particularly to methods and systems for searching for information.

### BACKGROUND

Traditional search methods for text content databases are mostly keyword-based. Namely, a text database and its associated dictionary are first established. An inverse index file for the database is derived from the dictionary, where the occurrence of each keyword and its location within the database are recorded. When a query containing the keyword is entered, a lookup in the inverse index is performed, where all entries in the database containing that keyword are returned. For a search with multiple keywords, the lookup is performed multiple times, followed by a “join” operation to find documents that contain all the keywords (or some of them). In advanced search types, a user can specify exclusion words as well, where the appearance of the specified words in an entry will exclude it from the results.

One major problem with this search method is “the huge number of hits” for one or a few limited keywords. This is especially troublesome when the database is large, or the media becomes inhomogeneous. Thus, traditional search engines limit the database content and size, and also limit the selection of keywords. In world-wide web searches, one is faced with very large database, and with very inhomogeneous data content. These limitations have to be removed. Yahoo at first attempted using classification, putting restrictions on data content and limit the database size for each specific category a use selects. This approach is very labor intensive, and puts a lot of burden on the users to navigate among the multitude of categories and sub categories.

Google addresses the “huge number of hits” problem by ranking the quality of each entry. For a web page database, the quality of an entry can be calculated by link number (how many other web pages reference this site), the popularity of the website (how many visits the page has), etc. For database of commercial advertisement, quality can be determined by amount of money paid as well. Internet users are no longer burdened by traverse the multilayered categories or limitation of keywords. Using any keyword, Google's search engine returns a result list that is “objectively ranked” by its algorithm. The Google search engine has its limitations:
Limitation on the number of search words: the number of keywords is limited (usually less than 10 words). The selection of these words will greatly impact the results. In many occasions, it may be hard to completely define a subject matter of interest by a few keywords. A user is usually faced with the dilemma of selecting the few words to search. Should a user be burdened in selecting the keywords? If they do, how should they select?
In many occasions, ranking of “hits” according to a quality is irrelevant. For example, the database is a collection of patents, legal cases, internal emails, or any of the text database where there is no “link number” allowing quality assignments. “link number” exists only for Internet contents. There is no link number for all other text databases except Internet. We need search engines for them as well.
“Huge number of hits” problem remains. It is not solved, but just hidden! The user is still faced with a huge amount of irrelevant results. The ranking sometimes may work, but in most of times, it just buries the most-wanted result very deep. Worse of all, it forces an external quality judgment onto naäve users. The results one gets are biased by link numbers. They are not really “objective”.

Thus, in solving the “huge number of hits” problem, if you are unhappy with the Google's solution, what else can you do? Which direction informational retrieval will evolve after Google?

Some conventional approaches to information searching are identified and discussed below.

1. U.S. Pat. No. 5,265,065—Turtle. Method and apparatus for information retrieval from a database by replacing domain specific stemmed phases in a natural language to create a search query

This patent proposes a method of eliminating common words (stopping words) in a query, and also using stemming to reduce query complexities. These methods are now common practice in the field. We use stopping words and stemming as well. But we went much further. Our itom concept can be viewed as an extension of the stopping word concept. Namely, by introducing a distribution function of all itoms. We can choose to eliminate common words at any level a user desires. “Common” words in our definition is no longer a fixed given collection, but a variable one depending on the threshold choosing by a user.

2. U.S. Pat. No. 5,745,602—Chen. Automatic method of selecting multi-word key phrases from a document.

This patent provides an automatic method of generating key phrases. The method begins by breaking the text of the document into multi-word phrases free of stop words which begin and end acceptably. Afterward, the most frequent phrases are selected as key word phrases. Chen's method is much simpler compare to our automated itom identification methods. We used several keyword selection methods in our program. First, in selecting keywords from query for a full-text query. We choose a certain amount of “rare” words in the Selecting keyword this way provide the best differentiator for identifying related documents in the database. In the second occasion, we have an automated program for phrase identification, or complex itom identification. For example, to identify a two-word itom we compare the observed frequency of its occurrence in the database to the expected frequency (calculated from the given the distribution frequency for each word). If the observed frequency is much higher than the expected frequency, then this two-word is an itom (phrase).

3. U.S. Pat. No. 5,765,150—Burrows. Method for statistically projecting the ranking of information

This patent assigns a score to individual pages while performing searching of a collection of web pages. The score is a cumulative number based on number of matching words and the weights on these words. One way to determine the weight w of a word is: W=log P−log N, where P is the number of pages indexed, and N is the number of pages which contain a particular word to be weighed. Commonly occurring words specified in a query will contribute negligibly to the total score or weight W of a qualified page, and pages including rare words will receive a relatively higher score. Burrows' search is limited to keyword searches. It handles the keyword with a weighting scheme that is somehow related to our scoring system. Yet the distinction is obvious. While we use a total distribution function of the entire database to assign frequency (weights), while the weights used in Burrows is a much heuristic one. The root of the weight: N/P is not a frequency. The information theoretic ideas are here in Burrows' patent, but the method is incomplete as compared to our method. We use a distribution function and its associated Shannon information to calculate the “weight”.

4. U.S. Pat. No. 5,864,845—Voorhees. Facilitating world wide web searches utilizing a multiple search engine query clustering fusion strategy

Because the search engines process queries in different ways, and because their coverage of the Web differs, the same query statement given to different engines often produces different results. Submitting the same query to multiple search engines can improve overall search effectiveness. This patent proposes an automatic method for facilitating web searches. For a single query, it combines results from different search engines to produce a single list that is more accurate than any of the individual lists from which it is built. The method of ordering the final combination is a little bit odd. While preserving the rank order from the same search engine, it mixes the results from distinct search engines by a random die. We have proposed an indirect search engine technology in our application. As we aim to be the first full-text as query search engine for the internet, we use many distinct methods. The only thing that is the same here is that both search engines employ results from different search engines. Here are some distinctions: 1) we use a sample distribution function, which is a concept totally absent from Voorhees. 2) we address the full-text as query problem as well as keyword searches, while Voorhees is only appropriate for keyword searches; 2) we have a unified ranking once the candidates from individual search engines are generated. We disregard the original order returned completely, and use our own ranking system.

5. U.S. Pat. No. 6,065,003—Sedluk. System and method for finding the closest match of a data entry

This patent proposes a search system that generates and searches a find list for matches to a search-entry. It intelligently finds the closet match of a single or multiple-word search-entry in an intelligently generated find list of single and multiple-word entries. It allows the search-entry containing spelling errors, letter transpositions, or word transpositions. This patent is a specific search engine that is good for simple word matching. It has the capacity of automatically fixing minor user query errors, and then finds the best matches in a candidate list pool. It is different from ours, as we are focused more on complex queries, Sedluk's patent is focused on simple queries. We do not use automated spelling fixes. In fact, in some occasions, spelling mistakes or grammatical mistakes contain the highest information amount, thus they provide highest Shannon information amounts. These errors are of particular interest, for example, in finding plagiarized documents, copyright violations of source codes, etc.

6. Journal publication: Karen S. Jones. 1972. A statistical interpretation of term specificity and its application in retrieval. J. of Documentation, Vol. 28, pp. 11-21.

This is the original paper where the concept of inverse document frequency (IDF) is introduced. The formula is log₂N−log₂n+1, where N is the total number of documents in collection, and n is the number of documents the term appeared. Thus, n<=N. This is based on the intuition that a query term with occurs in many documents is not a good discriminator and should be given less weight than one which occurs in documents. IDF concept and Shannon information function both use log functions to provide a measure for words based on their frequency. But the definition of frequency as in IDF is total different as we defined in our version of Shannon information amount. The denominator we have for frequency is the total number of words (or itoms), the denominator in Jones is the total number of entries in the database. This difference is very fundamental. All the theories we derived in our patents, such as distributed computing, or database search, cannot be derived from the IDF function. The relationship between IDF and Shannon information function is never clear.

7. Journal publication: Stephen Robertson. 2004. Understanding inverse document frequency: on theoretical arguments for IDF. J. of Documentation, Vol. 60, pp. 503-520.

This paper is a good review of IDF history, the scheme known generically as TF*IDF (where TF is a term frequency measure, and IDF is an inverse document frequency measure), and theoretical efforts toward reconciliation with Shannon information theory. It shows that the information theoretic approaches developed so far are problematic, but there are good justifications of both IDF and TF*IDF in traditional probabilistic model of information retrieval. Dr. Robertson recognized the difficulties in reconcile between TF*IDF approach and Shannon information theory. We think the two concepts are distinct. We totally abandoned the TF*IDF weighting, and build our theoretical bases solely on Shannon information function. So our theory is in total agreement with Shannon information. Our system can measure similarity between different articles within a database setting, whereas the TF*IDF approach is only appropriate for computing a very limited number of words or phrases. Our approach is based on simple, yet powerful assumptions, whereas the theoretical base for TF*IDF is hard to establish. As a result of this simple abstraction, the itomic measure theory has many profound applications, such as in distributed computing, in clustering analysis, in searching unstructured data, and in searching structured data. The itomic measure theory can be applied to study the search problem when order of text matters, whereas the IF*IDF approach has not addressed this type of problem.

Given the above and other shortcomings of the above approaches, a need remains in the art for the teachings of the present invention.

Co-pending application Ser. No. 11/259,468 dramatically advanced the state of the art of information searching.

The present invention extends the teachings of the co-pending application to solve these and other problems, and addresses many other needs in the art.

### SUMMARY

Roughly described, in an aspect of the invention, a database searching method ranks hits in dependence upon an information measure of itoms shared by both the hit and the query. An information measure is a kind of importance measure, but excludes importance measures like the number of incoming citations, a la Google. Rather, an information measure attempts to indicate the information value of a hit. The information measure can be a Shannon information score, or another measure which indicates the information value of the shared itoms. An itom can be a word or other token, or a multi-word phrase, and can overlap with each other. Synonyms can be substituted for itoms in the query, with the information measure of substituted itoms being derated in accordance with a predetermined measure of the synonyms' similarity. Indirect searching methods are described in which hit from other search engines are re-ranked in dependence upon the information measures of shared itoms. Structured and completely unstructured databases may be searched, with hits being demarcated dynamically. Hits may be clustered based upon distances in an information-measure-weighted distance space.

An embodiment of the invention provides a search engine for text-based databases, the search engine comprising an algorithm that uses a query for searching, retrieving, and ranking text, words, phrases, Itoms, or the like, that are present in at least one database. The search engine uses ranking based on Shannon information score for shared words or Itoms between query and hits, ranking based on p-values, calculated Shannon information score, or p-value based on word or Itom frequency, percent identity of shared words or Itoms.

Another embodiment of the invention provides a text-based search engine comprising an algorithm, the algorithm comprising the steps of: i) means for comparing a first text in a query text with a second text in a text database, ii) means for identifying the shared Itoms between them, and iii) means for calculating a cumulative score or scores for measuring the overlap of information content using a Itom frequency distribution, the score selected from the group consisting of cumulative Shannon Information of the shared Itoms, the combined p-value of shared Itoms, the number of overlapping words, and the percentage of words that are overlapping.

In one embodiment the invention provides a computerized storage and retrieval system of text information for searching and ranking comprising: means for entering and storing data as a database; means for displaying data; a programmable central processing unit for performing an automated analysis of text wherein the analysis is of text, the text selected from the group consisting of full-text as query, webpage as query, ranking of the hits based on Shannon information score for shared words between query and hits, ranking of the hits based on p-values, calculated Shannon information score or p-value based on word frequency, the word frequency having been calculated directly for the database specifically or estimated from at least one external source, percent identity of shared Itoms, Shannon Information score for shared Itoms between query and hits, p-values of shared Itoms, percent identity of shared Itoms, calculated Shannon Information score or p-value based on Itom frequency, the Itom frequency having been calculated directly for the database specifically or estimated from at least one external source, and wherein the text consists of at least one word. In an alternative embodiment, the text consists of a plurality of words. In another alternative embodiment, the query comprises text having word number selected from the group consisting of 1-14 words, 15-20 words, 20-40 words, 40-60 words, 60-80 words, 80-100 words, 100-200 words, 200-300 words, 300-500 words, 500-750 words 750-1000 words, 1000-2000 words, 2000-4000 words, 4000-7500 words, 7500-10,000 words, 10,000-20,000 words, 20,000-40,000 words, and more than 40,000 words. In a still further embodiment, the text consists of at least one phrase. In a yet further embodiment, the text is encrypted.

In another embodiment the system comprises system as disclosed herein and wherein the automated analysis further allows repeated Itoms in the query and assigns a repeated Itom with a higher score. In a preferred embodiment, the automated analysis ranking is based on p-value, the p-value being a measure of likelihood or probability for a hit to the query for their shared Itoms and wherein the p-value is calculated based upon the distribution of Itoms in the database and, optionally, wherein the p-value is calculated based upon the estimated distribution of Itoms in the database. In an alternative, the automated analysis ranking of the hits is based on Shannon Information score, wherein the Shannon Information score is the cumulative Shannon Information of the shared Itoms of the query and the hit. In another alternative, the automated analysis ranking of the hit is based on percent identity, wherein percent identity is the ratio of 2*(shared Itoms) divided by the total Itoms in the query and the hit

In another embodiment of the system disclosed herein, counting Itoms within the query and the hit is performed before stemming. Alternatively, counting Itoms within the query and the hit is performed after stemming. In another alternative, counting Itoms within the query and the hit is performed before removing common words. In yet another alternative, counting Itoms within the query and the hit is performed after removing common words.

In a still further embodiment of the system disclosed herein ranking of the hits is based on a cumulative score, the cumulative score selected from the group consisting of on p-value, Shannon Information score, and percent identity. In one preferred embodiment, the automated analysis assigns a fixed score for each matched word and a fixed score for each matched phrase.

In another embodiment of the system, the algorithm further comprises means for presenting the query text with the hit text on a visual display device and wherein the shared text is highlighted.

In another embodiment the database further comprises a list of synonymous words and phrases.

In a yet other embodiment of the system, the algorithm allows a user to input synonymous words to the database, the synonymous words being associated with a relevant query and included in the analysis. In another embodiment the algorithm accepts text as a query without soliciting a keyword, wherein the text is selected from the group consisting of an abstract, a title, a sentence, a paper, an article, and any part thereof. In the alternative, the algorithm accepts text as a query without soliciting a keyword, wherein the text is selected from the group consisting of a webpage, a webpage URL address, a highlighted segment of a webpage, and any part thereof.

In one embodiment of the invention, the algorithm analyzes a word wherein the word is found in a natural language. In a preferred embodiment the language is selected from the group consisting of Chinese, French, Japanese, German, English, Irish, Russian, Spanish, Italian, Portuguese, Greek, Polish, Czech, Slovak, Serbo-Croat, Romanian, Albanian, Turkish, Hebrew, Arabic, Hindi, Urdu, That, Togalog, Polynesian, Korean, Viet, Laosian, Kmer, Burmese, Indonesian, Swedish, Norwegian, Danish, Icelandic, Finnish, Hungarian, and the like.

In another embodiment of the invention, the algorithm analyzes a word wherein the word is found in a computer language. In a preferred embodiment, the language is selected from the group consisting of C/C++/C#, JAVA, SQL, PERL, PHP, and the like.

Another embodiment of the invention provides a processed text database derived from an original text database, the processed text database having text selected from the group consisting of text having common words filtered-out, words with same roots merged using stemming, a generated list of Itoms comprising words and automatically identified phrases, a generated distribution of frequency or estimated frequency for each word, and the Shannon Information associated with each Itom calculated from the frequency distribution.

In another embodiment of the system disclosed herein, the programmable central processing unit further comprises an algorithm that screens the database and ignores text in the database that are most likely not relevant to the query. In a preferred embodiment, the screening algorithm further comprises reverse index lookup where a query to the database quickly identifies entries in the database that contain certain words that are relevant to the query.

Another embodiment of the invention provides a search engine process for searching and ranking text, the process comprising the steps of i) providing the computerized storage and retrieval system as disclosed herein; ii) installing the text-based search engine in the programmable central processing unit; and iii) inputting text, the text selected from the group consisting of text, full-text, or keyword; the process resulting in a searched and ranked text in the database.

Another embodiment of the invention provides a method for generating a list of list of phrases, their distribution frequency within a given text database, and their associated Shannon Information score, the method comprising the steps of i) providing the system disclosed herein; ii) providing a threshold frequency for identifying successive words of fixed length of two words, within the database as a phrase; iii) providing distinct threshold frequencies for identifying successive words of fixed length of 3, 4, 5, 6, 7, 8, 9, 10, 11, 12, 13, 14, 15, 16, 17, 18, 19, and 20 words within the database as a phrase; iv) identifying the frequency value of each identified phrase in the text database; v) identifying at least one Itom; and vi) adjusting the frequency table accordingly as new phrases of fixed length are identified such that the component Itoms within an identified Itom will not be counted multiple times, thereby generating a list of phrases, their distribution frequency, and their associated Shannon Information score.

Another embodiment of the invention provides a method for comparing two sentences to find similarity between them and provide similarity scores wherein the comparison is based on two or more items selected from the group consisting of word frequency, phrase frequency, the ordering of the words and phrases, insertion and deletion penalties, and utilizing substitution matrix in calculating the similarity score, wherein the substitution matrix provides a similarity score between different words and phrases.

Another embodiment of the invention provides a text query search engine comprising means for using the methods disclosed herein, in either full-text as query search engine or webpage as query search engine.

Another embodiment of the invention provides a search engine comprising the system disclosed herein, the database disclosed herein, the search engine disclosed herein, and the user interface, further comprising a hit, the hit selected from the group consisting of hits ranked by website popularity, ranked by reference scores, and ranked by amount of paid advertisement fees. In one embodiment, the algorithm further comprises means for re-ranking search results from other search engines using Shannon Information for the database text or Shannon Information for the overlapped words. In another embodiment, the algorithm further comprises means for re-ranking search results from other search engines using a p-value calculated based upon the frequency distribution of Itoms within the database or based upon the frequency distribution of overlapped Itoms.

Another embodiment of the invention provides a method for calculating the Shannon Information for the repeated Itoms in query and in hit, the method comprising the step of calculating the score S using the equation S=min(n,m)*S_{w}, wherein S_{w} is the Shannon Information of the Itom and wherein the number of times a shared Itom is in the query is m and the number of times the shared Itom is in the hit is n.

Another embodiment of the invention provides a method for ranking advertisements using the full-text search engine disclosed herein, the search engine process disclosed herein, the Shannon Information score, and the method for calculating the Shannon Information disclosed above, the method further comprising the step of creating an advertisement database. In one embodiment, the method for ranking the advertisement further comprises the step of outputting the ranking to a user via means selected from the group consisting of a user interface and an electronic mail notification.

Another embodiment of the invention provides a method for charging customers using the methods of ranking advertisements and that is based upon the word count in the advertisement and the number of links clicked by customers to the advertiser's site.

Another embodiment of the invention provides a method for re-ranking the outputs from a second search engine, the method further comprising the steps of i) using a hit form the second search engine as a query; and ii) generating a re-ranked hit using the method for claim 26, wherein the searched database is limited to all the hits that had been returned by the second search engine.

Another embodiment of the invention provides a user interface that further comprises a first virtual button in virtual proximity to at least one hit and wherein when the first virtual button is clicked by a user, the search engine uses the hit as a query to search the entire database again resulting in a new result page based on that hit as query. In another alternative, the user interface further comprises a second virtual button in virtual proximity to at least one hit and wherein when the second virtual button is clicked by a user, the search engine uses the hit as a query to re-rank all of the hits in the collection resulting in a new result page based on that hit as query. In one embodiment, the user interface further comprises a search function associated with a web browser and a third virtual button placed in the header of the web browser. In another embodiment, the third virtual button is labeled “search the internet” such that when the third virtual button is clicked by a user the search engine will use the page displayed as a query to search the entire Internet database.

Another embodiment of the invention provides a computer comprising the system disclosed herein and the user interface, wherein the algorithm further comprises the step of searching the Internet using a query chosen by a user.

Another embodiment of the invention provides a method for compressing a text-based database comprising unique identifiers, the method comprising the steps of: i) generating a table containing text; ii) assigning an identifier (ID) to each text in the table wherein the ID for each text in the table is assigned according to the space-usage of the text in the database, the space-usage calculated using the equation freq(text)*length(text); and iii) replacing the text in the table with the IDs in a list in ascending order, the steps resulting in a compressed database. In a preferred embodiment of the method, the ID is an integer selected from the group consisting of binary numbers and integer series. In another alternative, the method further comprises compression using a zip compression and decompression software program. Another embodiment of the invention provides a method for decompressing the compressed database, the method comprising the steps of i) replacing the ID in the list with the corresponding text, and ii) listing the text in a table, the steps resulting in a decompressed database.

Another embodiment of the invention provides a full-text query and search method comprising the compression method as disclosed herein further comprising the steps of i) storing the databases on a hard disk; and ii) loading the disc content into memory. In another embodiment the full-text query and search method further comprises the step of using various similarity matrices instead of identity mapping, wherein the similarity matrices define Itoms and their synonyms, and further optionally providing a similarity coefficient between 0 and 1, wherein 0 means no similarity and 1 means identical.

In another embodiment the method for calculating the Shannon Information further comprises the step of clustering text using the Shannon information. In one embodiment, the text is in format selected from the group consisting of a database and a list returned from a search.

Another embodiment of the invention provides the system herein disclosed and the method for calculating the Shannon Information further using Shannon Information for keyword based searches of a query having less than ten words wherein the algorithm comprises the constants selected from the group consisting of a damping coefficient constant α, where 0<=α<=1 and a damping location coefficient constant β, where 0<=β<=1, and wherein the total score is a function of the shared Itoms, total query Itom number K, and the frequency of each Itom in the hit, and α and β. In one embodiment, the display further comprises multiple segments for a hit and the segmentation determined according to the feature selected from the group consisting of a threshold feature wherein the segment has a hit to the query above that threshold, a separation distant feature wherein there is significant word separating the two segments, and at an anchor feature at or close to both the beginning and ending of the segment, wherein the anchor is a hit word.

In one alternative embodiment the system herein disclosed and the method for calculating the Shannon Information are used for screening junk electronic mail.

In another alternative embodiment the system herein disclosed and the method for calculating the Shannon Information are used for screening important electronic mail.

As information amount increases, the need for accurate information retrieval increases. Current search engines are mostly keyword and Boolean-logic based. If a database is large, for most queries, these keyword-based search engines return huge number of records ranked in various flavors. We propose a new search concept, called “full-text as query search”, or “content search”, or “long-text search”. Our search is not limited to matching a few keywords, but measures similarity between a query and all entries in the database, and rank them based on a global similarity score or a localized similarity score within a window or segment where the similarity with the query is significant. The comparison is performed at the level of itoms, which can (in various embodiments) constitute words, phrases, or concepts represented by words and phrases. Itoms can be imported externally from word/phrase dictionaries, and/or they can be generated by automated algorithms. Similarity scores (global and local) are calculated by the summation of the Shannon information amount for all matched or similar itoms. Compared with existing technology, we have no limit on number of query keywords, no limit on database content except that it is textual, no limitation on language or the understanding of semantics, and it can handle large database sizes. Most importantly, our search engine calculates the informational relevance between a query and its hits objectively and ranks the hits based on this informational relevance.

In this application we disclose the method for automated itom identification, localized similarity score calculation, employing similarity matrix to measure itoms that are related, and generating similarity scores from distributed databases. We defined a distance function that measures the differences in informational space. This distance function can be used to cluster collections of related entries, especially the output from a query. As an example, we show examples of how we apply our search engine to Chinese database searches. We also provide methods for distributed computing, and for database updating.

As information amount increases, the need for accurate information retrieval increases. Current search engines are mostly keyword and Boolean-logic based. If a database is large, for most queries, these keyword-based search engines return huge number of records ranked in various flavors. We propose a new search concept, called “full-text as query search”, or “content search”, or “long-text search”. Our search is not limited to matching a few keywords, but measures similarity between a query and all entries in the database, and rank them based on a global similarity score or a localized similarity score within a window or segment where the similarity with the query is significant. The comparison is performed at the level of itoms, which are defined as words, phrases, and concepts represented by words and phrases. Itoms can be imported externally from word/phrase dictionaries, or/and they can be generated by automated algorithms. Similarity scores (global and local) are calculated by the summation of the Shannon information amount for all matched or similar itoms. Compared with existing technology, we have no limit on number of query keywords, no limit on database content except that it is textual, no limitation on language or the understanding of semantics, and it can handle large database sizes. Most importantly, our search engine calculates the informational relevance between a query and its hits objectively and ranks the hits based on this informational relevance.

In this patent application, we will first review the key components of itomic measure theory for information management as described in the co-pending application. We then provide a list of potential applications of this itomic measure theory. Some are basic application such as scientific literature search or patent search for prior arts, email screening for junk mails, identifying job candidates by measuring job description against candidate resumes. Other applications are more advanced. This includes an indirect Internet search engine; search engine for unstructured data, such as data distributed in a cluster of clients; search engine for structured data, such as relational databases; search engine for ordered itomic data; and the concept of search by example. Finally, we extend the applications to non-text data content.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

The FIG. 1 illustrates how the hits are ranked according to overlapping Itoms in the query and the hit.

FIG. 2 is a schematic flow diagram showing how one exemplary embodiment of the invention is used.

FIG. 3 is a schematic flow diagram showing how another exemplary embodiment of the invention is used.

FIG. 4 illustrates an exemplary embodiment of the invention showing three different methods for query input.

FIG. 5 illustrates an exemplary output display listing hits that were identified using the query text passage using the query of FIG. 4.

FIG. 6 illustrates a comparison between the query text passage and the hit text passage showing shared words, the comparison being accessed through a link in the output display of FIG. 5.

FIG. 7 illustrates a table showing the evaluated SI_score for individual words in the query text passage compared with the same words in the hit text passage, the table being accessed through a link in the output display of FIG. 5.

FIG. 8 illustrates the exemplary output display listing shown in FIG. 5 sorted by percentage identity.

FIG. 9 illustrates an alternative exemplary embodiment of the invention showing three different methods for query input wherein the output displays a list of non-interactive hits sorted by SI_score.

FIG. 10 illustrates an alternative exemplary embodiment of the invention showing one method for query input of a URL address that is then parsed and used as a query text passage.

FIG. 11 illustrates the output using the exemplary URL of FIG. 10.

FIG. 12 illustrates an alternative exemplary embodiment of the invention showing one method for query input of a keyword string that is used as a query text passage.

FIG. 13 illustrates the output using the exemplary keywords of FIG. 12.

FIG. 14 is a screenshot of a user login page for access to our full-text as query search engine. A user can create his own account, and can obtain his password if he forgets;

FIG. 15A is a screenshot of a keyword query to the Medline database. On the top of the main page (not visible here) a user can select the database he wants to search. In this case, the user selected MEDLINE database. He inputs some keywords for his search. On the bottom of the page, there is links to US-PTO, Medline, etc. These links bring user to the main query pages of these external databases;

FIG. 15B is a screenshot of the summary response page from the keyword query. On the left side the “Primary_id” column has a link (called left-link, or highlight link). It points to the highlight page (FIG. 15C below). The middle link is the external data link (source of the data in MedLine in this case), and the “SI_score” column, (called the right link, or the itom list link) is a list of matched itoms and their information amounts. Last column shows the percentage of word matching;

FIG. 15C is a screenshot wherein left-link showing matched keywords between query and hit. The query words are listed on top of the page (not visible here). The matching keywords are highlighted in red color;

FIG. 15D is a screenshot showing the itom-list link, also known as the right-link. It lists all the itoms (keywords in this case), their information amount, frequency in query and in hit, and how much it contributed toward the Shannon information score in each time of its occurrences. The SI_score for each occurrence is different is because of the implementation of information damping in keyword-based searches;

FIG. 16A is a screenshot showing a full-text query in another search. Here the user's input is a full-text taking from the abstract of a published paper. The user selected to search US-PTO patent database this time;

FIG. 16B is a screenshot showing a summary page from a full-text as query search against the US-PTO database (containing both the published applications and issued patents). The first column contains the primary_id, or the patent/application ids, and has a link, called the left-link, the highlight link, or the alignment link. The second column is the title and additional meta-data for the patent/application, and has a link to the US-PTO abstract page. The third column is the Shannon information score, and has a link to itom list page. The last column is the percent identity column;

FIG. 16C is a screenshot illustrating a Left-link, or the alignment link showing the alignment of query text next to the hit text. Matching itoms are high-lighted. A highlighted text in red color indicates a matching word; and a highlighted text in blue color indicates a matching phrase;

FIG. 16D is a screenshot illustrating the middle link page, or the title link page. It points to the external source of the data, in this case it is an article appeared in Genomics;

FIG. 16E is a screenshot illustrating the itom-list link, or the right-link. It lists all the matched itoms between the query and hits. The information amount of each itom, their frequency in query and in hit, and their contribution to the total amount of Shannon information in the final SI_score;

FIG. 17A is a screenshot illustrating an example of searching using a Chinese BLOG database with localized alignments. This is the query page;

FIG. 17B is a screenshot illustrating a summarized return page from the query in 17A. The right-side contain 3 columns: the localized score, the percent of itoms identical, and the global score is on the right-most column;

FIG. 17C is a screenshot illustrating an alignment page showing the first high-scoring window. Red colored characters mean a character match; blue colored characters are phrases;

FIG. 17D is a screenshot illustrating a right link from the localized score, showing matching itoms in the first high scoring window;

FIG. 17E is a screenshot showing the high-scoring window II from the same search. Here is the alignment page for this HSW from the left link;

FIG. 17F is a screenshot showing matching itoms from the HSW 2. This page is obtained by clicking the right-side link on “localized score”;

FIG. 17G is a screenshot showing a list of itoms from the right-most link, showing matched itoms and their contribution to the global score;

FIG. 18A is a diagram illustrating a function of information d(A,B);

FIG. 18B is a diagram illustrating a centroid of data points;

FIG. 18C is a schematic dendrogram illustrating a hierarchical relationship among data points;

FIG. 19 illustrates a distribution function of a database.

FIG. 20A is a diagram of an outline of major steps in our indexer in accordance with an embodiment.

FIG. 20B is a diagram of sub steps in identifying an n-word itom in accordance with an embodiment.

FIG. 20C is a diagram showing how the inverted index file (aka reverse index file) is generated in accordance with an embodiment.

FIG. 21A illustrates an overall architecture of a search engine in accordance with an embodiment.

FIG. 21B is a diagram showing a data flow chart of a search engine in accordance with an embodiment.

FIG. 22A illustrates psuedocode of distinct itom parser rules in accordance with an embodiment.

FIG. 22B illustrates psuedocode of itom selection and sorting rules in accordance with an embodiment.

FIG. 22C illustrates psuedocode of classifying words in query itoms into 3 levels in accordance with an embodiment.

FIG. 22D illustrates psuedocode of generating candidates and computing hit-scores in accordance with an embodiment.

FIG. 23A is a screenshot of a user login page in accordance with an embodiment.

FIG. 23B is a screenshot of a main query page in accordance with an embodiment.

FIG. 23C is a screenshot of a “Search Option” link in accordance with an embodiment.

FIG. 23D is a screenshot of a sample results summary page in accordance with an embodiment.

FIG. 23E is a screenshot of a highlighting page for a single hit entry in accordance with an embodiment.

FIG. 24 illustrates an overall architecture of Federated Search in accordance with an embodiment.

FIG. 25A is a screenshot of a user interface for a Boolean-like search in accordance with an embodiment.

FIG. 25B is a screenshot of a Boolean-like query interface for unstructured data in accordance with an embodiment.

FIG. 25C is a screenshot of a Boolean-like query interface for structured databases with text fields in accordance with an embodiment.

FIG. 25D is a screenshot of an advanced query interface to USPTO in accordance with an embodiment.

FIG. 26 is a screenshot of a cluster view of search results in accordance with an embodiment.

FIG. 27 illustrates a database indexing “system”, searching “system”, and user “system”, all connectable together via a network in accordance with an embodiment.

FIG. 28 illustrates a schematic diagram of a distributed computer environment in accordance with an embodiment.

FIG. 29 is a screenshot of an output from a stand-alone clustering based on itomic-distance in accordance with an embodiment.

FIG. 30 is a screenshot of a graphical display of clusters and their relationship in accordance with an embodiment.

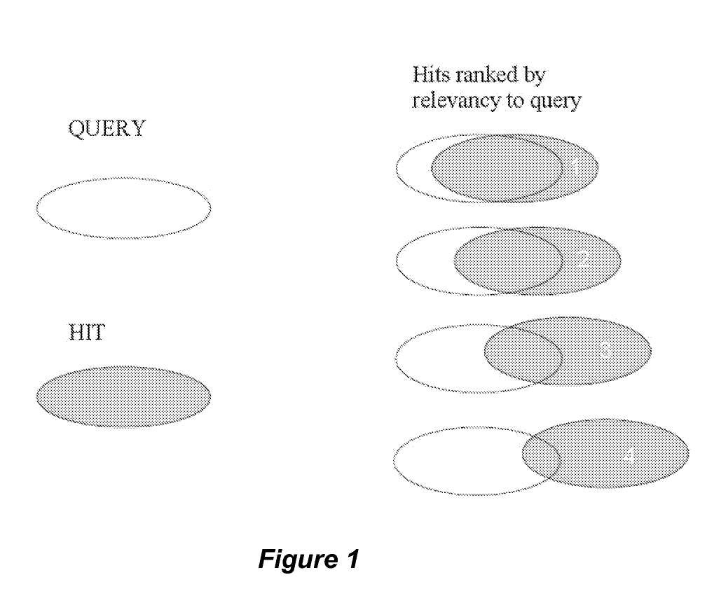

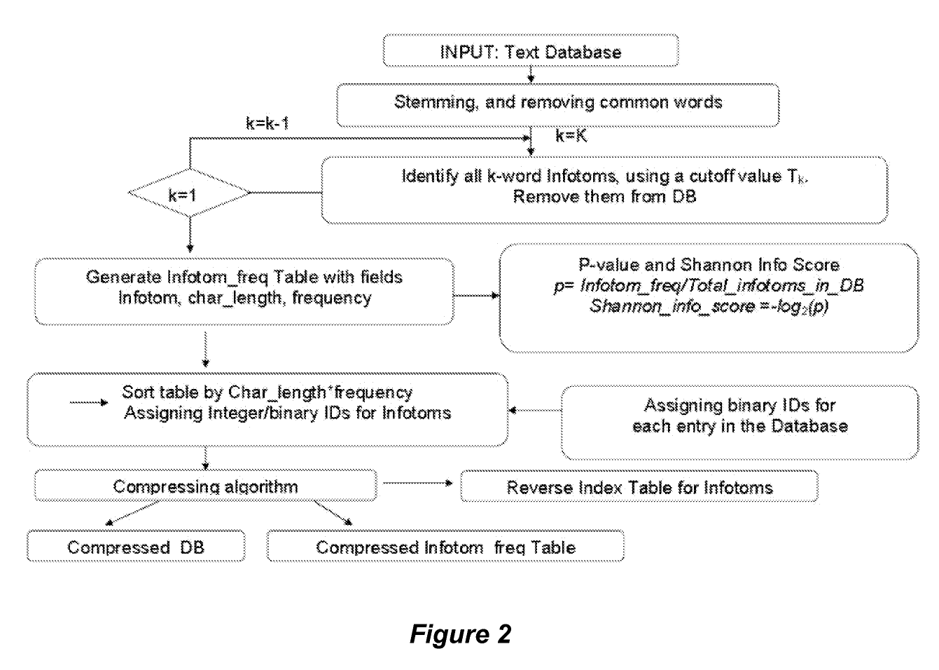

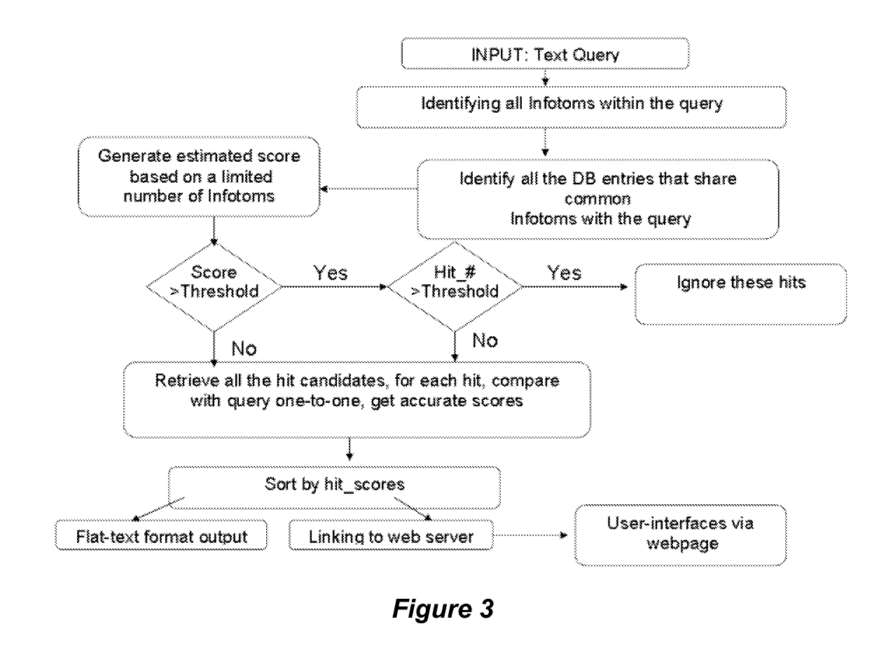

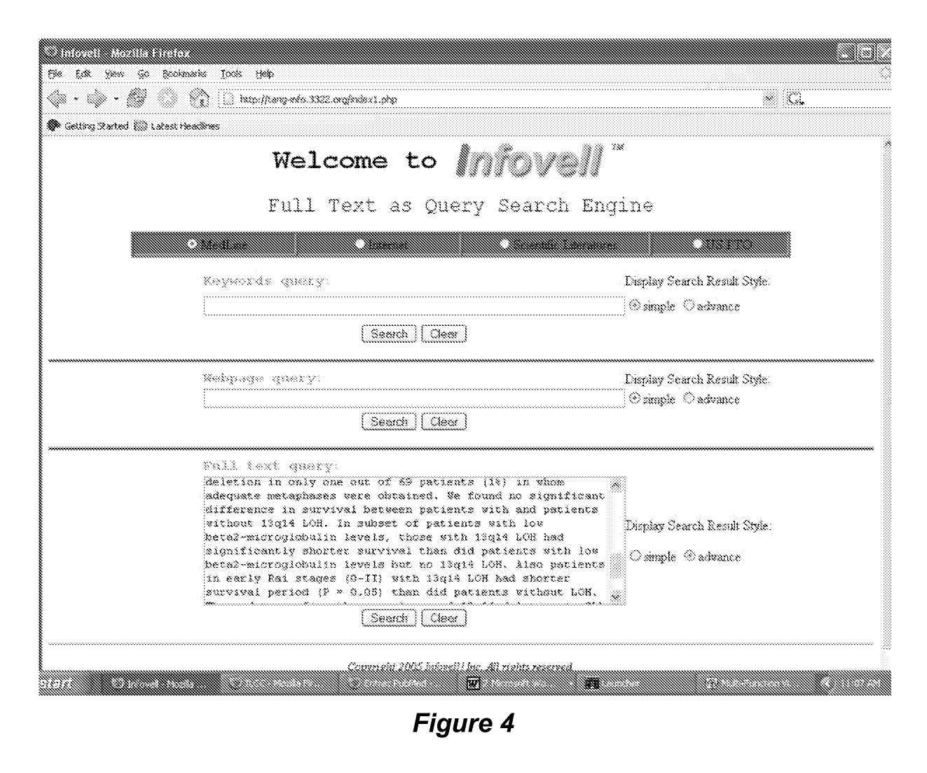

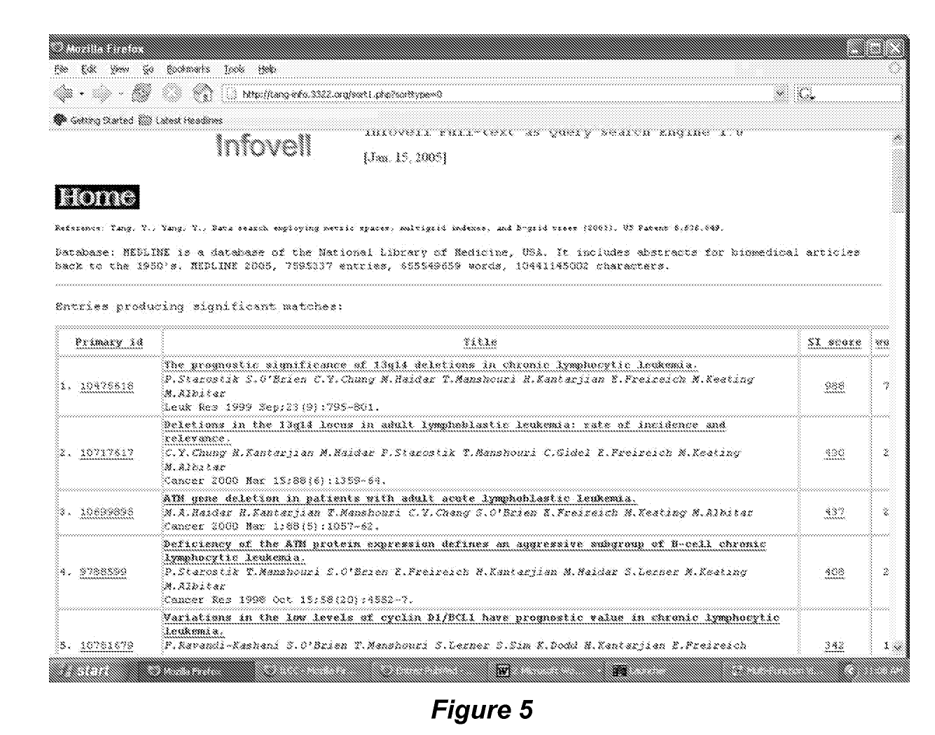

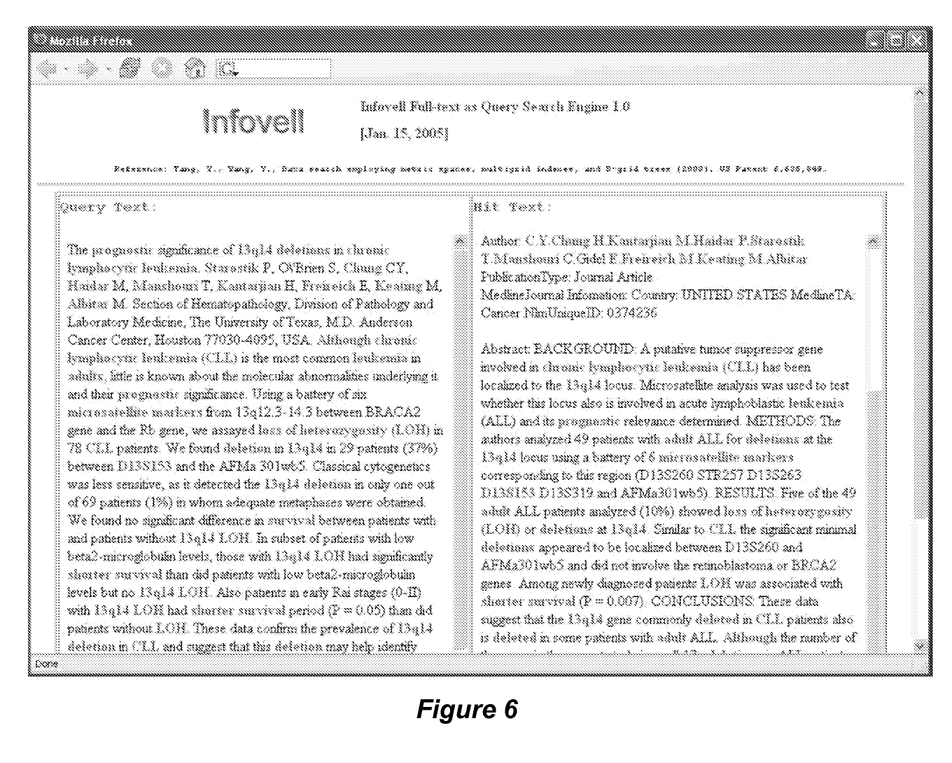

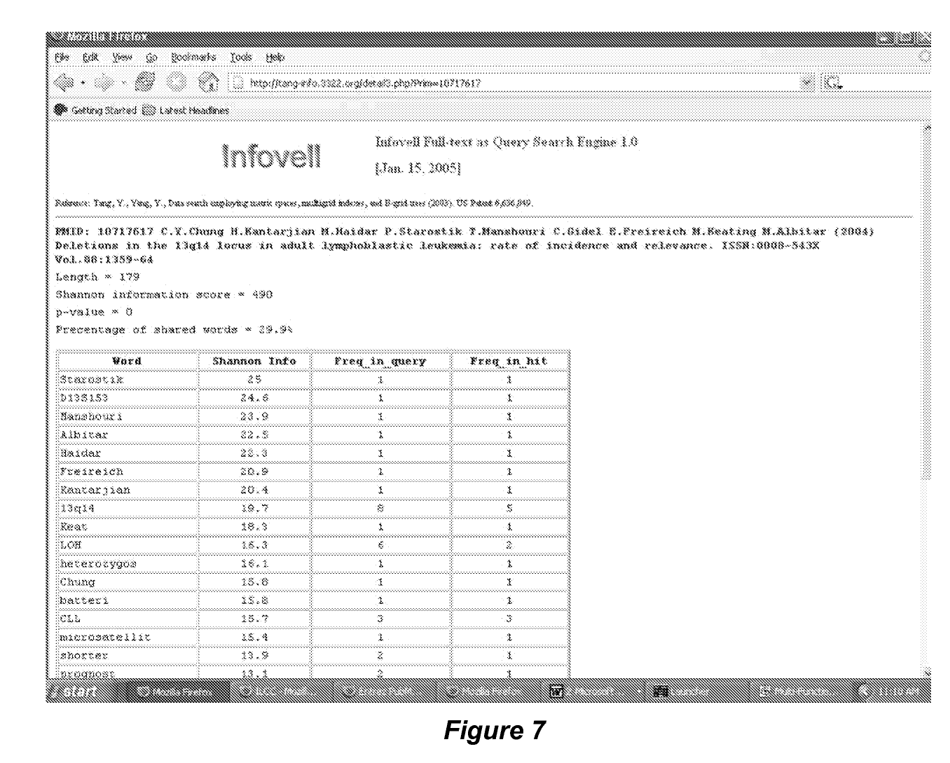

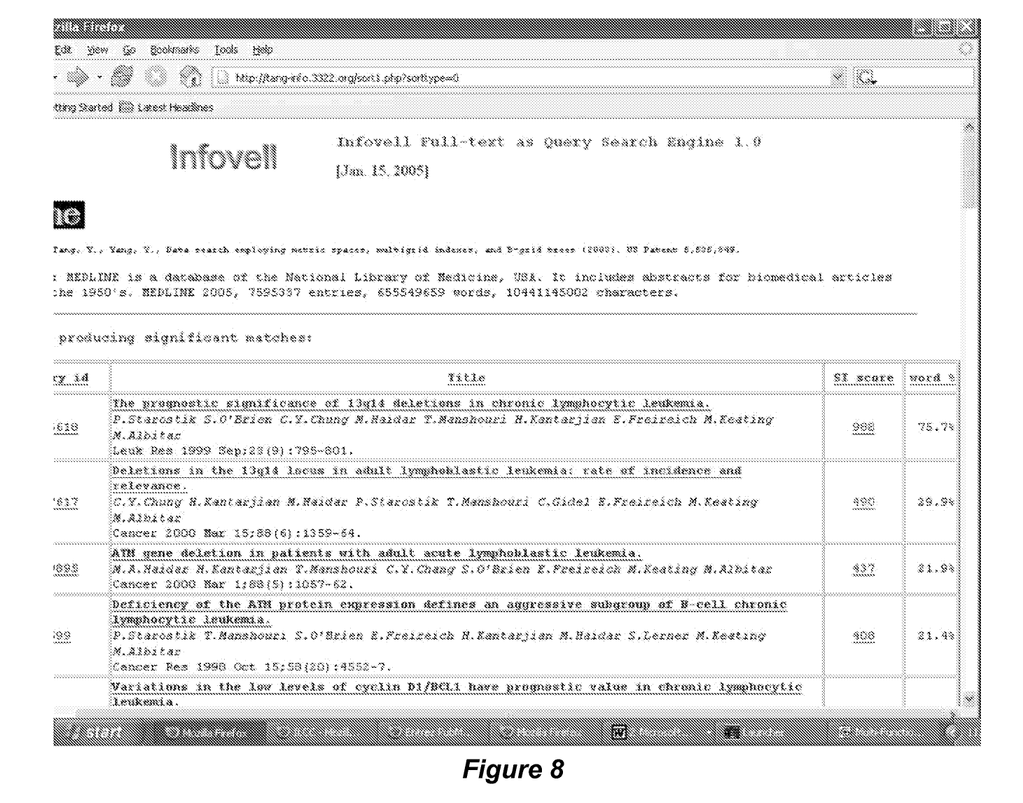

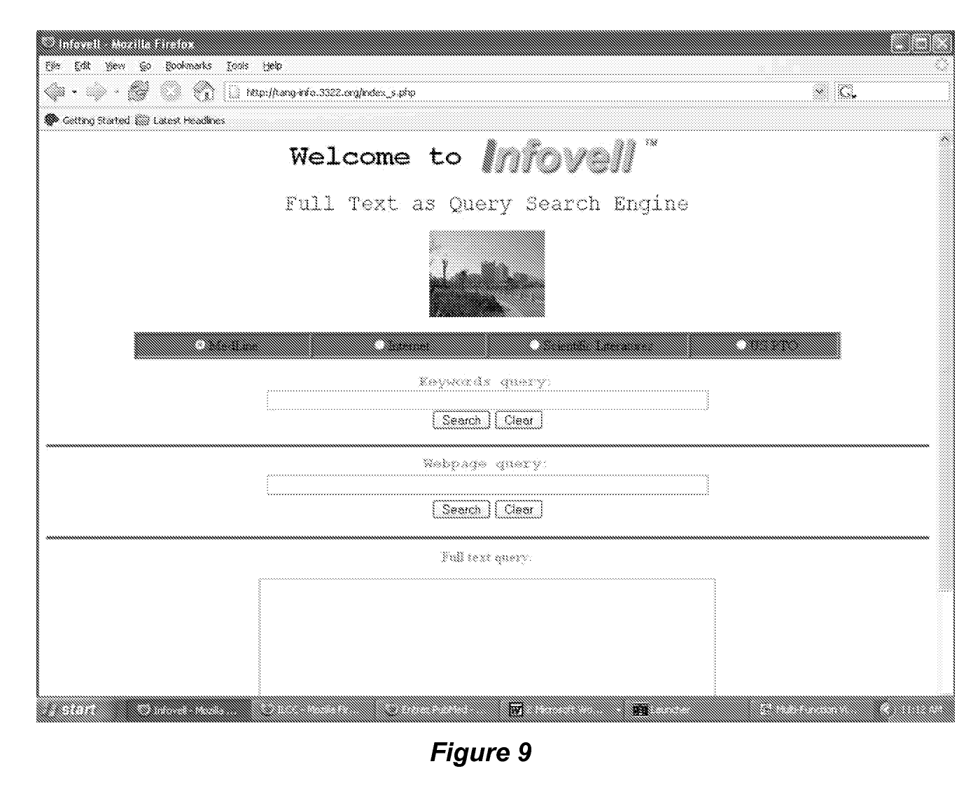

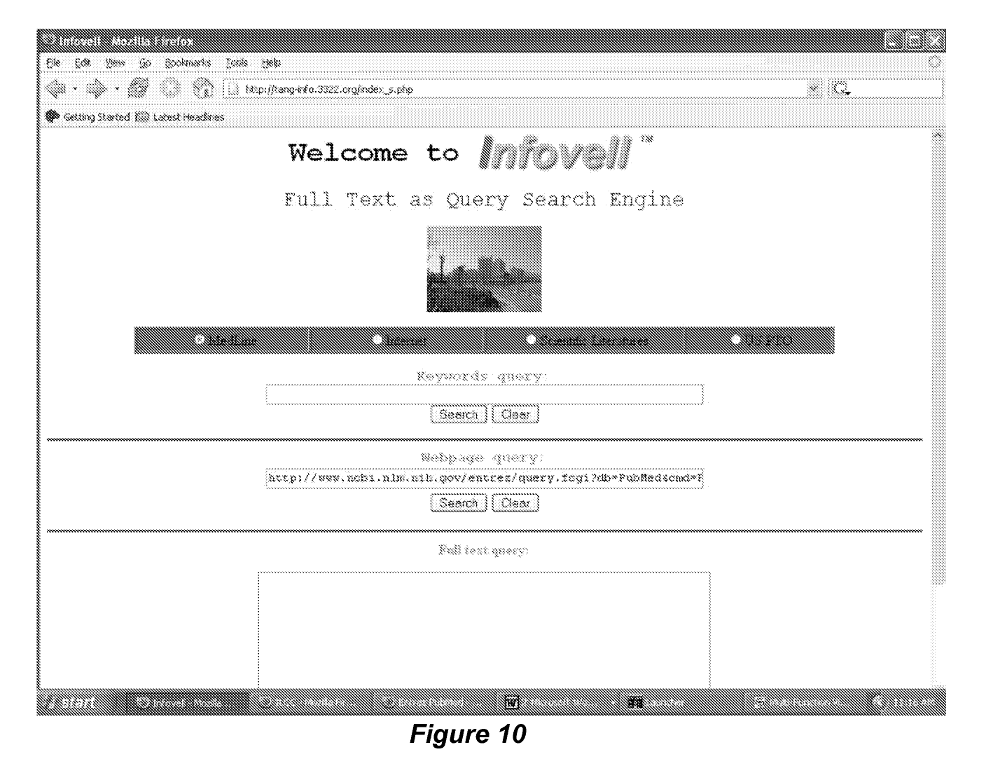

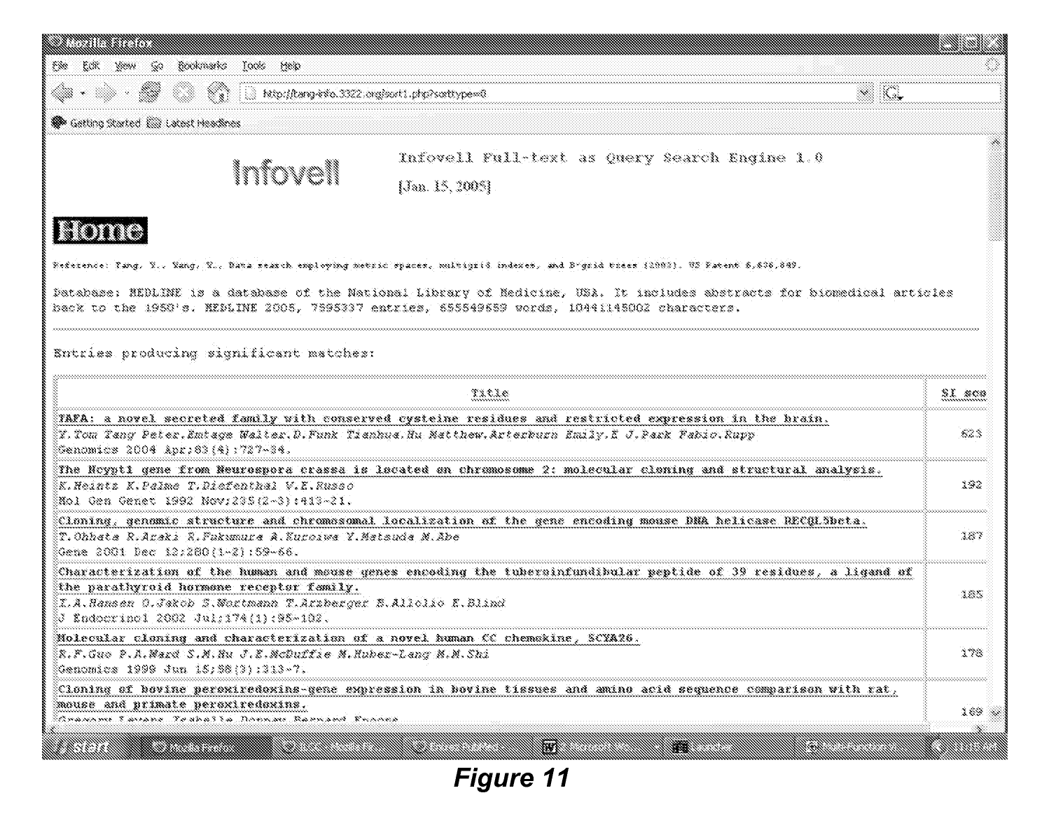

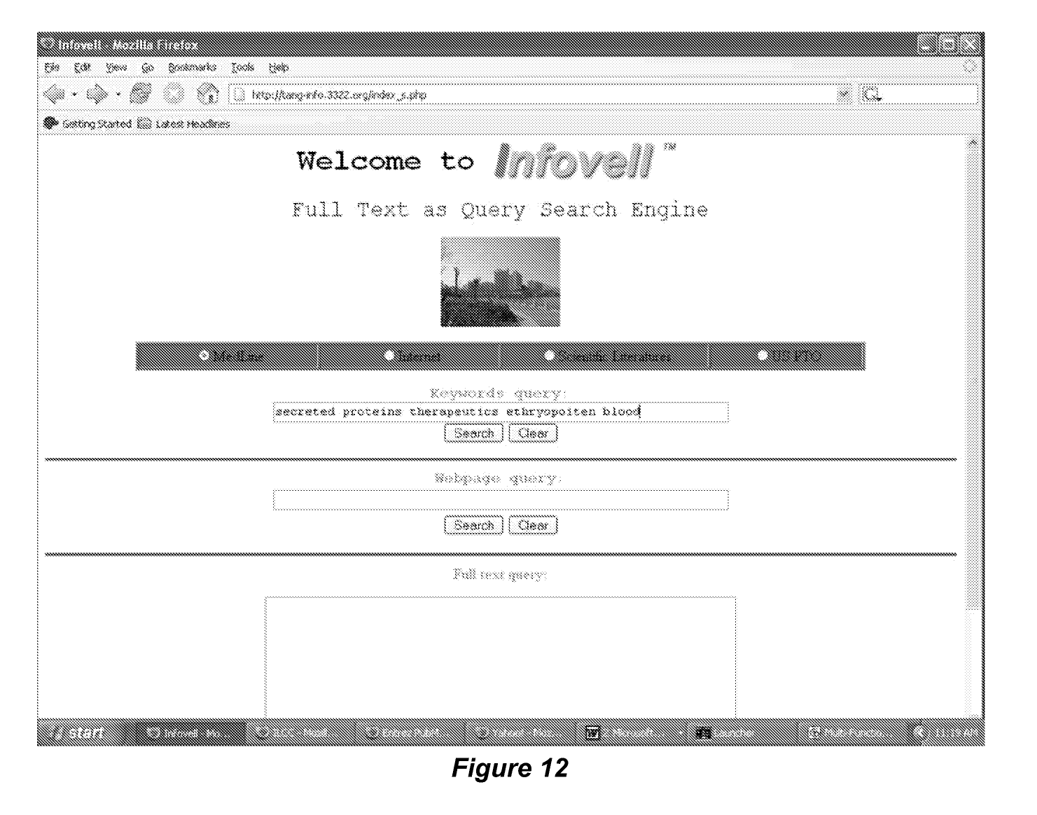

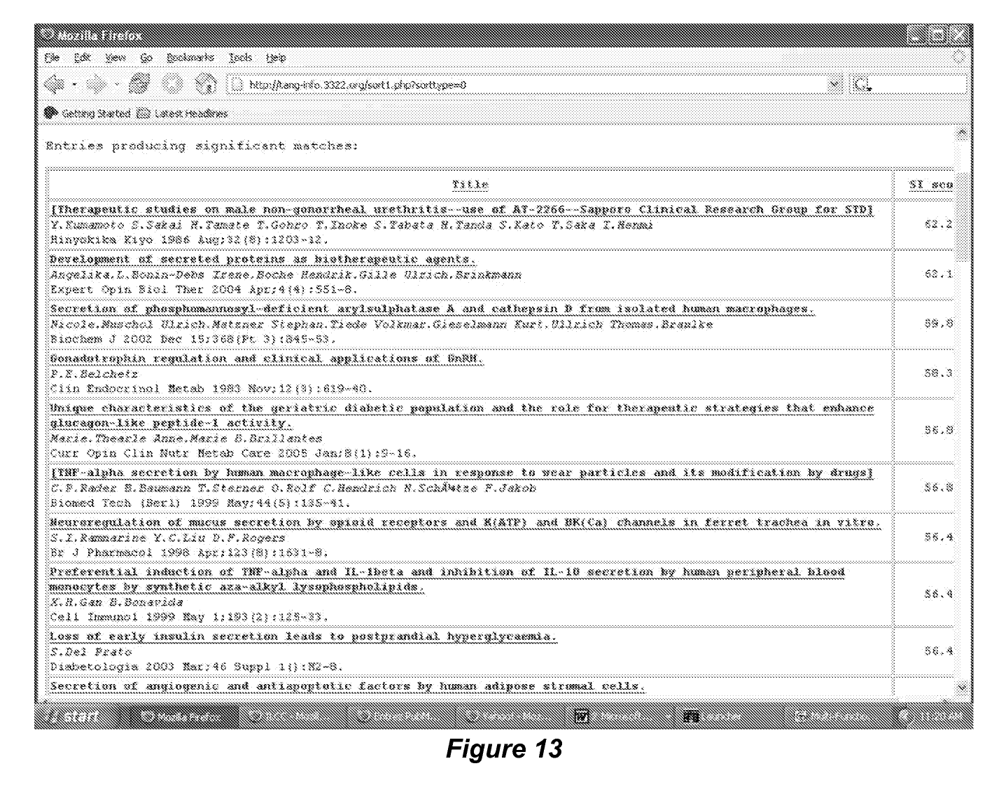

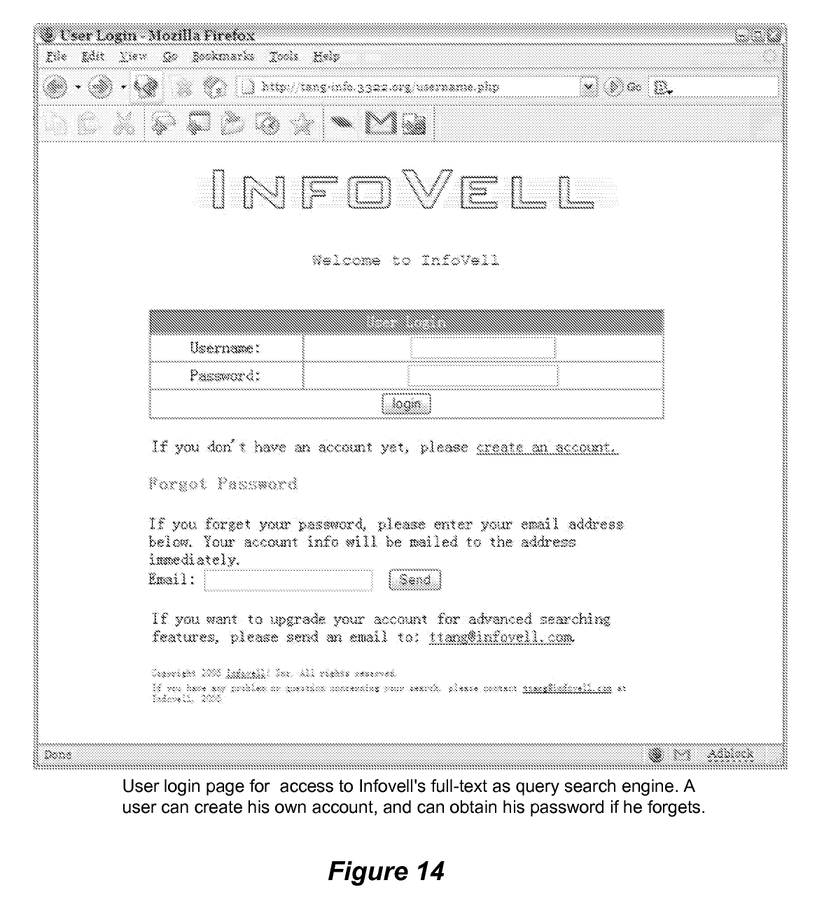

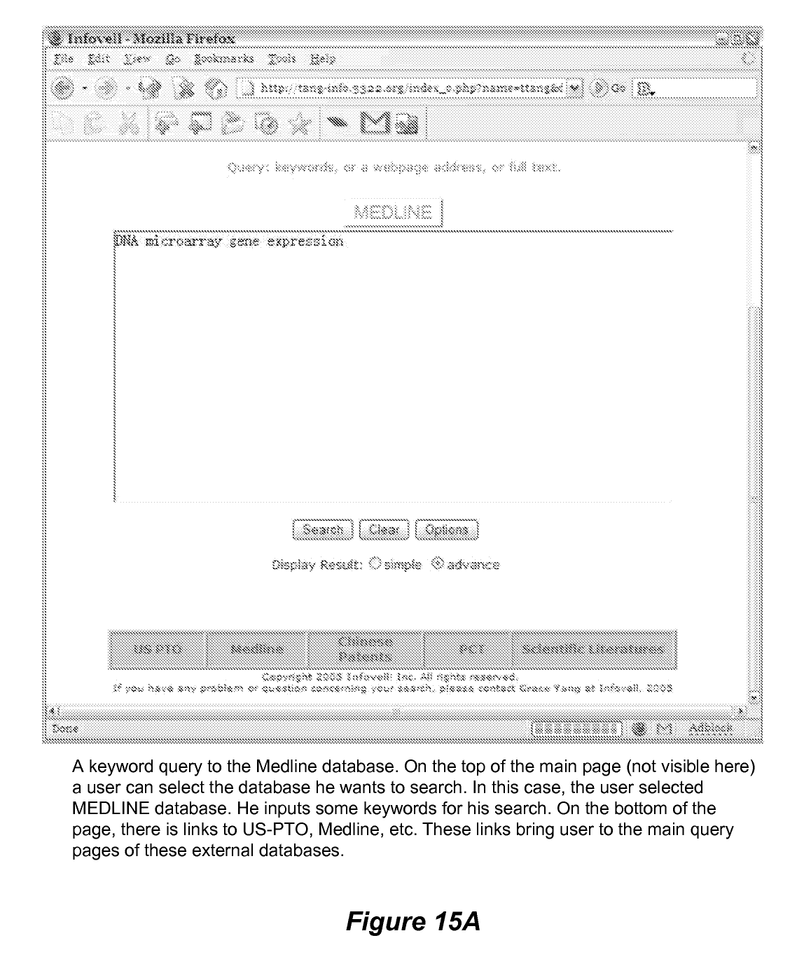

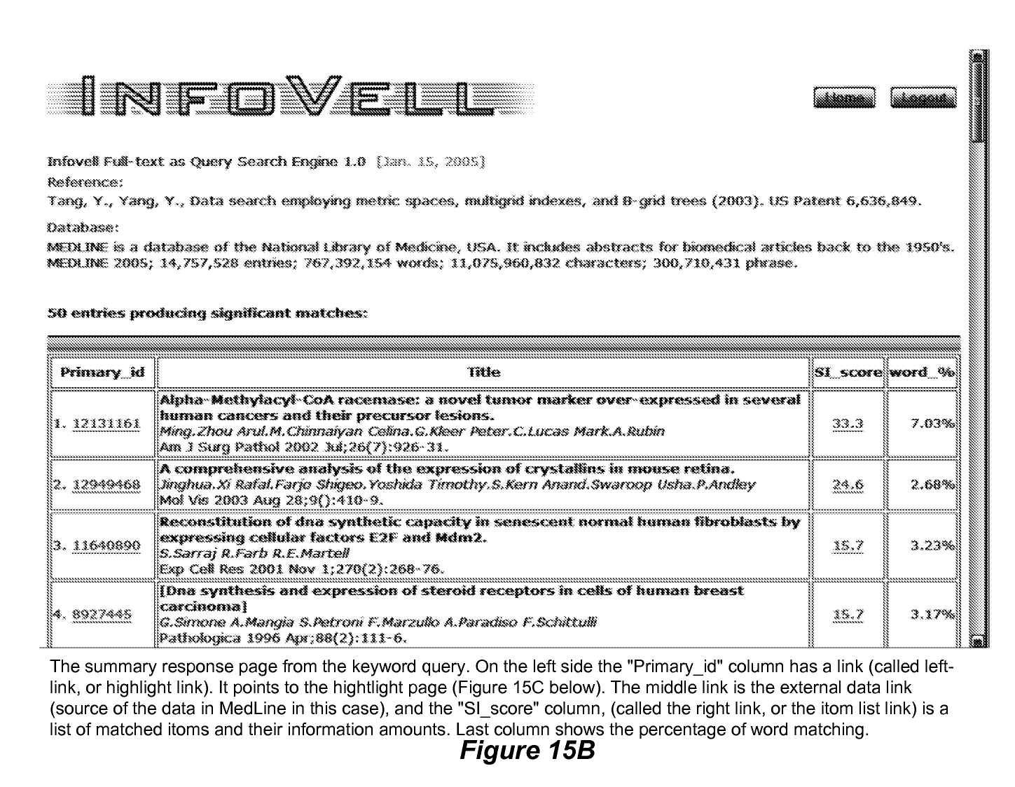

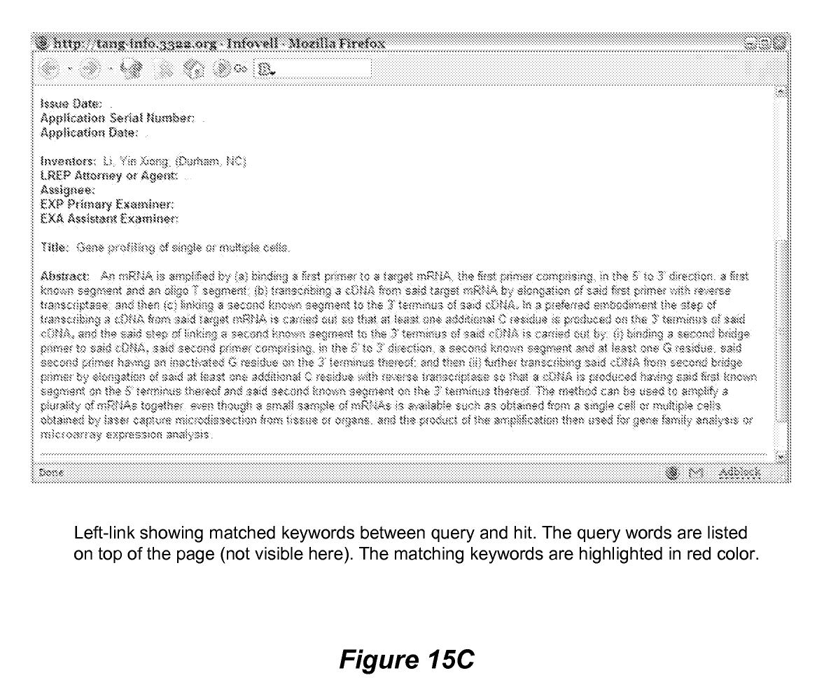

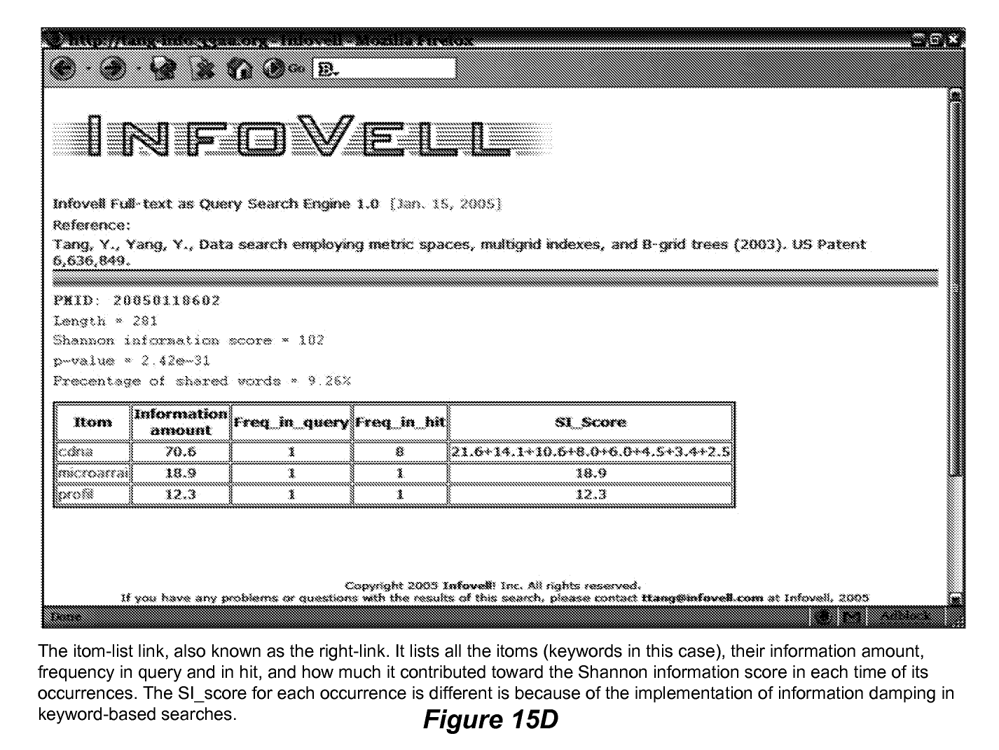

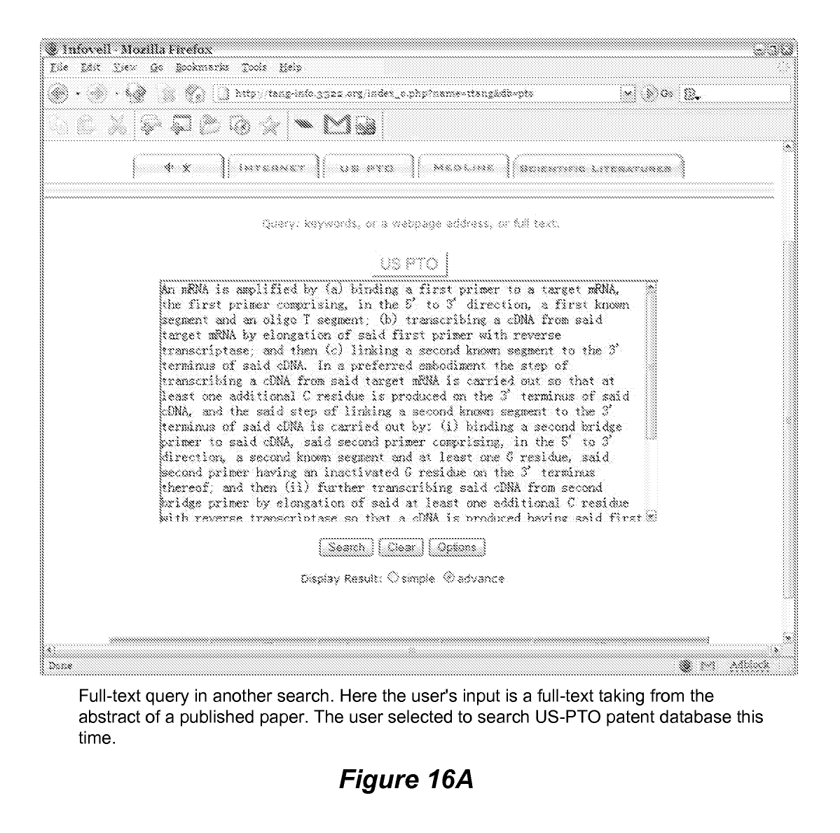

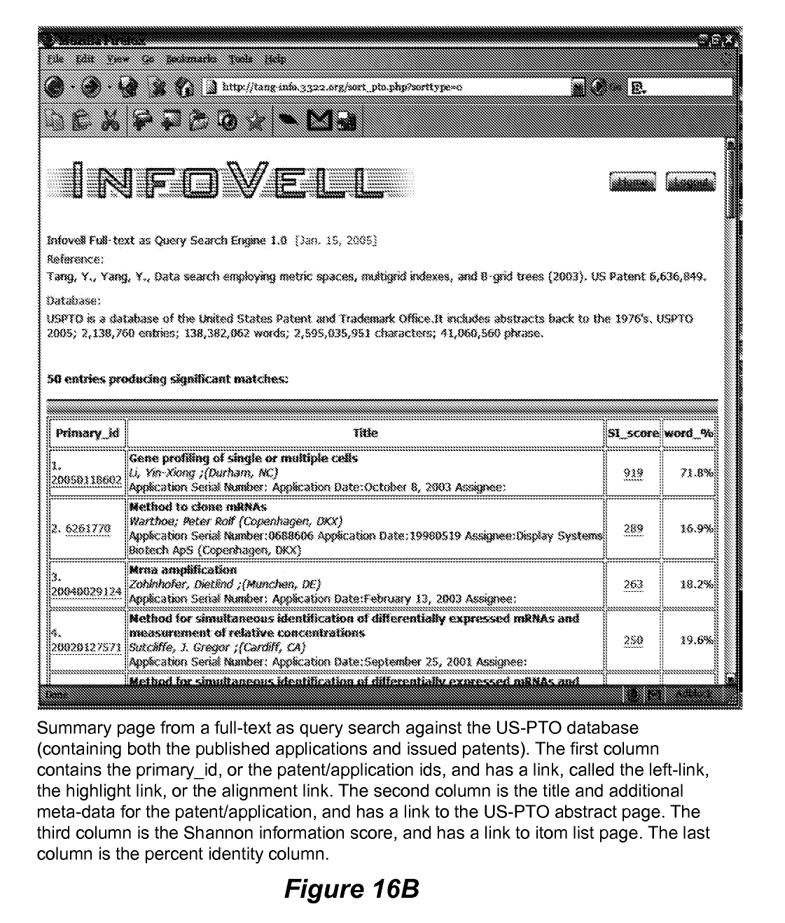

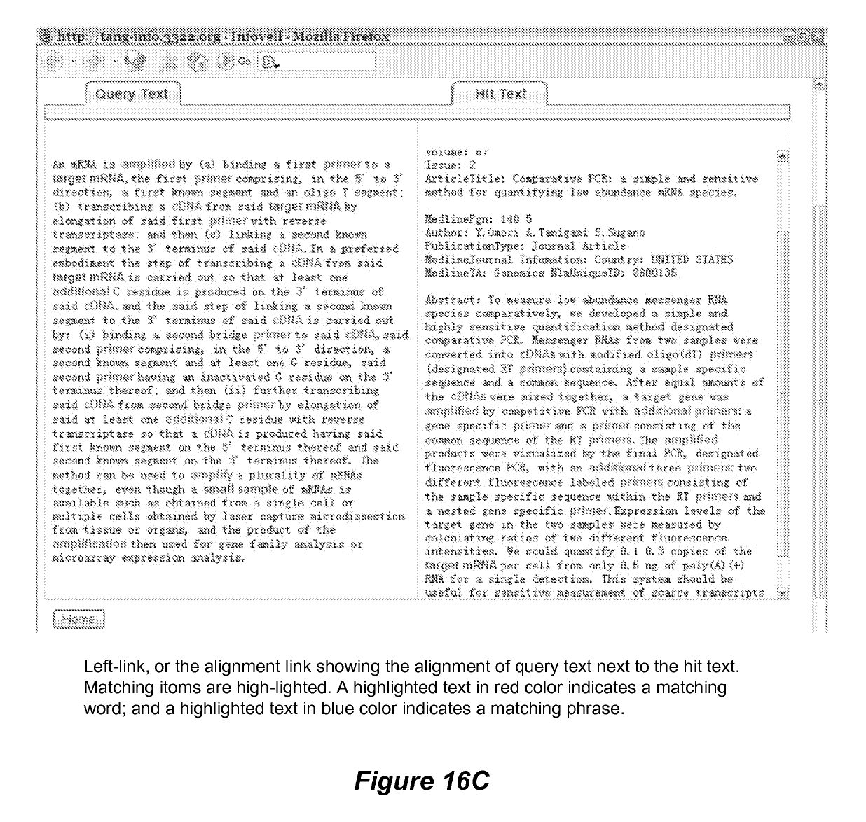

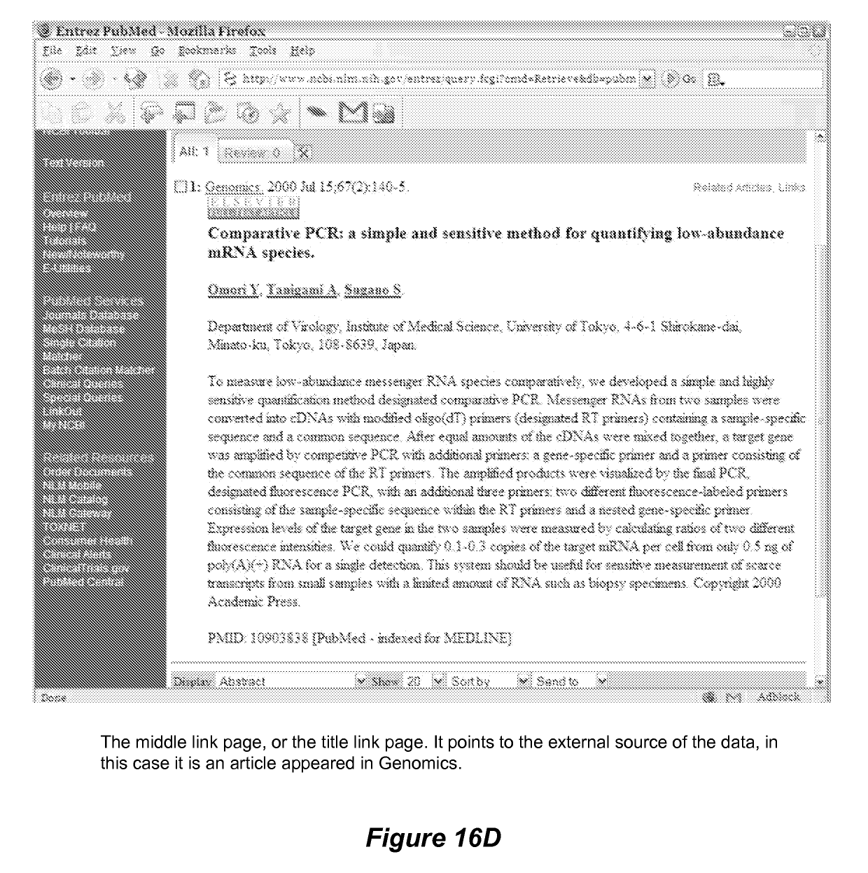

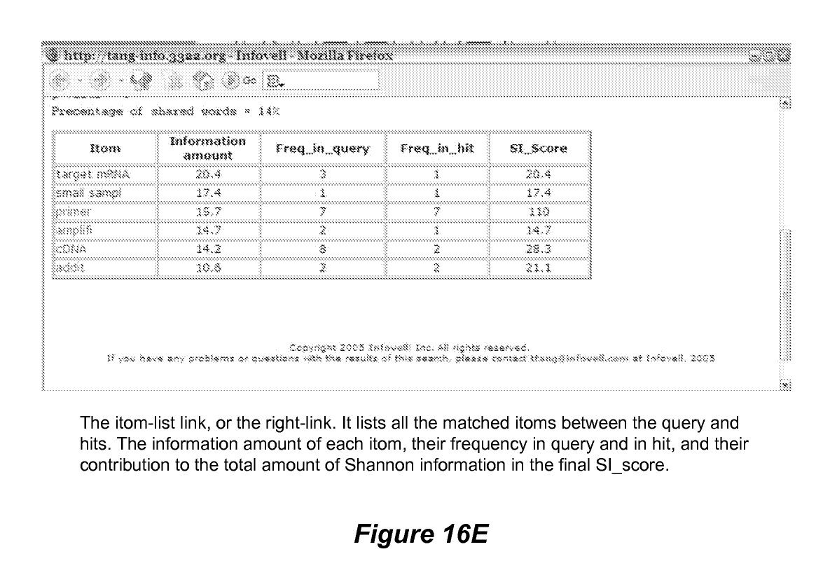

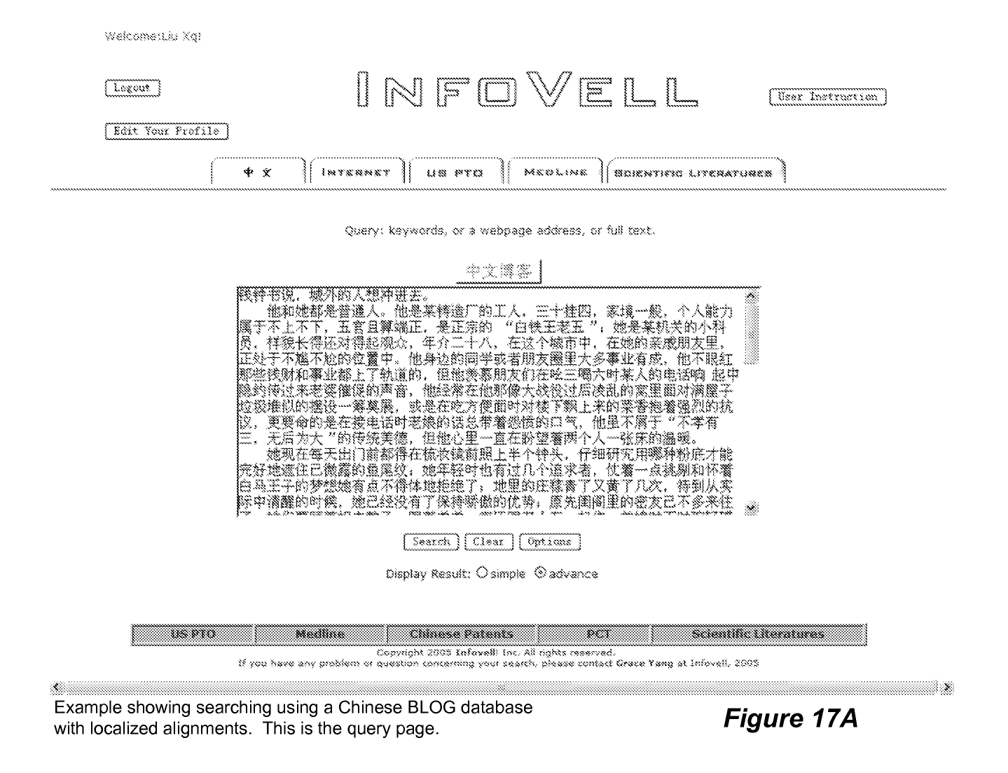

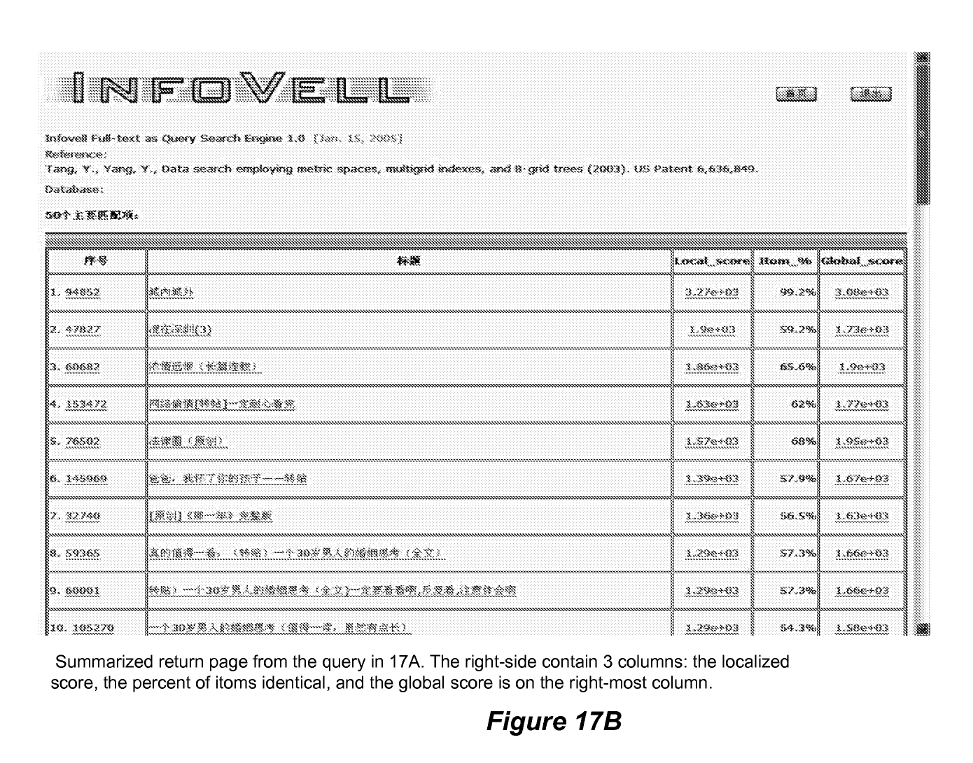

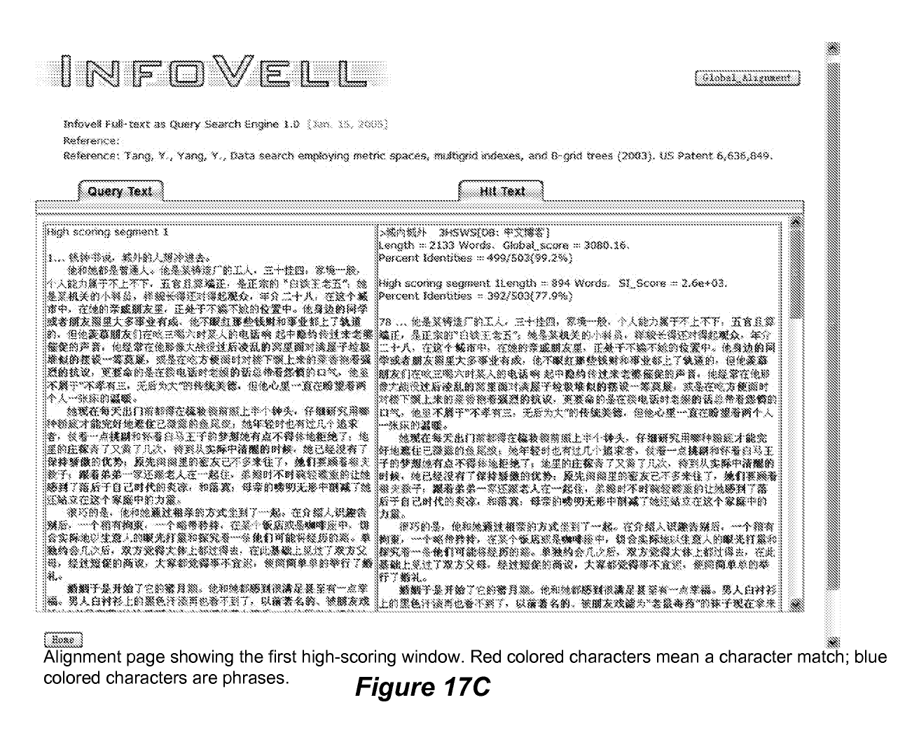

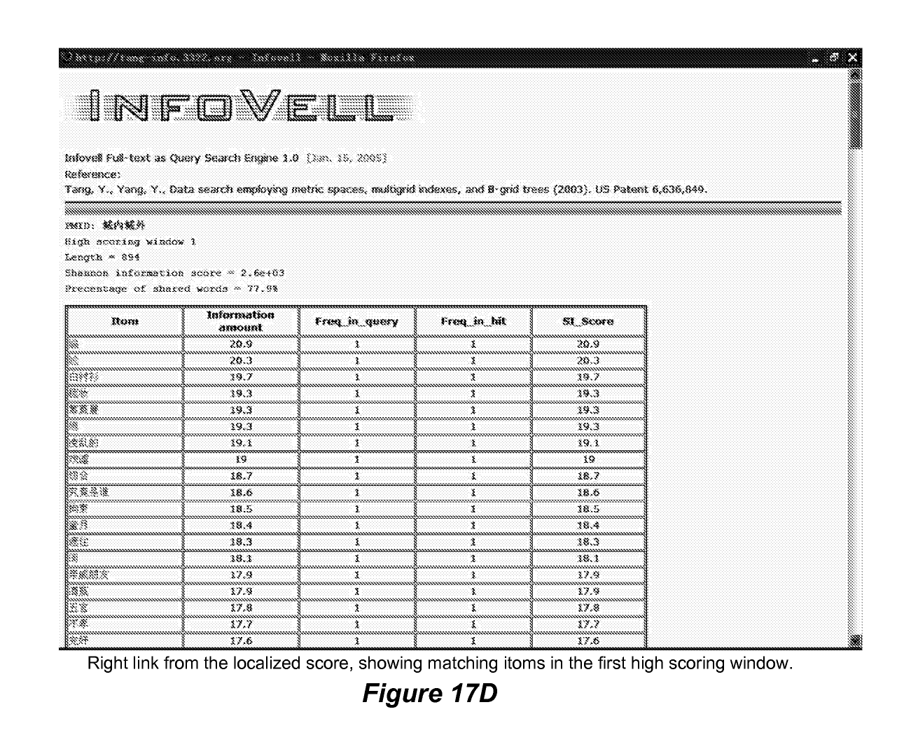

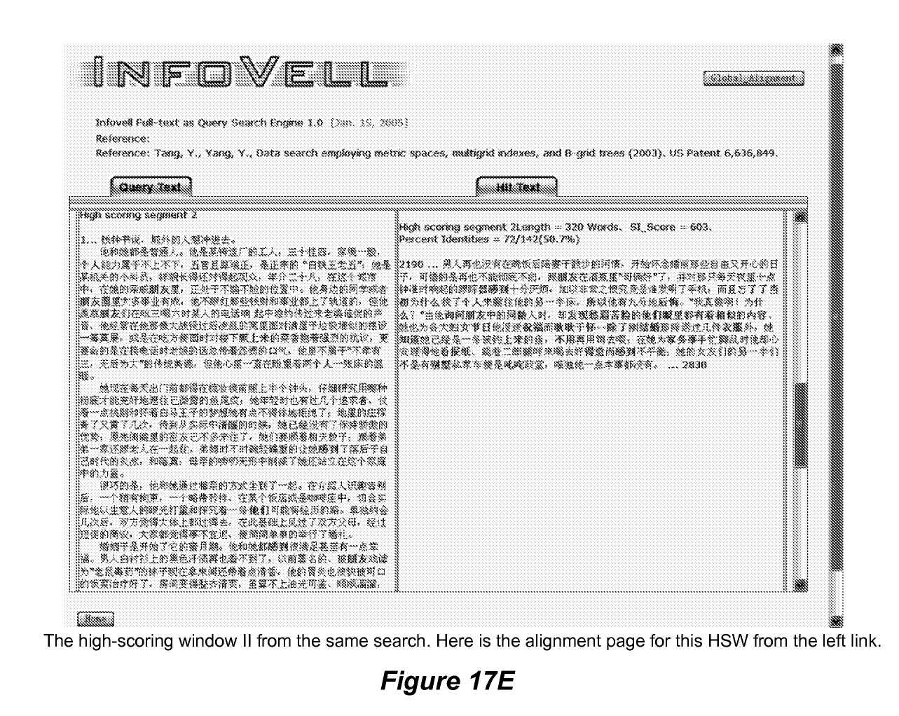

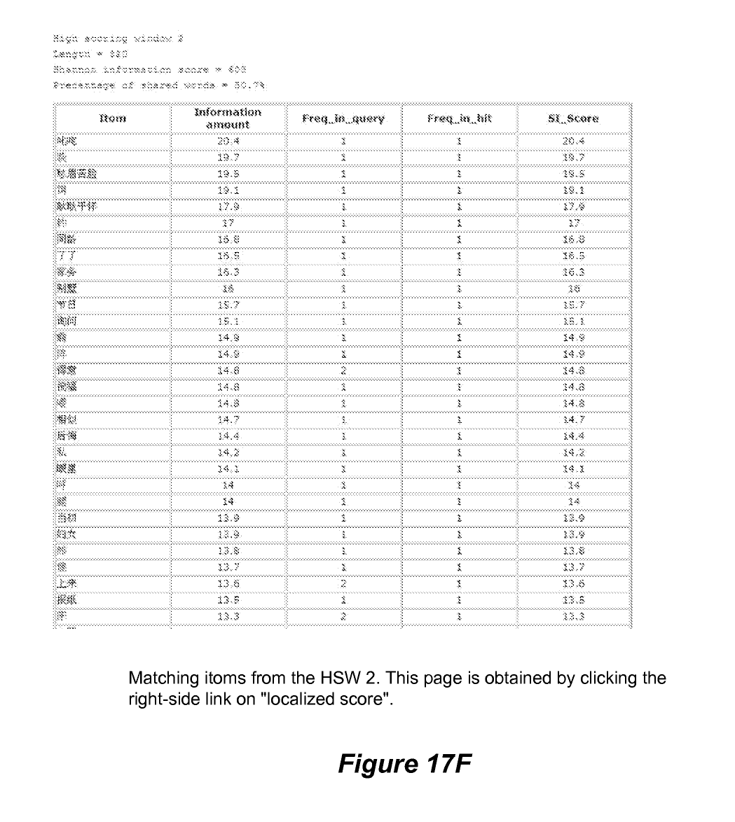

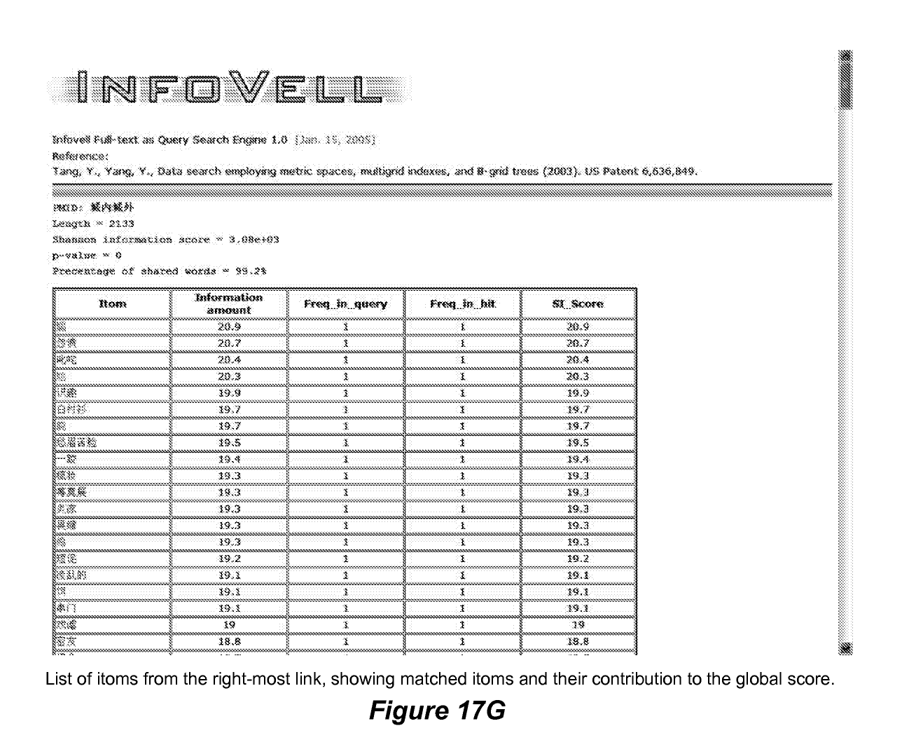

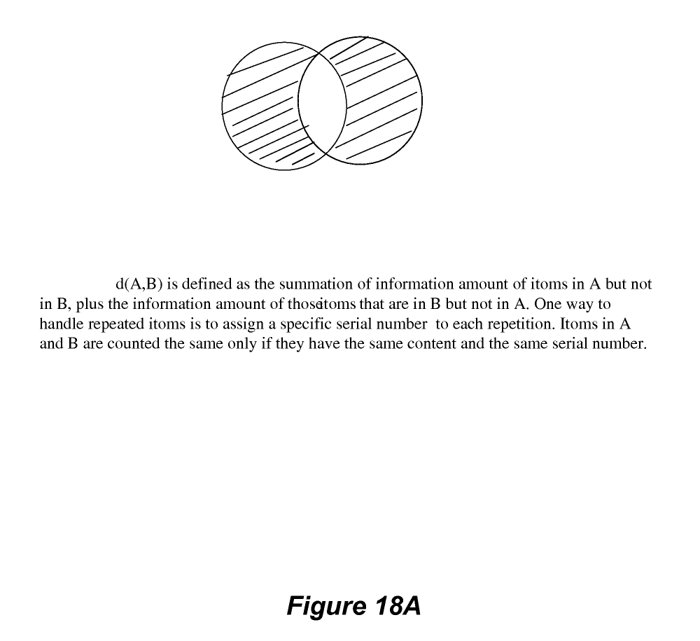

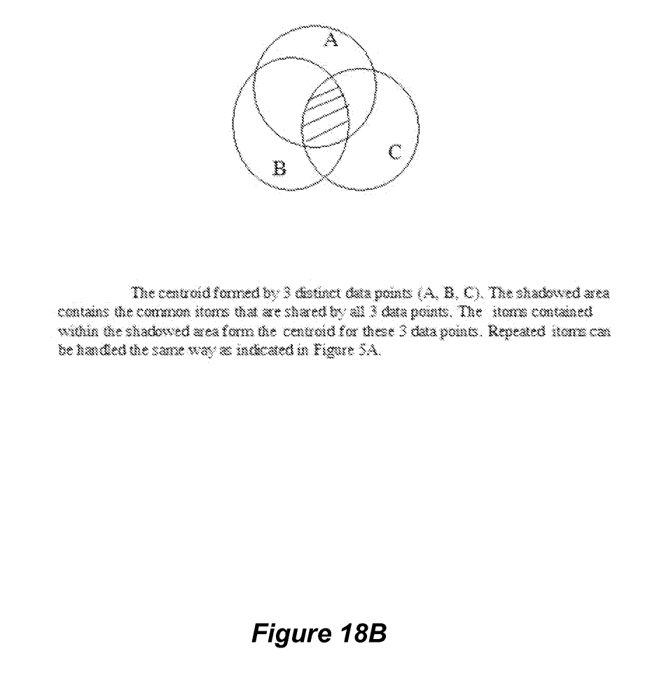

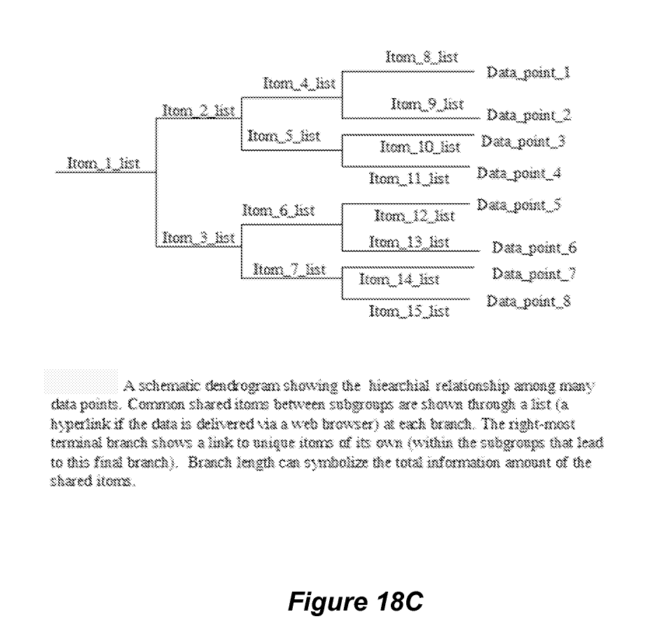

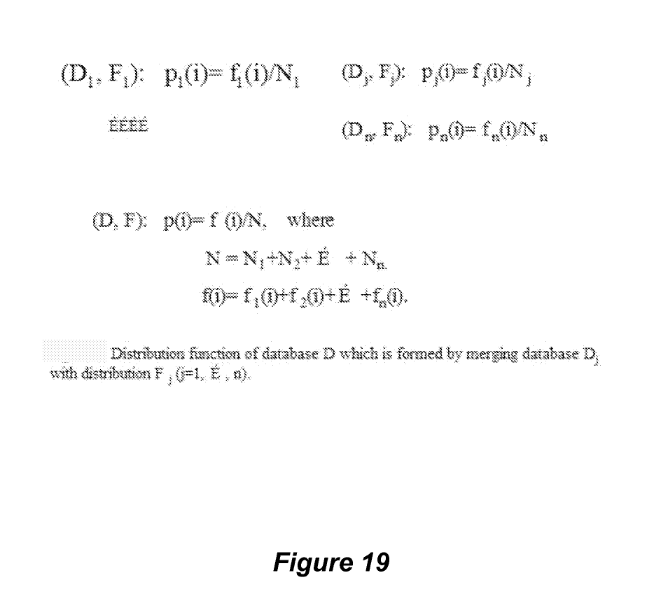

### DETAILED DESCRIPTION

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

As used herein and in the appended claims, the singular forms “a,” “an,” and “the” include plural reference unless the context clearly dictates otherwise. Thus, for example, a reference to “a phrase” includes a plurality of such phrases, and a reference to “an algorithm” is a reference to one or more algorithms and equivalents thereof, and so forth.

### DEFINITIONS

Database and its entries: a database here is a text-based collection of individual text files. Each text file is an entry. Each entry has a unique primary key (the name of the entry). We expect the variance within the length of the entries not so large. As used herein, the term “database” does not imply any unity of structure and can include, for example, sub-databases, which are themselves “databases”.

Query: a text file that contains information in the same category as in the database. Something that is of special interest to the user. It can also be an entry in the database.

Hit: a hit is a text file entry in the database where the overlap of query and the hit in the words used are calculated to be significant. Significance is associated with a score or multiple scores as disclosed below. When the overlapped words have a collective score above a certain threshold, it is considered to be a hit. There are various ways of calculating the score, for example, tracking the number of overlapped words; using cumulated Shannon Information associated with the overlapping word; calculating a p-value that indicates how likely that the hit associated with the query is due to chance. As used herein, depending on the embodiment, a “hit” can constitute a full document or entry, or it can constitute a dynamically demarcated segment. The terms document, entry, and segment are defined in the context of the database being searched.

Hit score: a measure (i.e. a metric) used to record the quality of a hit to a query. There are many ways of measuring this hit quality, depending on how the problem is viewed or considered. In the simplest scenario the score is defined as the number of overlapped words between the two texts. Thus, the more words are overlapped, the higher the score. The ranking by citation of the hit that appears in other sources and/or databases is another way. This method is best used in keyword searches, where 100% matches to the query is sufficient, and the sub-ranking of documents that contend the keywords is based on how important each website is. In the aforementioned case importance is defined as “citation to this site from external site”. In a search engine embodiment of the invention, the following hit scores can be used with the invention: percent identity, number of shared words and phrases, p-value, and Shannon Information. Other parameters can also be measured to obtain a score and these are well known to those in the art.

Word distribution of a database: for a text database, there is a total unique word count: N. Each word w has its frequency f(w), meaning the number of appearance within the database. The total number of words in the database is T_{w}=Sᵢ f(wᵢ), i=1, . . . , N, where Sᵢ means the summation over all i. The frequency for all the words w (a vector here), F(w), is termed the distribution of the database. This concept is from the probability theory. The word distribution can be used to automatically remove redundant phrases.

Duplicated word counting: If a word appears both once in query and in hit, it is easy to count it as a common word shared by the two documents. The invention contemplates accounting for a word that appears more than one time in both query and in hit? One embodiment will follow the following rules: for duplicated words in query (present m times) and in hit (present n times), the numbers are counted as: min (m,n), the smaller of m and n.

Percent identity: A score to measure the similarity between two files (query and hit). In one embodiment it is the percentage of words that are identical between the query file and the hit file. Percent identity is defined as: 2*number_of_shared_words)/(total_words_in_query+total_words_in_hit). For duplicated words in query and hit, we follow the rule in item 6. Usually, the higher the score, the more relevant are the two entries. If the query and the hit are identical, percent identity=100%.

p-value: the probability of the appearance of common words in the query and the hit that is purely by chance, given the distribution function F(w) for the database. This p-value is calculated using rigorous probability theory, but it is a little bit hard. As a first degree approximation, we will use p=pᵢp(wᵢ), where pᵢ is the multiplication over all i′s for the words shared in the hit and query, and p(wᵢ) is the probability of each word, p(wᵢ)=f(wᵢ)/T_{w}. The real p-value is linearly correlated to this number but has a multiplication factor that is related to the size of query, the hit, and the database.

Shannon Information for a word: In more complex scenarios, the score can be defined as the cumulated Shannon Information of the overlapped words, where the Shannon Information is defined as −log₂(f/T_{w}) where f is the frequency of the word, the number of appearances of the word within the database, and T_{w} is the total number of words in the database.

Phrase means a list of words in a fixed consecutive order and is selected from a text and/or database using an algorithm that determines its frequency of appearing in the database (word distribution).

Itom (also sometimes called “Infotom” herein) is the basic unit of information associated with a word, phrase, and/or text, both in a query and in a database. The word, phrase, and/or text in the database is assigned a word distribution frequency value and becomes an Itom if the frequency value is above a predefined frequency. The predetermined frequency can differ between databases and can be based upon the different content of the databases, for example, the content of a gene database is different to the content of a database of Chinese literature, or the like. The predetermined frequency for different databases can be summarized and listed in a frequency table. The table can be freely available to a user or available upon payment of a fee. The frequency of distribution of the Itom is used to generate the Shannon Information and the p value. If the query and the hit have an overlapping and/or similar Itom frequency the hit is assigned a hit score value that ranks it towards or at the top of the output list. In some cases, the term “word” is synonymous with the term “Itom”; in other cases the term “phrase” is synonymous with the term “Itom”. The term “Itom” is used herein in its general sense, and any specific embodiment can limit the kinds of itoms it supports. Additionally, the kinds of itoms allowed can be different for different steps in even a single embodiment. In various embodiments the itoms supported can be limited to phrases, or can be limited to contiguous sequences of one or more tokens, or even can be limited to individual tokens only. In an embodiment, itoms can overlap with each other (either in the hit or in the query or both), whereas in another embodiment itoms are required to be distinct. As used herein, the term “overlap” is intended to include two itoms in which one is partially or wholly contained in the other.

Shannon Entropy and Information for an Article or Shared Words Between Two Articles

Let X be a discrete random variable on a set x={x₁, . . . , xₙ}, with probability p(x)=Pr(X=x). The entropy of X, H(X), is defined as:

H(X)=−Sᵢp(xᵢ) log₂p(xᵢ)

Where Si defines the summation over all i. The convention 0 log₂0=0 is adopted in the definition. The logarithm is usually taken to the base 2. When applied to the text search problem, the X is our article, or the shared words between two articles (with the each word having a probability from the dictionary), the probability can be the frequency of words in the database or estimated frequency. The information within the text (or the intersection of two texts): I(X)=−Sᵢ log₂(xᵢ).

A “Token”, as the term is used herein, is an atomic element considered by the embodiment. In one embodiment, a token is a word in a natural language (such as English). In another embodiment, a token is a Chinese character. In another embodiment, a token is the same as what is considered a token by a parser of a computer language. In yet another embodiment, a token is a word as represented in ciphertext. Other variations will be apparent to the reader. In most embodiments described herein the database is text and a token is a word, and it will be understood that unless the context requires otherwise, wherever the term “text” or “word” is used, different embodiments exist in which a different kind of database content is used in place of “text” or a different kind of token is used in place of the “word”.

An itom said herein to be “shared” by both the hit and the query does not require that it be found identically in both; the term includes the flexibility to find synonyms, correlated words, misspellings, alternate word forms, and any other variations deemed to be equivalent in the embodiment. It also includes itoms added into the query by means of a query expansion step as described herein.

An information measure is also sometimes referred to herein as a “selectivity measure”.

As used herein, a database may be divided into one or more “entries”, which may be further subdivided into one or more “cells”. In an embodiment in which the database is structured, such as in a relational database environment, an entry may correspond to a row in a table, and a “cell” may correspond to a row and column combination in the table. In an environment in which the database is semi-structured, such as a collection of documents, then an entry may correspond to a document; if the document is not further subdivided, then the cell is co-extensive with the entry. In an environment in which the database is completely unstructured, such as un-demarcated text, the entire database constitutes a single entry and a single cell.

As used herein, approximation or estimation includes exactness as a special case. That is, a formula or process that produces an exact result is considered to be within the group of formulas or processes that “approximate” or “estimate” the result.

As used herein, the term “system” does not imply any unity of structure and can include, for example, sub-systems.

As used herein, the term “network” does not imply any unity of structure and can include, for example, subnets, local area nets, wide area nets, and the internet.

As used herein, a function g(x) is “monotonically non-increasing” or “monotonically decreasing” if, whenever x<y, then g(x)>=g(y), i.e., it reverses the order. A function g(x) is “strictly monotonically decreasing” if, whenever x<y, then g(x)>g(y). The negative logarithm function used elsewhere herein to compute a Shannon Information score is one example of a monotonically non-increasing function.

### Outline of Global Similarity Search Engine

We propose a new approach towards search engine technology that we call “Global Similarity Search”. Instead of trying to match keywords one by one, we look at the search problem from another perspective: the global perspective. Here, the match of one or two keywords is not essential anymore. What matters is the overall similarity between a query and its hit. The similarity measure is based on Shannon Information entropy, a concept that measures the information amount of each word or phrase.
1) No limitation on number of words. In fact, users are encouraged to write down whatever is wanted. The more words in a query, the better. Thus, in the search engine of the invention, the query may be a few keywords, an abstract, a paragraph, a full-text article, or a webpage. In other words, the search engine will allow “full-text query”, where the query is not limited to a few words, but can be the complete content of a text file. The user is encouraged to be specific about what they are seeking. The more detailed they can be, the more accurate information they will be able to retrieve. A user is no longer burdened with picking keywords.
2) No limit on database content, not limited to Internet. As the search engine is not dependent on link number, the technology is not limited by the database type, so long it is text-based. Thus, it can be any text content, such as hard-disk files, emails, scientific literature, legal collections, or the like. It is language independent as well.
3) Huge database size is a good thing. In a global similarity search, the number of hits is usually very limited if the user can be specific about what is wanted. The more specific one is about the query, the less hits will be returned. Huge size in database is actually a good thing to the invention, as it is more likely to find records a user wants. In keyword-based searches, large database size is a negative factor, as the number of records containing the few keywords is usually very large.
4) No language barrier. The technology applies to any language (even to alien languages if someday we receive them). The search engine is based on information theory, and not on semantics. It does not require any understanding on the content. The search engine can be adapted to any existing language in the world with little effort.
5) Most importantly, what the user wants is what the user gets and the returned hits are non-biased. A new scoring system is herewith introduced that is based on Shannon Information Theory. For example, the word “the” and the phrase “search engine” carries different amount of information. Information amount of each word and phrase is intrinsic to the database it is in. The hits are ranked by the amount of information in the overlapping words and phrases between the query and the hits. In this way, the most relevant entries within the database to the query are generally expected with high certainty to score the highest. This ranking is purely based on the science of Information Theory and has nothing to do with link number, webpage popularity, or advertisement fees. Thus, the new ranking is really objective.

Our angle of improving user search experience is quite different from other search engines such as provided by YAHOO or GOOGLE. Traditional search engines, including YAHOO and GOOGLE, are more concerned with a word, or a short list of words or phrases, whereas we are solving the problem of a larger text with many words and phrases. Thus, we present an entirely different way of finding and ranking hits. Ranking the hits that contain all the query words is not the top priority but is still performed in this context, as this rarely occurs for long queries, that is, queries having many words or multiple phrases. In the case that there are many hits, all containing the query words, we recommend the user refining their search by providing more description. This allows the search engine of the invention to better filter out irrelevant hits.

Our main concern is the method to rank hits with different overlaps with the query. How should they be ranked? The solution herein provided has its root in the “informational theory” developed by Shannon for communication. Shannon's Information concept is applied to text databases with given discrete distributions. Information amount of each word or phrase is determined by its frequency within the database. We use the total amount of information in shared words and phrases between the two articles to measure the relevancy of a hit. Entries in the whole database can be ranked this way, with the most relevant entry having the highest score.

### Language-Independent Technology Having Origins in Computational Biology

The search engine of the invention is language-independent. It can be applied to any language, including non-human languages, such as the genetic sequence databases. It is not related to semantics study at all. Most of the technology was first developed in computational biology for genetic sequence databases. We simply applied it to the text database search problem with the introduction of Shannon Information concepts. Genetic database search is a mature technology that has been developed by many scientists for over 25 years. It is one of the main technologies that achieved the sequencing of human genome, and the discovery of the ˜30,000 human genes.

In computational biology, a typical sequence search problem is as following: given a protein database ProtDB, and a query protein sequence ProtQ, find all the sequences in ProtDB that are related to ProtQ, and rank all them based on how close they are to ProtQ. Translating that problem into a textual database setting: for a given text database TextDB, and a query text TextQ, find all the entries in TextDB that are related to TextQ, and rank them based how close they are to TextQ. The computational biology problem is well-defined mathematically, and the solution can be found precisely without any ambiguity using various algorithms (Smith-Waterman, for example). Our mirrored text database search problem has a precise mathematical interpretation and solution as well.

For any given textual database, irrespective of its language or data content, the search engine of the invention will automatically build a dictionary of words and phrases, and assign Shannon information amount to each word and phrase. Thus, a query has its amount of information; an entry in the database has its amount of information; and the database has its total information amount. The relevancy of each database entry to the query is measured by the total amount of information in overlapped words and phrases between a hit and a query. Thus, if a query and an entry have no overlapped words/phrases the score will be 0. If the database contains the query itself, it will have the highest score possible. The output becomes a list of hits ranked according to their informational relevancy to the query. An alignment between query and each hit can be provided, where all the shared words and phrases can be highlighted with distinct colors; and the Shannon information amount for each overlapped word/phrases can also be listed. The algorithm used herein for the ranking is quantitative, precise, and completely objective.

Language can be in any format and can be a natural language such as, but not limited to Chinese, French, Japanese, German, English, Irish, Russian, Spanish, Italian, Portuguese, Greek, Polish, Czech, Slovak, Serbo-Croat, Romanian, Albanian, Turkish, Hebrew, Arabic, Hindi, Urdu, That, Togalog, Polynesian, Korean, Viet, Laosian, Kmer, Burmese, Indonesian, Swedish, Norwegian, Danish, Icelandic, Finnish, and Hungarian. The language can be a computer language, such as, but not limited to C/C++/C#, JAVA, SQL, PERL, and PHP. Furthermore, the language can be encrypted and can be found in the database and used as a query. In the case of an encrypted language, it is not necessary to know the meaning of the content to use the invention.

Words can be in any format, including letters, numbers, binary code, symbols, glyphs, hieroglyphs, and the like, including those existing but as yet unknown to man.

### Defining a Unique Measuring Matrix

Typically in the prior art the hit and the query are required to share the same exact words/phrases. This is called exact match, or “identity mapping”. But this is not necessary in the search engine of the invention. In one practice, we allow a user to define a table of synonyms. These query words/phrases with synonyms will be extended to search the synonyms in the database as well. In another practice, we allow users to perform “true similarity” searches by loading various “similarity matrices.” These similarity matrices provide lists of words that have similar meaning, and assign a similarity score between them. For example, the word “similarity” has a 100% score to “similarity”, but may have a 50% score to “homology”. The source of such “similarity matrices” can be from usage statistics or from various dictionaries. People working in different areas may prefer using a specific “similarity matrix”. Defining “similarity matrix” is an active area in our research.

### Building the Database and the Dictionary

The entry is parsed into words contained, and passed through a filter to: 1) remove uninformative common words such as “a”, “the”, “of”, etc., and 2) use stemming to merge the words with similar meaning into a single word, e.g. “history” and “historical”, “evolution”, “evolutionary”, etc. All words with the same stem are merged into a single word. Typographical errors, rare-word, and/or non-word may be excluded as well, depending on the utility of the database and search engine.

The database is composed of parsed entries. A dictionary is built for the database where all the words appeared in the database are collected. The dictionary also contains the frequency information of each word. The word frequency is constantly updated as the database expands. The database is also constantly updated by new entries. If a new word not in the dictionary is seen, then it is entered into the dictionary with a frequency equal to one (1). The information content of each word within the database is calculated based on

−log₂(x), where the x is the distribution frequency (frequency of the word divided by total frequency of all words within the dictionary). The entire table of words and its associated frequency for a database is called a “Frequency Distribution”.

In the database each entry is reduced and/or converted to a vector in this very large space of the dictionary. The entries for specific applications can be further simplified. For instance, if only the “presence” or “non-presence” of a word within an entry is desired to be evaluated by the user, the relevant entry can be reduced into a recorded stream of just values of ‘1s’, and ‘0s’. Thus, an article is reduced to a vector. An alternative to this is to record word frequency as well, that is, the number of appearance of a word is also recorded. Thus, if “history” appeared ten times in the article, it will be represented as value ‘10’ in the corresponding column of the vector. The column vector can be reduced to a sorted, linked list, where only the serial number of the word and its frequency is recorded.

### Calculating Shannon Information Scores

Each entry has its own Shannon Information score that is the summary of all the Shannon Information (SI) for the words contained. In comparing two entries, all the shared words between the two entries are first identified. The Shannon Information for each shared word based on the Shannon Information of each word is calculated and the repetition times of this word in the query and in the hit. If a word appeared ‘m’ times in query, and ‘n’ times in hit, the SI associated with the word is:

SI_total(w)=min (n,m)*SI(w).

Another way to calculate the SI(w) for repeated words is to use damping, meaning that the amount of information calculated will be reduced by a certain proportion when it appeared in the 2^{nd} time, 3^{rd} time, etc. For example, if a word is repeated ‘n’ times, damping can be calculated as follows:

SI_total(w)=Sᵢ(α**(i−1))*SI(w)

where α is a constant, called the damping coefficient; Si is the summation over all i, 0<i<=n, 0<=α<=1. When αa=0, it becomes SI(w), that is, 100% damping, and when αa=1 it becomes n*SI(w), that is, no damping at all. This parameter can be set by a user at the user interface. Damping is especially useful in keyword-based searches, when entries containing more keywords are favored against entries that contain fewer keywords but repeated multiple times.

In keyword search cases, we introduce another parameter, called damping location coefficient, β, 0<=β<=1. β is used to balance the relevant importance of each keyword when keywords are appearing multiple times in a hit. β is used to assign a temporary Shannon_Info for a repeated word. If we have K word, we can set the SI for the first repeated word at the SI(int (β*K)), where SI(i) stands for the Shannon_Info for the i-word.

In keyword searches, these two coefficients (α,β) should be used together. For example, let α=0.75 and β=0.75. In this example, numbers in parentheses are simulated SI scores for each word. If one search results with

TAFA (20) Tang (18) secreted (12) hormone (9) protein (5)

then, when TAFA appeared in second time, its SI will be 0.75*SI(hormone)=0.75*9. If TAFA appears a 3rd time, it will be 0.75*0.75*9. Now, let us assume that TAFA appeared a total of 3 times. The total ranking of words by SI are now

TAFA (20) Tang (18) secreted (12) hormone (9) TAFA (6.75) TAFA (5.06) protein (5)

If Tang appears a second time, its SI will be 75% of the number, number int(0.75*7)=5, which is TAFA (6.75). Thus, its SI is: 5.06. Now, with a total of 8 words in the hit, the scores (and ranking) are

TAFA (20) Tang (18) secreted (12) hormone (9) TAFA (6.75) TAFA (5.06) Tang (5.06) protein (5).

One can see that the SI for repeated word has a dependency on the spectrum of SI on all the words in the query.

### Heuristics of Implementation

1) Sorting the Search Results from a Traditional Search Engine.

If a traditional search engine returns a large number of results, where most of the results may not be what the user wants. If the user finds one article (A*) is exactly what he wants, he can now re-sort the search result into a list according to the relevance to that article using our full-text searching method. In this way, one only need to compare each of those articles once with A*, and resort the list according to the relevance to A*.

This application can be “stand-alone” software and/or one that can be associated with any existing search engine.

### 2) Generating a Candidate File List Using Other Search Engines

As a way to implement our full text query and search engine, we can use a few keywords from the query (those words that are selected based on their relative rarity), and use the traditionally keyword based search engine to generate a list of candidate articles. As one example, we can use the top ten most informational words (as defined by the dictionary and the Shannon Information) as queries and use the traditional search engine to generate candidate files. Then we can use the sorting method mentioned above to re-order the search output, so that the most relevant to the query will appear the first.

Thus, if the algorithm herein disclosed is combined with any existing search engine, we can implement a method that will generate our results using another search engine. The invention can generate the correct query to other search engines and re-sort them in an intelligent way.

### 3) Screening Electronic Mail

The search engine can be used to screen an electronic mail database for “junk” mail. A “junk” mail database can be created using mail that has been received by a user and which the user considers to be “junk”; when an electronic mail is received by the user and/or the user's electronic mail provider, it is searched against the “junk” mail database. If the hit is above a predetermined and/or assigned Shannon Information score or p-value or percent identity, it is classified as a “junk” mail, and assigned a distinct flag or put into a separate folder for review or deletion.

The search engine can be used to screen an electronic mail database to identify “important” mail. A database using electronic mail having content “important” to a user is created, and when a mail comes in, it is searched against the “important” mail database. If the hit is above a certain Shannon Information score or p-value or percent identity, it is classified as an important mail and assigned a distinct flag or put into a separate folder for review or deletion.

Table 1 shows the advantages that the disclosed invention (global similarity search engine) has over current keyword-based search engines including YAHOO and GOOGLE search engines

TABLE 1

| | Global similarity search | Current keyword-based |
|---|---|---|
| Features | engine | search engines |
| Query type | Full text and key words | Key words (burdened |
| | | with word selection) |
| Query length | No limitation of number | Limited |
| | of words | |
| Ranking system | Non-biased, based on | Biased, for example, |
| | weighted information | popularity, links, etc., |
| | overlaps | so may lose real results |
| Result relevance | More relevant results | More irrelevant results |
| Non-internet | Effective in search | Ineffective in search |
| content databases | | |

The invention will be more readily understood by reference to the following examples, which are included merely for purposes of illustration of certain aspects and embodiments of the present invention and not as limitations.

### EXAMPLES

### Example I

### Implementation of the Theoretical Model

In this section details of an exemplary implementation of the search engine of the invention are disclosed.

### 1. Introduction to FlatDB Programs

FlatDB is a group of C programs that handles flat-file databases. Namely, they are tools that can handle flat text files with large data contents. The file format can be many different kinds, for example, table format, XML format, FASTA format, and any format so long that there is a unique primary key. The typical applications include large sequence databases (genpept, dbEST), the assembled human genome or other genomic database, PubMed, Medline, etc.

Within the tool set, there is an indexing program, a retrieving program, an insertion program, an updating program, and a deletion program. In addition, for very large entries, there is a program to retrieve a specific segment of entries. Unlike SQL, FlatDB does not support relationship among different files. For example, if all the files are large table files, FlatDB cannot support foreign key constraints on any table.

Here is a list of each program and a brief description on its function:
1. im_index: for a given text file where a field separator exists and primary_id is specified, im_index generates an index file (for example <text.db>) which records each entry, where they appear in the text, and the size of the entry. The index file is sorted.
2. im_retrieve: for a given database (with index), and a primary_id (or a list of primary_ids in a given file), the program retrieves all the entries from the text database.
3. im_subseq: for a given entry (specified by a primary_id) and a location and size for that entry, im_subseq returns the specific segment of that entry.
4. im_insert: it inserts one or a list of entries into the database and updates the index. While it is inserting, it generates a lock file so others cannot insert contents the same time.
5. im_delete: deletes one or multiple entries specified by a file.
6. im_update: updates one or multiple entries specified by a file. It actually runs an im_delete followed by an im_insert.

The most commonly used programs are im_index, im_retrieve. im_subseq is very useful if one needs to get a subsequence from a large entry, for example, a gene segment inside a human chromosome.

In summary, we have written a few C programs that are flat-file database tools. Namely they are tools that can handle a flat-file with many data contents. There is an indexing program, a retrieving program, an insertion program, an updating program, and a deletion program.

### 2. Building and Updating a Word Frequency Dictionary

Name: im_word_freq<text_file><word_freq>

### Input:

1: a long list of text file. Flat text file is in FASTA format (as defined below).
2: a dictionary with word frequency.
   Output: updating Input 2 to generate a dictionary of all the word used and the frequency of each word.

### Language: PERL.

### Description:

1. The program first reads Input_{—}2 into memory (a hash: word_freq): word_freq{word}=freq.
2. It opens file <text_file>. For each entry, it splits the file into an array (@entry_one), each word is a component of $ntry_one. For each word, word_freq{word}+=1.
3. Write the output into <word_freq.new>.
   FASTA format is a convenient way of generating large text files (used commonly in listing large sequence data file in biology). It typically looks like:
   >primary_id1 xxxxxx (called annotation)
   text file (with many new lines).
   >primary_id2

The primary_ids should be unique, but otherwise, the content is arbitrary.

### 3. Generating a Word Index for a Flat-File FASTA Formatted Database

Name: im_word_index<text_file><word_freq>

### Input:

1. a long list of text file. Flat text file in FASTA format (as defined above).
2. a dictionary with word frequency associated with the text_file.

### Output:

1. two index files: one for the primary_ids, one for the bin_ids.
2. word-binary_id association index file.

### Language: PERL.

Description: The purpose for this program is for a given word, one will be able to quickly identify which entries contain this word. In order to do that, we need an index file, essentially for each word in the word_freq file, we have to list all the entries that contain this word.

Because the primary_id is usually long, we want to use a short form. Thus we assign a binary_id (bin_id) to each primary_id. We then need a mapping file to associate quickly between the primary_id and the binary_id. The first index file in the format: primary_id bin_id, sorted by the primary_id. And the other is: bin_id primary_id, sorted by the primary_id. These two files are for look up purpose: namely given a binary_id one can quickly find what its primary_id, and vice versa.

The final index file is the association between the words in the dictionary, and a list of binary_ids that this word appears. The list should be sorted by bin_ids. The format can be FASTA, for example:

>Word1, freq.
bin_id1 bin_id2 bin_id3 . . .
>Word2, freq
bin_id1 bin_id2 bin_id3, bin_id3 . . .
4. Finding all the Database Entries that Contains a Specific Word

Name: im_word_hits <database><word>

### Input

1: a long list of text file. Flat text file in FASTA format, and its associated 3 index files.
2: a word.

### Output

A list of bin_ids (entries in the database) that contain the word.

### Language: PERL.

Description: For a given word, one wants to quickly identify which entries contain this word. In the output, we have a list all the entries that contain this word.
Algorithm: for the given word, first use the third index file to get all the binary_ids of texts containing this word. (One can use the second index file: binary_id to primary_id to get all the primary_ids). One returns the list of binary_ids.

This program should also be available in as a subroutine: im_word_hits (text_file, word).

5. For a Given Query, Find all the Entries that Share Words with the Query

Name: im_query_{—}2_hits<database_file><query_file>[query_word_number] [share_word_number]

### Input

1: database: a long list of text file. Flat text file in FASTA format.
2: a query in FASTA file that is just like the many entries in the database.
3: total number of selected words to search, optional, default 10.
4: number of words in the hits that are in the selected query words, optional, default 1.
   Output: list of all the candidate files that share a certain number of words with the query.

### Language: PERL.

Description: The purpose for this program is for a given query, one wants a list of candidate entries that share at least one word (from a list of high information words) with the query.

We first parse the query into a list of words. We then look up the word_freq table to establish query_word_number (10 for default, but user can modify) words with the lowest frequency (that is, highest information content). For each of the 10 words, we use the im_word_hits (subrountine) to locate all the binary_ids that contain the word. We merge all those binary_ids, and also count how many times the binary_id appeared. We only keep those binary_ids that have >share_word_number of words (at least share one word, but can be 2 if there are too many hits).

We can sort here based on a hit_score for each entry if the total number of hit number is >1000. The calculation of hit_score for each entry is to use the Shannon Information for the 10 words. This hit_score can also be weighted by the frequency of each word in both the query and the hit file.

Query_word_number is a parameter that users can modify. If larger, the search will be more accurate, but it may take longer time. If it is too small, we may loss accuracy.

### 6. For Two Given Text Files (Database Entries), Compare and Assign a Score

Name: im_align_{—}2<word_freq><entry_{—}1><entry_{—}2>

### Input:

1: The word_frequency file generated for the database.
2: entry_{—}1: a single text file. One database entry in FASTA format.
3: entry_{—}2: same as entry_{—}1.
   Output: A number of hit scores including: Shannon Information, Common word numbers. The format is:
1) Summary: entry_{—}1 entry_{—}2 Shannon_Info_score Common_word_score.
2) Detailed Listing: list of common words, the database frequency of the words, and the frequency within entry_{—}1 and in entry_{—}2 (3 columns).

### Language: C/C++.

This step will be the bottleneck in searching speed. That is why we should write it in C/C++. In prototyping, one can use PERL as well.
Description: For two given text files, this program compares them, and assign a number of scores that describes the similarity between the two texts.

The two text files are first parsed into to arrays of words (@text1, and @text2). A join operation is performed between the two arrays to find the common words. If the common words are null, return NO COMMON WORDS BETWEEN entry_{—}1 and entry_{—}2 to STDERR.

If there are common words, the frequency of each common word is looked up in word_freq file. Then, the Sum of all Shannon Information for each shared word is calculated. We generate a SI_score here (for Shannon Information). The total number of words in the common words (Cw_score) is also counted. There may be more scores to report in the future (such as the correlation between the two files including the frequency comparisons of the words, and normalization based on the text length, etc.).

To calculate Shannon Information, refer to the original document on the method (Shannon (1948) Bell Syst. Tech. J., 27: 379-423, 623-656; and see also Feinstein (1958) Foundations of Information Theory, McGraw Hill, New York N.Y.).

### 7. For a Given Query, Rank all the Hits

Name: im_rant_hits<database_file><query_file><query_hits>

### Input:

1: database: a long list of text file. Flat text file in FASTA format.
2: a query in FASTA file. Just like the many entries in the database.
3: a file containing a list of bin_ids that are in the Database.

### Options:

1. [rank_by] default: SI_score. Alternative: CW_score.
2. [hits] number of hits to report. Default: 300.
3. [min_SI_score]: to be determined in the future.

4. [min_CW_score]: to be determined in the future.

Output: a sorted list of all the files in the query_hits based on hit scores.

### Language: C/C++/PERL.

This step is the bottleneck in searching speed. That is why it should be written in C/C++. In prototyping, one can use PERL as well.

Description: The purpose for this program is for a given query and its hits, one wants to rank all those hits based on a scoring system. The scoring here is a global score, showing how related the two files are.

The program first calls the im_align_{—}2 subroutine to generate a comparison between the query and each of the hit_file. It then sorts all the hits based on the SI_score. A one-line summary is generated for each hit. This summary is listed in the beginning of the output. In the later section of the output, the detailed alignment of common words and frequency of those words are shown for each hit.

The user should be able to specify the number of hits to report. Default is 300. The user also can specify sort order, default is SI_score.

### Example II

### A Database Example for MedLine

Here is a list of database files as they were processed:

1) Medline.raw Raw database downloaded from NLM, in XML format.
2) Medline.fasta Processed database
FASTA Format for the parsed entries follows the format
>primary_id authors. (year) title. Journal. volume:page-page word1(freq) word2(freq) . . .

words are be sorted by character.

3) Medline.pid2bid Mapping between primary_id (pid) and binary_id (pid).
Medline.bid2pid Mapping between binary_id and primary_id
   Primary_id is defined in the FASTA file. It is the unique identifier used by Medline. Binary_id is an assigned id used for our own purpose to save space.
   Medline.pid2bid is a table format file. Format: primary_id binary_id (sorted by primary_id).
   Medline.bid2pid is a table format file. Format: binary_id primary_id (sorted by binary_id)
   4) Medline.freq Word frequency file for all the word in Medline.fasta, and their frequency. Table format file: word frequency.
   5) Medline.freq.stat Statistics concerning Medline.fasta (database size, total word counts, Medline release version, release dates, raw database size. Also has additional information concerning the database.
   6) Medline.rev Reverse list (word to binary_id) for each word in the Medline.freq file.
   7) im_query_{—}2_hits <db><query.fasta>

Here both database and query are in FASTA format. Database is: /data/Medline.fasta. Query is ANY entry from Medline.fasta, or anything from the web. In the later case, the parser should convert any format of user-provided file into a FASTA formatted file confirming to the standard specified in Item 2.

The output from this program should be a List_file of Primary_Id and Raw_scores. If the current output is a list of Binary_ids, it can be easily transformed to Primary_ids by running: im_retrieve Medline.bid2pid <bid_list>>pid_list.

On generating the candidates, here is a re-phrasing of what was discussed above:

1) Calculate an ES-score (Estimated Shannon score) based on the top ten words query (10-word list) which has lowest frequency in the frequency-dictionary of database.
2) ES-score should be calculated for all the files. A putative hit is defined by:
(a) Hits 2 words in the 10-word list.
(b) Hit THE word, the highest Shannon-score for the words in the query. In this way, we don't miss any hit that can UNIQUELY DEFINE A HIT in the database.

Rank all the a) and b) hits by ES-score, and limit the total number up to 0.1% of database size (for example, 14,000 for a db of 14,000,000). (If the union of (a) and (b) is less than 0.1% of database size, the rank does not have to be performed, simply pass the list as done; this will save time).

3) Calculate the Estimated Score using the formulae disclosed below in item 8, except in this case there are at most ten words.

8) im_rank_hits <Medline.fasta><query.fasta><pid_list>

The first thing the program does is to run: im_retrieve Medline.fasta pid_list and store all the candidate hits in memory before starting the 1-1 comparison of query to each hit file.

Summary: Each of the database file mentioned above (Medline.*) should be indexed using im_index. Please don't forget to specify the format of each file in running im_index.

If temporary files to hold your retrieved contents are desired, put them in /tmp/directory. Please use the convention of $$.* to name your temporary files, where $$ is your process_id. Remove these temp files generated at a later time. Also, no permanent files should be placed in /tmp.

### Formulae for Calculating the Scores:

p-value: the probability that the common word list between the query and the hit is completely due to a random event.

Let T_{w} be total number of words (for example, SUM (word*word_freq)) from the word_freq table for the database (this number should be calculated be written in the header of the file: Medline.freq.stat. One should read that file to get the number. For each dictionary word (w[i]) in the query, the frequency in the database is f_{d}[i]. The probability of this word is: p[i]=f_{d}[i]/T_{W}.

Let the frequency w[i] in the query be f_{q}[i], and frequency in the hit be fₕ[i], f_{c}[i]=min(f_{q}[i], fₕ[i]). f_{c}[i] is the smaller number of frequency in the query and hit. Let m be the total common words in the query, i=1, . . . , m, p-value is calculated by:

p=(Sᵢf_{c}[i])!(p_{—}ip[i]**f_{c}[i])/(p_{—}if_{c}[i]!)

where Sᵢ is the summation of all i (i=1, . . . , m), and p_i means the multiplication of all i, (i=1, . . . , m), ! is the factorial (for example, 4!=4*3*2*1)

p should be a very small number. Ensure that floating type is used to do the calculation. SI_score (Shannon Information score) is the −log₂ of p-value.
3. word_% (#_shared_words/total_words). If a word appears multiple times, it is counted multiple times. For example: query (100 words), hit (120 words), shared words 50, then word_%=50*2/(100+120).

### Example III

### Method for Generating a Dictionary of Phrases

### 1. Theoretical Aspects of Phrase Searches

Phrase searching is when a search is performed using a string of words (instead of a single word). For example: one might be looking for information on teenage abortions. Each one of these words has a different meaning when standing alone and will retrieve many irrelevant documents, but when you one them together the meaning changes to the very precise concept of “teenage abortions”. From this perspective, phrases contain more information than the single words combined.

In order to perform phrase searches, we need first to generate phrase dictionary, and a distribution function for any given database, just like we have them for single words. Here a programmatic way of generating a phrase distribution for any given text database is disclosed. From purely a theoretical point of view, for any 2-words, 3-words, . . . , K-words, by going through the complete database the occurring frequency of each “phrase candidate” are obtained, meaning they are potential phrases. A cutoff is used to only select those candidates with frequency that is above a certain threshold. The threshold for a 2-word phrase many be higher than that for a 3-word phrase, etc.. Thus, once the thresholds are given, the phrase distribution for 2-word, . . . , K-word phrases are generated automatically.

Suppose we already have the frequency distribution for 2-word phrases F(w2), S-word phrases F(w3), . . . , where w2 means all the 2-word phrases, and w3 all the 3-word phrases. We can assign Shannon Information for phrase wk (a k-word phrase):

SI(wk)=−log₂f(wk)/T_{wk}

where f(wk) is the frequency of the phrase, and T_{wk} is the total number of phrases within the distribution F(wk).

Alternatively, we can have a single distribution for all phrases, irrespective of the phrase length, we call this distribution F(wa). This approach is less favored compared to the first, as we usually think a longer phrase would contain more information compare to a shorter phrase, even they occurred the same number of times within the database.

When a query is given, just like the way we generate a list of all words, we can generate a list of all potential phrases (up to K-word). We can then look at the phrase dictionary to see if any of them are real phrases. We select those phrases within the database for further search.

Now we assume there exists a reverse dictionary for phrases as well. Namely for each phrase, all the entries in the database containing this phrase is listed in the reverse dictionary. Thus, for the given phrases in the query, using the reverse dictionary we can find out which entries contain these phrases. Just as we handle words, we can calculate the cumulative score for each entry which contain at lease one of the query phrases.

In the final stage of summarizing the hit, we can use alternative methods. The first method is to use two columns, one for reporting word score, and the other for reporting phrase score. The default will be to report all hits ranked by cumulative Shannon Information for the overlapped words, but with the cumulative Shannon Information for the phrases in the next column. The user can also select to use the phrase SI score to sort the hits by clicking the column header.

In another way, we can combine the SI-score for phrases with that of SI for the overlapped words. Here there is a very important issue: how should we compare the SI-score for words with the SI-score for phrases. Even within the phrases, as we mentioned above, how we compare the SI-score for a 2-word phrase vs. a 3-word phrase? In practice, we can simply using a series of factors to merge the various SI-scores together, that is:

SI_total=SI_word+a₂*SI_{—}2-word-phrase+ . . . +a_{K}*SI_{—}K-word-phrase

where aₖ, k=2, . . . , K are coefficients that are >=1, and are monotonic increasing.

If the consideration of adjusting for phrase length is already taken care in the generation of a single phrase distribution function F(wa), then, we have a simpler formulae:

SI_total=SI_word+a*SI_phrase

where a is a coefficient: a>=1. a reflects the weighting between word score and phrase score.

This method of calculation of Shannon Information is applicable to either a complete text (that is, how much total information a text has within the setting of a given distribution F, or to the overlapped segments (words and phrases) between a query and a hit.

### 2. Medline Database and Method of Automated Phrase Generation

Program 1: phrase_dict_generator

1). Define 2 hashes:
CandiHash: a hash of single word that may serve as a component of a Phrase.
PhraseHash: a hash to record all the discovered Phrases and their frequencies.
Define 3 parameters:

### WORD_FREQ_MIN=300

### WORD_FREQ_MAX=1000000

### PHRASE_FREQ_MIN=100

2). From the word freq table, take all the words with frequncy >=WORD_FREQ_MIN, and <=WORD_FREQ_MAX. Read them into The CandiHash.
3). Take the Medline.stem file (if this file has preserved the word orders in the original file, otherwise you have to regenerate a Medline.stem file such that the word order in the original file is preserved).
Psuedo code:

```
while (<Medline.stem>) {
      for each entry {
            Read in 2 words a time, shift 1 word a time
            check if both words are in CandiHash, if yes:
                  PhraseHash{word1_word2}++;
    }
}
```

4). Loop step 2 until 1) the end of Medline.stem
or 2) system close to Memory_Limit.
If 2) write PhraseHash, clear PhraseHash, continues while(<Medline.stem>) until END OF Medline.stem
   5). If multiple outputs from step 4, merge sort the outputs >Medline.phrase.freq.0.
If finishes with condition 1), sort PhraseHash >Medline.phrase.freq.0.
   6). Any thing in Medline.phrase.freq.0 with frequency >PHRASE_FREQ_MIN is a phrase. Sort all those entries into: Medline.phrase.freq.

Program 2. phrase_db_generator

1). Read in Medline.phrase.freq into a Hash: PhraseHash_n
2).

```
while (<Medline.stem>) {
    for each entry {
        Read in 2 words a time, shift 1 word a time
        Join the 2 words, and check if it is defined in the PhraseHash_n
        if yes {
            write Medline.phrase for this entry}
        }
    }
```

Program 3. phrase_revdb_generator

This program generates Medline.phrase.rev. It is generated the same as the reverse dictionary for words. For each phrase, this file contains an entry that lists all the binary_ids of all database entries that contain this phrase.

### Example IV

### Command-Line Search Engine for Local Installation

A stand-alone version of the search engine is developed. This version does not have the web interface. It is composed of many programs mentioned before and compiled together. There is a single Makefile. When “make install” is typed, the system compiles all the programs within that directory, and generate three main programs that are used. The three programs are:

### 1) Indexing an Database:

im_index_all: all program that generates a number of indexes, including the word/phrase frequency tables, and the forward and reverse indexes. For example:
$ im_index_all/path/to/some_db_file_base.fasta

### 2) Starting the Searching Server:

im_GSSE_server: this program is the server program. It loads all the indexes into memory and keeps running on the background. It handles the service requests from the client:
im_GSSE_client. For example:
$ im_GSSE_server/path/to/some_db_file_base.fasta

### 3) Run Search Client

Once the server is running, one can run a search client to perform the actual searching. The client can be run locally on the same machine, or remotely from a client machine. For example:
$ im_GSSE_client-qf/path/to/some_query.fasta

### Example V

### Compression Method for Text Database

The compression method outlined here is for the purpose of shrinking the size of the database, save the usage of hard disk and system memory, and to increase the performance of computer. It is also an independent method that can be applied to any text-based database. It can be used alone for compression purpose, or it can be combined with current existing compression techniques such as zip/gzip etc.

The basic idea is to locate the words/phrases of high frequency, and replace these words/phrases with shorter symbols (integers in our case, called code hereafter). The compressed database is composed of a list of words/phrases, and their codes, and the database itself with the words/phrases replaced with code systematically. A separate program reads in the compressed data file and restores it to original text file.

Here is the outline of how the compression method works: During the process of generating all the word/phrase frequency, assign a unique code to each word/phrase. The mapping relationship between the word/phrase and its code is stored in a mapping file, with the format: “word/phrase, frequency, code”. This table was generated from a table with “word/phrase, frequency” only, and the table was sorted by the reverse order of length(word/phrase)*frequency. The code is assigned to this table from row 1 to the bottom sequentially. In our case the code is an integer starting at 1. Before the compression, all the existing integers in the database have to be protected by using a non-text character in its front.

Those skilled in the art will appreciate that various adaptations and modifications of the just-described embodiments can be configured without departing from the scope and spirit of the invention. Other suitable techniques and methods known in the art can be applied in numerous specific modalities by one skilled in the art and in light of the description of the present invention described herein. Therefore, it is to be understood that the invention can be practiced other than as specifically described herein. The above description is intended to be illustrative, and not restrictive. Many other embodiments will be apparent to those of skill in the art upon reviewing the above description. The scope of the invention should, therefore, be determined with reference to the appended claims, along with the full scope of the disclosed invention to which such claims are entitled.

### The Present Technology Overcomes the Limitations

We have proposed a new approach towards search engine technology. We call our technology “Global Similarity Search”. Instead of trying to match keywords one by one, we look at the search problem from another perspective: the global perspective. Here, the match of one or two keywords is not essential anymore. What matters is the overall similarity between a query and its hit. The similarity measure is based on Shannon information entropy, a concept that measures the information amount of each itom. An itom is a word or phrase, and is generated automatically by the search engine during the indexing step. There are certain frequency limitations on the generation of itoms: 1) very common words are excluded; 2) phrases have to meet a minimum occurrence based on number of words they contain; 3) an itom cannot be part of another itom.

Our search engine has the certain characteristics:
No limitation on number of words. Actually, we encourage users to write down whatever he wants. The more words in a query, the better. Thus, in our search engine, the query may be a few keywords, an abstract, a paragraph, a full-text article, or a webpage. In other words, our search engine will allow “full-text query”, where the query is not limited to a few words, but can be the complete content of a text file. We encourage the user to be specific about what they are seeking. The more detailed they can be, the more accurate information they will be able to retrieve. A user is no longer burdened with picking keywords.
No limit on database content, not limited to Internet. As our search engine is not dependent on link number, our technology is not limited by the database type, with the only limitation that it is text-based. Thus, it can be any text content, such as hard-disk files, emails, scientific literature, legal collections, etc.
Huge database size is a good thing. In a global similarity search, the number of hits is usually very limited if you can be specific about what you want. The more specific one is about his query, the less hits he will get. Huge size in database is actually a good thing to us, as we are more likely to find records a user wants. In keyword-based searches, large database size is a killing factor, as the number of records containing the few keywords is usually very large.
No language barrier. The technology applies to any language (even to alien languages if someday we receive them). The search engine is based on information theory, and not on semantics. It does not require any understanding on the content. We can adopt our search engine to any existing language in the world with little effort.
Most importantly, what you want is what you get. Non-biased in any way. We introduced a new scoring system that is based on Shannon Information Theory. For example, the word “the” and the phrase “search engine” carries different amount of information. Information amount of each itom is intrinsic to the database it is in. We rank the hits by the amount of information in the overlapping itoms between the query and the hits. In this way, we guarantee that the most relevant entries within the database to the query will score the highest. This ranking is purely based on the science of Information Theory. It has nothing to do with link number, webpage popularity or advertisement fees. Thus, our ranking is really objective.

Our angle of improving user search experience is quite different from other search engines such as provided by Yahoo or Google. Traditional search engines, including Yahoo and Google, are more concerned with a word, or a short list of words or phrases, whereas we are solving the problem of a larger text with many words and phrases. Thus, we need an entirely different way of finding and ranking hits. How to rank the hits that contain all the query words is not our top priority (but we still handle that), as this problem rarely occurs for long queries. In the case that there are many hits, all containing the query words, we recommend the user refining their search by providing more description. This will allow our engine to better filter out irrelevant hits.

Our main concern is the method to rank hits with different overlaps with the query. How should we rank them? Our solution has its root in the “informational theory” developed by Shannon for communication. We applies Shannon's information concept to text databases with given discrete distributions. Information amount of each itom is determined by its frequency within the database. We use the total amount of information in shared itoms between the two articles to measure the relevancy of a hit. The whole database entries can be ranked this way, with the most relevant entry having the highest score.

### Relationship to Vector-Space Models

The vector-space models for information retrieval are just one subclass of retrieval techniques that have been studied in recent years. Vector-space models rely on the premise that the meaning of a document can be derived from the document's constituent terms. They represent documents as vectors of terms d(t₁, t₂, . . . , tₙ) where tᵢ is a non-negative value denoting the single or multiple occurrences of term i in document d. Thus, each unique term in the document collection corresponds to a dimension in the space. Similarly, a query is represented as a vector where term is a non-negative value denoting the number of occurrences of (or, merely a 1 to signify the occurrence of term) in the query. Both the document vectors and the query vector provide the locations of the points in the term-document space. By computing the distance between the query and other points in the space, points with similar semantic content to the query presumably will be retrieved.

Vector-space models are more flexible than inverted indices since each term can be individually weighted, allowing that term to become more or less important within a document or the entire document collection as a whole. Also, by applying different similarity measures to compare queries to terms and documents, properties of the document collection can be emphasized or deemphasized. For example, the dot product (or, inner product) similarity measure finds the Euclidean distance between the query and a document in the space. The cosine similarity measure, on the other hand, by computing the angle between the query and a document rather than the distance, deemphasizes the lengths of the vectors. In some cases, the directions of the vectors are a more reliable indication of the semantic similarities of the points than the distance between the points in the term-document space.

Vector-space models, by placing terms, documents, and queries in a term-document space and computing similarities between the queries and the terms or documents, allow the results of a query to be ranked according to the similarity measure used. Unlike lexical matching techniques that provide no ranking or a very crude ranking scheme (for example, ranking one document before another document because it contains more occurrences of the search terms), the vector-space models, by basing their rankings on the Euclidean distance or the angle measure between the query and terms or documents in the space, are able to automatically guide the user to documents that might be more conceptually similar and of greater use than other documents. Also, by representing terms and documents in the same space, vector-space models often provide an elegant method of implementing relevance feedback. Relevance feedback, by allowing documents as well as terms to form the query, and using the terms in those documents to supplement the query, increases the length and precision of the query, helping the user to more accurately specify what he or she desires from the search.

Among all search methods, our method is most closely related to the vector-space model. But we are distinctive in many aspects as well. The similarity is that both methods takes a “full-text as query” approach. It uses the complete “words” and “terms” in comparing query and hits. Yet in traditional vector-space model, the terms and words are viewed equally. There is no introduction of statistical concepts into measuring the relevance or in describing the database at hand. There is no concept of information amount associated with each word or phrase. Further, words and phrases are defined externally. As there is no statistics in the words used, there is no automated ways in term identification either. The list of terms has to be provided externally. The vector-space model fails to address the full-text search problem satisfactorily, as it does not contain the idea of distribution function for databases, and the concepts of itoms and their automated identification. It fails to recognize the connection between “informational relevance” required by a search problem and “informational theory” as proposed by Shannon. As a result, vector-space model has not been successfully applied commercially.

Language-Independent Technology with Origin in Computational Biology

Our search engine is language-independent. It can be applied to any language, including non-human languages, such as the genetic sequence databases. It is not related to semantics study at all. Most of the technology was first developed in computational biology for genetic sequence databases. We simply applied it to the text database search problem with the introduction of Shannon information concepts. Genetic database search is a mature technology that has been developed by many scientists for over 25 years. It is one of the main technologies that achieved the sequencing of human genome, and the discovery of the ˜30,000 human genes.

In computational biology, a typical sequence search problem is as following: given a protein database ProtDB, and a query protein sequence ProtQ, find all the sequences in ProtDB that are related to ProtQ, and rank all them based on how close they are to ProtQ. Translating that problem into a textual database setting: for a given text database TextDB, and a query text TextQ, find all the entries in TextDB that are related to TextQ, and rank them based how close they are to TextQ. The computational biology problem is well-defined mathematically, and the solution can be found precisely without any ambiguity using various algorithms (Smith-Waterman, for example). Our mirrored text database search problem has a precise mathematical interpretation and solution as well.

For any given textual database, irrespective of its language or data content, our search engine will automatically build a dictionary of words and phrases, and assign Shannon information amount to each word and phrase. Thus, a query has its amount of information; an entry in the database has its amount of information; and the database has its total information amount. The relevancy of each database entry to the query is measured by the total amount of information in overlapped words and phrases between a hit and a query. Therefore, if a query and an entry have no overlapped itoms will have a score of 0. If the database contains the query itself, it will have the highest score possible. The output becomes a list of hits ranked according to their informational relevancy to the query. We provide alignment between query and each hit, where all the shared words and phrases are highlighted with distinct colors; and the Shannon information amount for each overlapped word/phrases is listed. Our algorithm for the ranking is quantitative, precise, and completely objective.

### Itom Identification and Determination

The following provides an introduction to several terms used in the foregoing text. The terms should be construed in the broadest possible sense, and the following descriptions are intended to be illuminating rather than limiting.

Itom: itom is the basic information unit that makes up a text entry. It can be a word, a phrase, or an expression pattern composed of disjoint words/phrases that meets a certain restriction requirements (for example: minimum frequency of appearance, externally identified). A sentence/paragraph can be decomposed into multiple itoms. If multiple decomposition of a text exists, the identification of itoms with higher information amount takes precedence over itoms with lower information amount. Once a database is given, our first objective is to identify all itoms within.

Citom: candidate itom. It can be a word, a phrase, or an identifiable expression pattern composed of disjoint words/phrases. It may be accepted as an itom or rejected based on the rules and parameters used. In this version of our search engine, itoms are limited to words or a collection of neighboring words. There is no expression pattern formed by disjoint words/phrases yet.

The following abbreviations are also explained:
1w: one word
3w: 3 words.
f(citom_j): frequency of citom_j, j=1,2
f_min=100; Minimal frequency to select an citom
Tr=100; Minimal threshold FOLD above expected frequency.
Pc=25; Minimal percentage together for two citoms.

### Automated Itom Identification

In this method, we try to identify itoms automatically using a program. It is composed of 2 loops (I & II). For illustration purpose, we limit the maximum itom length as 6 words (it can be longer or shorter). Loop I to go upwards (i=2,3,4,5,6). Loop II to go downwards (i=6,5,4,3,2).

### 1. The Upward Loop

1) for i=2, citoms are just words here. Identify all 2w-citoms with frequency >f_min.
   a) Calculate its expected frequency (E_f=O_f(citom1)*O_f(citom2)*N2, and its observed frequency (O_f). If O_f>=Tr*E_f, keep it. (N2: total count of 2-citom items)
   b) Otherwise, if O_f>=Pc % *min(f(citom_{—}1), f(citom_{—}2)), keep it. (Pc % of all possibilities for the 2 citoms appearing together), keep it.
   c) Otherwise, reject.

Let's assume the remaining set is: {2w_citoms}. What are we getting here? We are getting two distinct collection of potential phrases (1) that these two words occurs together much high than expected; (2) in more than 25% of cases, these two words appears together.
2) for i=3, for each citom in {2w_citoms}, identify all 3 words citoms (the 2-word citom plus a word) with frequency >f_min.
   a) Calculate its expected frequency (E_f=O_f(2w_citom)*O_f(3rd_word)*N3), and its observed frequency (O_f). If O_f>=Tr*E_f, keep it. (N3: total count of 2-citom items in this new setting).
   b) Otherwise, if O_f>=Pc % *min(f(citom_{—}1), f(citom_{—}2)), keep it. (Pc % of all possibilities for the 2 citoms appearing together), keep it. (citom_{—}2 is the 3rd word).
   c) Otherwise, reject.

We will have a set: {3w_citoms}. Please notice {3w_citoms} is a subset of {2w_citoms}.
3) For i=4,5,6, repeat similar steps. The results are: {4w_citoms}, {5w_citoms}, {6w_citoms}.

Please notice, in general, we have: {2w_citoms} contains {3w_citoms}, {3w_citoms} contain {4w_citoms}, . . .

### 2. The Downward Loop

For i=6, {6w_citoms} are automatically accepted as itoms. It is {6w_itoms}. Thus: {6w_citoms}={6w_itoms}. In real world, if there is a 7-word itom, it may appear strange in our itom selection, as we only capture the FIRST 6-words as an itom, leaving the 7th-word out. For 8-word itoms, 7th & 8th words will be left out.
For i=5, for each citom in {5w_citoms}-{6w_itoms}, citom_j:
   If f{citom_j}>f_min, them, citom_j is a member of {5w_itoms}.
For i=4, for each citom in {4w_citoms}-{5w_itoms}-{6w_itoms}, citom_j:
   If f{citom_j}>f_min, them, citom_j is a member of {4w_itoms}.
For i=3, 2, do the same thing.

Thus, we have generated a complete list of all itoms, for i=2, 6. Any word that is left, and it is not a member of {Common_words}, it belongs to {1w_itoms}. There is no MINIMUM frequency requirement for 1w-itom.

### Uploading an External Itom Dictionary

We can use external keyword dictionary. 1) Any phrase from the external dictionary, if appears in our database of interest, no matter how low the frequency, and irrespective its number of words contained, will become an itom immediately; or 2) We may put a minimum frequency requirement. In that case, the minimum frequency may be the same or different from the minimum frequency used in automated itom selection.

This step may be done before or after the automated itom identification step. In our current implementation, this step is done before the automated itom identification step. The external itoms may become part of an automatically identified itoms. These itoms are replaced with SYMBOLS, and treated as the same as other characters/words we will handle in the text. As a result, some externally input itoms may not appear in the final itom list. Some will remain.

### Localized Alignments via High Scoring Windows and High Scoring Segments

### The Need for Localized Alignments

Reason: if a query is a short article, and there are two hits, one is long (the long-hit), and one is short (the short-hit). The relevancy between the query and the long-hit may be low, but our current ranking may rank long article high as the long article has a more likelihood of containing itoms in the query. We would like to fix this bias toward long articles by introducing local alignments.

Approach: we will add one more column to the hit page, called “Local Score”, previous column of “Score” should be renamed as “Global score”. The searching algorithm to generate the “Global score” is the same as before. We will add one more Module, called Local_Score to re-rank the hit articles in the final display page.

Here we set a few parameters:
1. Query_size_min, default, 300 words. If a query is less than 300 words (such as the case in keyword-based searching), we will use 300 words.
2. Window_size=Query_size*1.5. (e.g., if query size is 10 words, then Window_size=450).

If the hit size is less than Window_size, Local_Score=Global_Score. The Local_Alignment is the same as the “Global_Alignment”.

If a hit is longer than Window_size, then, the “Local Score” and “Local Alignment” will change. In this case, we pick a window size of Window_size that contain the HIGHEST score among all possible windows. The Left_link will always display the “Local Alignment” as default, but has a button on the upper right corner of the page, so that “Global Alignment” can be selected, and in that case, the page refreshes, and displays the global alignment.

The right side now will have two links, one to the “Global Score”, and one to the “Local Score”. The “Global Score” link is the same as before, but the “Local Score” link will only display those itoms within the Local Alignment.

The sort order for all the hits should be by Local Score by default. When a user selects to resort by click the “Global Score” column heading, it should re-sort by Global Score.

### Finding the Highest-Scoring Window

We will use Window_size=450 to find the highest-scoring window. The other cases are obvious.

1) Locate a 450-words window by scanning with 100-words steps, and joining it with its left and right neighbor.

If an article is less than 450 words, then, there is no need to refine the alignment. If is longer than 450 words, we will shift the window 100 words each time, and calculate the Shannon_Information for that window. If the last window has less than 450 words, open it up to the left-side until it is 450-words in length. Find the highest score window, and select the window that is one left to it, and one right to it. If the highest score window is either a left-most or right-most window, you only have two windows. Merge the 3 (or 2) windows together. This window, with size between 451-650 words is our top candidate. If there are multiple windows with the Highest score, always use the Left-most window.

2) Narrow down further to a window of 450 words only

Similar to step 1, now scanning the region with 10-word steps. Find the one with the highest score. Merge it with the left and right side windows if there is any. Now you have a window of maximum width of 470 words.

3) Now, do the same scanning, using a 5-word step. Then a 2-word step. Then a one-word step. You are done!

Don't forget to use the Left-most rule if you have more than one window with the same score.

### Aligning High-Scoring Windows

The section above provides an algorithm for identifying a window for the TOP-hit segment. We should EXTEND that logic to identify the 2nd-hit segment, the 3rd-hit segment. Each time, we first REMOVE the identified hit segment from the hit article. We run the same algorithm on ALL the fragments after the removal of a HIGH-SCORE segment. Here is the outline of the algorithm:

1). Set default threshold for selecting a High-score Window as 100. Except for the TOP-hit window, we will not display any additional alignment that is less than this threshold.
2). For a given hit which is Longer than 450 words, or 1.5*query_length, we want to identify all additional High-score segments that is >100.
3). We identify the Top-hit segment as given in the section above.
4). Remove the Top-hit segment, for each of the REMAINING segment, run the same algorithm below.
5). Use a window size of 450, identify the TOP-hit window within that segment. If the TOP-hit is less than Threshold, EXIT. Otherwise, push that TOP-hit into a Stack of Identified HSWs (High Scoring Window). Go to Step 4).
6). Narrowing the display window by DROPPING beginning and ending Low-hit sentences.
After we obtained a 450-word window with threshold above the Threshold, we FURTHER drop a Beginning Segment, and an End Segment within the Window to narrow the Window size. For the left side, we search from beginning, until we hit the VERY FIRST of an ITOM with Information Amount in the TOP 20 ITOMS within the Query. The beginning of that Sentence will be our New Beginning for the Window.
For the right side, the logic is the same. We search from right-side until the VERY first ITOM that is in the TOP-20 ITOM list. We keep that sentence as the last sentence for the HSW. If no TOP 20 ITOMS are within the HSW, we drop the WHOLE WINDOW.
7). Reverse-sort the HSW stack by Score, display Each HSW next to the Query.

### An Alternative Method: Identifying High Scoring Segments

A candidate entry is composed of a string of itoms separated by non-itomic substances, including words, punctuation marks, and text separators such as ‘paragraph separator’ and ‘section separator’. We will define a penalty array y->{x} for non-itomic substances, where x is word, punctuation marks, or separators, and y->{x} is the value of the penalty. The following constraints should exist for the penalty array:
1) y->{x}<=0, for all x.
2) y->{apostrophe}=y->{hyphen}=0.
3) y->{word}>=y->{comma}>=>=y->{colon}=y->{semicolon}>=y->{period}=y->{question mark}=y->{exclamation point}>=y->{quotation mark}.
4) y->{quotation mark}>=y->{parentheses}>=y->{paragraph}>=y->{section}.

Additional penalties may be defined for additional separators or punctuation marks not listed here. As an example, here is a tentative set for the parameter values:
y->{apostrophe}=y->{hyphen}=0.
y->{word}=−1.
y->{comma}=−1.5.
y->{colon}=y->{semicolon}=−2.
y->{period}={question mark}=y->{exclamation point}=−3.
y->{parentheses}=−4.
y->{paragraph}=−5l
y->{section}=−8.

Here are the detailed algorithm steps to identify high-scoring segments (HSSs). HSS concept is different from High-scoring window concept in the sense we don't have an upper limit on how long the segment can be.
1) The original string of itomic and non-itomic substances can now be converted into a string of positive (for itoms) and non-positive numbers (non-itomic substances).
2) Continuous positive stretches or continuous negative stretches should be merged to give a combined number for that specific stretch. Thus, after merging the consecutive numbers within the string always alternates between positive and negative values.
3) Identifying HSSs. Let's define a “maximum allowable gap penalty for gap initiation”, gimax. (Tentatively, we can set giₘₐₓ=30).
   a. Start with the highest positive number. We will extend in both directions.
   b. If at any time, a negative score SI(k)<−giₘₐₓ, we should terminate the HSW at that direction.
   c. If SI(k+1)>−SI(k), continue extending. (The cumulative SI score will increase). Otherwise, also terminate.
   d. After terminating in both directions, report the positions of termination,
   e. If cumulative SI score is >100, and total number of HSS is less than 3, keep it. Continue to step a. Otherwise, terminate.

The parameters discussed within this section needs to be fine-tuned, so that we have meaningful calculations in the above step. Also, these parameters may be set by users/programmers based on their preferences.

The identification of the HSS within the query text is much simpler. Now we will only care for those itoms contained within the HSS. We start from both ends of the query, until we run into the very first itom that is in the hitting HSS, we stop. That will be our starting (ending) position depending on which side you are looking from.

### Displaying HSW and HSS on the User Interface

There are two types of local alignments, one based on HSW, and the other based on HSS. For the purpose of convenience, we will just use HSW. The same arguments apply to HSS as well. For each HSW, we should align the query text to the center of that HSW in the hit. The Query-text will be displayed the same times as the number of HSWs. Within each HSW, we highlight only the hit-itoms within that HSW. The query text will also be trimmed on both ends to remove the non-aligning elements. The positions of the remaining query text will be displayed. Itoms within the query text that is only in the HSW of the hit will be highlighted.

For the right link, we SHOW the list of ITOMs by each HSW as well. Therefore when the Localized_score is clicked, a window pops up, listing in the order of HSWs, each itom and their scores. For each of the HSW, we will have one line as the Header, showing the Summary Information about that HSW, such as the Total_score.

We leave one empty line between each HSW. For example, this is an output showing 3 HSWs.

```
(on the left side of popup, centered)
...
Query
100 ... bla bbla aa bll aaa aa lllla bbb blalablalbalblb
    blabla bla blablabal baaa aaa lllla bbb blalablalbalblb
    blabla bla blablabal baaa aaa lllla bbb ...313
... (leave sufficient vertical space here to generate meaningful visual
effect for an alignment).
Query
85 ...blabla bla blablabal baaa aaa lllla bbb blalablalba
    blabla bla blablabal baaa aaa lllla bbb blalablalbalblb
    blabla bla blablabal baaa aaa lllla bbb bbbaaavvva aaa
    aaa blablablal bbaa ...353
    ... (leave sufficient vertical space here to generate meaningful visual
effect for an alignment).
Query
456 ... blabla bla blablabal baaa aaa lllla bbb blalablal
    blabla bla blablabal baaa aaa lllla bbb blalablalbalblb
    blabla bla blablabal baaa aaa lllla bbb ...833
(on the right side of popup)
>ESP88186854 My example of showing a hit with 3 HSWs [DB: US-
PTO]
Length=313 words. Global_score = 345.0, Percent Identities
=10/102 (9%)
High scoring window 1. SI_Score = 135.0, Percent Identities =
22/102 (21%)
309 ... blabla bla blablabal baaa aaa lllla bbb blalablalbal
    blabla bla blablabal baaa aaa lllla bbb blalablalbalblb
    blabla bla blablabal baaa aaa lllla bbb blalablalbalblb
    blabla bla blablabal baaa aaa lllla bbb blalablalbalblb
    blabla bla blablabal baaa aaa lllla bbb blalablalbalblb
    blabla bla blablabal baaa aaa lllla bbb ... 611
(leave 2 empty lines here.)
High scoring window 2. SI_Score = 105.7, Percent Identities = 15/102
(14%)
10 ... blabla bla blablabal baaa aaa lllla bbb blalablalbal
    blabla bla blablabal baaa aaa lllla bbb blalablalbalblb
    blabla bla blablabal baaa aaa lllla bbb blalablalbalblb
    blabla bla blablabal baaa aaa lllla bbb ... 283
(leave 2 empty lines here.)
High scoring window 2. SI_Score = 85.2, Percent Identities =
10/102 (10%)
812 ... blabla bla blablabal baaa aaa lllla bbb blalablalbal
    blabla bla blablabal baaa aaa lllla bbb ... 988
```

### Variations on the Search Methods

The method disclosed here is based on Shannon information. There are other presentations of the same or similar method, but with different appearance. Here we give a few such examples.

### Employing Statistical Method and Measuring in P-Value, E-Value, Percent Identity, and Percent Similarity

As Shannon information is based on statistical concepts and is related to distribution function, the similarity between query and hit can also be measured in statistical quantities as well. Here the key concepts are p-values, e-values, and percent identity.

The significance of each alignment can be computed as a p-value or an e-value. E-value means expectation value. If we assume the given distribution of all the itoms within a database, and for the given query (with its list of itoms), e-value is the number of different alignments with scores equivalent to or better than SI-score between query and hit that are expected to occur in a database search by chance. The lower the e-value, the more significant the score. p-value is the probability of an alignment occurring with the score in question or better. The p-value is calculated by relating the observed alignment SI-score to the expected distribution of HSP scores from comparisons of random entries of the same length and composition as the query to the database. The most highly significant p-values will be those close to 0. p-value multiplied by the total number of entries in the database gives e-value. p-values and e-values are different ways of representing the significance of the alignment.

In genetic sequence alignment, there is a mathematical formula expressing the relationship between a S-score and p-value (or e-value). That formula is derived by making some statistical assumptions on the description nature of database and its entries. Similar mathematical relationship between SI-score and p-value exists. It is a subject needs further theoretical research.

Percent identity is a measure of how many itoms in the query and the hit HSP are matched. For a given identified HSP, it is defined as (matched itoms)/(total itoms)*100%. Percent similarity is the (summation of SI-score of matched itoms)/(total SI-score of itoms). Again, these two numbers can be used to as a measure of similarity between the query and hit for a specific HSP.

### Employing Physical Method and the Concept of Mutual Information

Another important concept is mutual information. How much information does one random variable tell about another one? When we look at the hit HSP, it is a random variable that is related to the query (another random variable). What we want to know is once we are given the observation (the hit HSP), how much we can say about the query. This quantity is the mutual information:

I(X;Y)=ΣxΣyp(x,y) log p(x,y)/(p(x)*p(y))

Where X, Y are two random variables within the distribution space, p(x), p(y) is their distribution, and p(x,y) is the joint distribution of X, Y. Note that when X and Y are independent (when there is no overlapped itoms between the query and the hit), p(x,y)=p(x) p(y) (definition of independence), so I(X;Y)=0. This makes sense: if they are independent random variables then Y can tell us nothing about X.

### Employing Externally Defined Probability/Frequency Matrix on Some or all Itoms

The probability, frequency, or Shannon information of itoms can be calculated from the database within. It can also be specified from outside. For example, probability data can be estimated from random sampling of a very large data set. A user can also alter the SI-score of itoms if he specifically want to amplify/diminish the effect of a certain itoms. People with different professional backgrounds may prefer to use a distribution function appropriate for his specific field of research. He may upload that itomic score matrix at search time.

### Employing an Identity Scoring Matrix or Cosine Function for Vector-Space Model

If a user prefers to view all itoms equally, or think that all itoms should have equal amount of information, then he is using something called identity scoring matrix. In this case, he is actually reducing our full-text searching method to something similar to vector-space model, where there is no weighting at all on any specific words (except in our application here words should be replaced with itoms).

The information contained in a multi-dimensional vector can be summarized in two one-dimensional measures, length and angle with respect to a fixed direction. The length of a vector is the distance from the tail to the head of the vector. The angle between two vectors is the measure (in degrees or radians) of the angle between those two vectors in the plane that they determine. we can use one number, the angle between the document vector and the query vector, to capture the physical “distance” of that document from the query. The document vector whose direction is closest to the query vector's direction (i.e., for which the angle is smallest) is the best choice, yielding the document most closely related to the query.

We can compute the cosine of the angle between the nonzero vectors x and y by:

cosine α=x^{T}y/(∥x∥∥y∥)

In the traditional vector-space model, the vector of x and y are just numbers recording the appearance of the words and terms. If we change that to the information amount for the itoms (counting duplications), then we obtain a measure of similarity between the two articles in the informational space. This measure is related to our SI-score.

### Employing Other Search Engines as an Intermediate

In some occasions, one may want to use other search engines as an intermediate. For example, if Google or Yahoo has a large internet database, but we don't have it. Or due to space limitation we don't want to have it installed locally. In this case, one can use the following approach to search:
1. Upload an itomic scoring matrix (this can be from external sources or from random sampling, see Section 4.3).
2. When given a full-text as query, select a limited number of high-information content itoms based on the external website's preference. For example, if Google performs best with ˜5 keywords, lets select 10-20 high information content itoms from the query.
3. Let's split the ˜20 itoms into 4 groups, and query the Google site with the 5 itoms. Retrieve the results into local memory.
4. Combine all the retrieved hits into a small database. Now, run our 1-1 alignment program between query and each hit. Calculate the SI-score for each retrieved hit.
5. Report the final results with the order of SI-scores.

### Score Calculation Employing Similarity Coefficient Matrices

### Extending Exact Matching of Itoms to Allowing Similarity Matrices

Typically, we require the hit and the query to share the same exact itoms. This is called exact match, or “identity mapping” when used in sequence alignment problems. But this is not necessary. In a very simple implementation of allowing user to use synonyms, we allow a user to define a table of itom synonyms. These query itoms with synonyms will be extended to search the synonyms in the database as well. This feature is currently supported by our user interface. The uploading of this user-specific synonym list does not change the Shannon information amount of involved itoms. This is a preliminary implementation.

In a more advanced implementation, we allow users to perform “true similarity” searches by loading various “similarity coefficient matrices.” These similarity coefficient matrices provide lists of itoms that have similar meaning, and assign a similarity coefficient between them. For example, the itom “gene chip” has a 100% similarity coefficient to “DNA microarray”, but may have a 50% similarity coefficient to “microarray”, and a 30% similarity coefficient to “DNA samples”; as another example, “UCLA” has 100% similarity coefficient to “University of California, Los Angeles”, and it has 50% similarity coefficient to “UC Berkeley”. The source of such “similarity matrices” can be from usage statistics or from various dictionaries. It is external to the algorithm. It can be subjective instead of objective. Different users may prefer using different similarity coefficient matrix because his interest and focus.

We require the similarity coefficient between 2 itoms symmetric, i.e., if “UCLA” has a 100% similarity coefficient to “University of California, Los Angeles”, then “University of California, Los Angeles” must have 100% similarity coefficient to UCLA. If we list all the similarity coefficients for all the itoms within a database (with N distinct itoms, and M total itoms), we will form a symmetric matrix of N*N, with all the elements in this matrix 0<=a i j<=1, and the diagonal elements will be 1. Because a itom usually have a very limited number of itoms that are similar to it, the similarity coefficient matrix is also sparse (most of the elements will be zero).

### Computing of Shannon Information for Each Itom

Once a distribution function, and a similarity matrix are given for a certain database, there is a unique way of calculating the Shannon information of each itom:

SI(itom i)=−log₂ [(Σⱼ aᵢⱼ*F (itomⱼ))/M]
Where j=0, . . . N, and M is the total itom counts within the database (M=Σ_{i=0, . . . N} F(itom i)

For example, if the frequency of UCLA is 100, and the frequency of “University of California, Los Angeles” is 200, and all other itoms in the database have a similarity coefficient 0 to these two itoms, then,

SI(UCLA)=SI (“University of California, Los Angeles”)=−log 2 (100+200)/M.

The introduction of similarity coefficient matrix to the system reduces the information amount of involved itoms, and also reduces the total amount of information in each entry, and in the complete database. The reduction of information amount due to the introduction of this coefficient matrix can be exactly calculated.

### Computing of Shannon Information Score Between Two Entries

For a given database with a given itom distribution, and an externally given similarity coefficient matrix for the itoms in the database, how should we measure the SI_score between two entries. Here is the outline:

1. Read in the query, and identify all the itoms within.
2. Look up the similarity coefficient matrix, identify the additional itoms that have non-zero coefficients with these itoms contained in query. This is the expanded itom list.
3. Identify the frequency of the expanded itom list in the hit.
4. Calculate the SI_score between these two entries by:

SI(A₁nA₂)=ΣᵢΣⱼaᵢⱼ min(itom_i in A)SI(itom ij)

### Search Meta Data

Meta data may be involved in text databases. Depending on the specific application, the contents of meta data are different. For example, in a patent database, meta data involves assignee and inventor; it also has distinct dates such as priority date, application date, publication date, issuing date, etc. In a scientific literature database, meta data includes: journal name, author, institution, corresponding author, address and email of corresponding author, dates of submission, revisions, and publication.

Meta data can be searched using available searching technology (word/phrase matching and Boolean logic). For example, one can query for articles published by a specific journal within a specific period. Or one can search meta data collections that contains specific word, and not contain another specific word. Searching by matching keywords, words, and applying Boolean logic, are known art in the field. It is not described here. These searching capacities can be made available next to the full-text query box. They serve as a further restriction in reporting hits. Of course, one may leave the full-text query box empty. In this case, the search becomes traditional Boolean logic based or keyword-matching searches.

### Application to Chinese Language

Chinese language implementation of our search engine is done. We have implemented on two text databases, one is the Chinese patent abstract database, and the other is an online BLOG database. We did not run into any particular problems. There are a few language-specific heuristics that were addressed: 1) we screen against 400 common Chinese characters based on their usage frequency (this number can be adjusted). 2) The identified phrases far-exceeds the number of single characters. This is different from English. The reason is in Chinese, there are only ˜3,000 common characters. Most of the “words”, or “meaning” are expressed by a specific combination of more than one characters. The attached figures show the query and outputs from some Chinese searches using our search engine.

### Metric and Distance Function in Informational Space and Clustering Introduction

Clustering is one of the most widely methods in data mining. It is applied in many areas, such as statistical data analysis, pattern recognition, image processing, and much more. Clustering partitions a collection of points into groups called clusters, such that similar points fall into the same group. Similarity between points is defined by a distance function satisfying the triangle inequality; this distance function along with the collection of points describes a distance space. In a distance space, the only operation possible on data points is the computation of distance between them.

Clustering methods can be divided into two basic types: hierarchical and partitional clustering. Within each of the types there exists a wealth of subtypes and different algorithms for finding the clusters. Hierarchical clustering proceeds successively by either merging smaller clusters into larger ones, or by splitting larger clusters. The clustering methods differ in the rule by which it is decided which two small clusters are merged or which large cluster is split. The end result of the algorithm is a tree of clusters called a dendrogram, which shows how the clusters are related. By cutting the dendrogram at a desired level a clustering of the data items into disjoint groups is obtained. Partitional clustering, on the other hand, attempts to directly decompose the data set into a set of disjoint clusters. The criterion function that the clustering algorithm tries to minimize may emphasize the local structure of the data, as by assigning clusters to peaks in the probability density function, or the global structure. Typically the global criteria involve minimizing some measure of dissimilarity in the samples within each cluster, while maximizing the dissimilarity of different clusters.

Here we first give the definition of an “informational metric space” by extending a traditional vector space model with an “informational metric”. We then show how the metric is extended to a distance function. As an example, we show the implementation of one of the most popular clustering algorithm, the K-mean algorithm, using the defined distance and metric. The purpose of this section is not to exhaustively list all potential clustering algorithms that we can implement, but rather, through one example, to show that various distinct clustering algorithms can be applied once our “informational metric” and “informational distance” concepts are introduced. We also show how a dendrogram can be generated, with the itoms for separation the subgroups listed at each branch.

This clustering method is conceptually related to our “full-text” search engine. One can run the clustering algorithm to put the entire database into a huge dendrogram or many smaller dendrograms. A search can be the process of traverse the dendrogram to the small subclasses and the leaves (individual entries of database). Or one can do a “clustering on the flight”, which means we run a small-scale clustering on the output from a search (the output can be from any search algorithm, not just our search algorithm). Further, one can run clustering on any data collection to the user's interest, for example, a selected subset of outputs from a search algorithm.

### Distance Function of Shannon Information

Our method extends on the vector-space model. The concept of itom is an extension of a term in the vector-space model. We further introduce the concept of informational amount for each itom, which is a positive number associated with the frequency of the itom.

Let's suppose we are given a text database D, composed of N entries. For each entry x in D, we define a norm (metric) for x, called informational amount SI(x):

SI(x)==Σᵢxᵢ

where xi are all the information amount of itom i that is in x.

For any two entries from D, we define a distance function d(x,y) (where x, y stands for entries, and d(.,.) is a function).

d(x,y)=Σᵢxi+Σⱼyⱼ

where xᵢ are all the information amount of itom i that is in x and not in y, and yj represents all the information amount of itom j that is in y but not in x.

If an itom appears in x m times and in y n times, and m>n, then, it should be calculated as (m−n)*xi; if m<n, then, it should be calculated as (n−m)*yⱼ (here xᵢ=y); if m=n, then its contribution to d(x,y) would be 0.

The distance function defined this way on D qualifies as a distance function, as it satisfies the following properties:
1) d(x,x)=0 for any given x in D.
2) d(x,y)>=0 for any x, y in D.
3) d(x,y)=d(y,x) for any x, y in D.
4) d(x,z)<=d(x,y)+d(y,z) for any given x,y,z in D.

The proofs of these properties are obvious, as the information amount for each itom is always positive. Thus, D with d(.,.) now is a distance space.

K-Means Clustering Algorithms in Space D with Informational Distance

K-means (See J. B. MacQueen (1967): “Some Methods for classification and Analysis of Multivariate Observations, Proceedings of 5-th Berkeley Symposium on Mathematical Statistics and Probability”, Berkeley, University of California Press, 1:281-297) is one of the simplest clustering algorithms. The procedure follows a simple and easy way to classify a given data set through a certain number of clusters (assume k clusters) fixed a priori. The main idea is to identify k best centroids, one for each cluster (to be obtained). For convenience, we will call a data entry in space D a “point”, and the distance between two data entries as distance between 2 points.

What is a centroid? It is determined by the distance function for that space. In our case, for two points in D, the centroids is the point which contains all the overlapping itoms for the given 2 points. We can call such a process a “joining” operation between the 2-points. This idea is easily extensible to obtaining centroids for multiple points. For example, the centroid for 3 points, is the centroid obtained by “joining” the centroid of the first 2 points with the third point. Generally speaking, a centroid for n-points is composed of the shared itoms among all the data points.

The clustering algorithm aims at minimizing an objective function (the cumulative information amount of non-overlapping itoms between all itoms and their corresponding centroids)

E=Σᵢ₌₁^{k}Σⱼ₌₁ⁿⁱd(xᵢⱼ,zᵢ)

where xᵢⱼ is the j-th point in the i-th cluster, z, is the centroid of the i-th cluster, and nᵢ is the number of points in that cluster. The notation d(xᵢⱼ, zᵢ) stands for the distance between xᵢⱼ and zᵢ.

Mathematically, the algorithm is composed of the following steps:
1. Randomly pick k points in the space from the point set that is being clustered. These points represent initial group of centroids.
2. Assign each point to the group that has the closest centroid as given by the distance function.
3. When all points have been assigned, recalculate the positions of the k-centroids.
4. Repeat Steps 2 and 3 until the centroids no longer move. This produces a separation of the points into groups from which the metric to be minimized can be calculated.

Although it can be proved that the procedure will always terminate, the k-means algorithm does not necessarily find the most optimal configuration, corresponding to the global objective function minimum. The algorithm is also significantly sensitive to the initial randomly selected cluster centres. The k-means algorithm can be run multiple times to reduce this effect.

Specifically with our definition of distance, if the data set is very disjoint (composed of unrelated materials), the objective of reducing to k-clusters may be not obtainable if k is too small. If this situation happens, k has to be increased. In practice, the exact number of k has to be determined externally based on the nature of data set.

### Hierarchical Clustering and Dendrogram

Another way to perform cluster analysis is to create a tree like structure, i.e. a dendrogram, of the data under investigation. By using the same distance measure we mentioned above, a tree (or multiple trees) can be made which shows in which order data points (database entries) are related to each other. In hierarchical clustering, a series of partitions takes place, which may run from a single cluster containing all points to n clusters each containing a single point.

Hierarchical clustering is subdivided into agglomerative methods, which proceed by series of fusions of the n points into groups, and divisive methods, which separate n points successively into finer groupings. Agglomerative techniques are more commonly used. Hierarchical clustering may be represented by a 2-dimensional diagram known as dendrogram which illustrates the fusions or divisions made at each successive stage of analysis. For any given data set, if there is at least one shared itom for all points, then this cluster can be reduced to a single hierarchical dendrogram with a root. Otherwise, multiple tree structures will be resulted.

### Agglomerative Methods

An agglomerative hierarchical clustering procedure produces a series of partitions of the data points, Pₙ, Pₙ₋₁, . . . , P₁. The first Pₙ, consists of n single point ‘clusters’, the last P₁, consists of single group containing all n cases. At each particular stage the method joins together the two clusters which are closest together (most similar). (At the first stage, of course, this amounts to joining together the two points that are closest together, since at the initial stage each cluster has one point.)

Differences between methods arise because of the different ways of defining distance (or similarity) between clusters. The commonly used hierarchical clustering methods include single linkage clustering, complete linkage clustering, average linkage clustering, average group linkage, and Ward's hierarchical clustering method. The differences among these methods are in the way of defining the distance between two clusters. Once the distance function is defined, the clustering algorithms mentioned here, and many additional methods, can be obtained using computational packages. They are not discussed in detail here, as any person with proper training in statistics/clustering algorithms will be able to implement these methods.

Here we will give two examples of new clustering algorithms that are specifically associated with our definition of “informational distance”. One is called named “minimum intra-group distance” method, and the other “maximum intra-group information” method. These two methods are theoretically independent methods. In practice, depending on the data set, they may yield same, similar, or different dendrogram topologies.

### Minimum Intra-Group Distance Linkage

For this method, one seeks to minimize the intra-group distance in each merging step. The groups with the minimal intra-group distance is linked (merged). Intra-group distance is defined as the distance between the two centroids of the group. In other words, the two clusters r and s are merged such that, before merger, the informational distance between the two clusters r and s, is minimum. d(r,s), the distance between clusters r and s, is computed as

d(r,s)=ΣSI(i)+SI(j)

where points i is an itom in the centroid for r, but not in the centroid for s, and j is in centroid for s, but not for r. For itoms appearing in both centroids, but with different times, we use the usual way of handling as the case for calculating the distance for two points. At each stage of hierarchical clustering, the clusters r and s, for which d(r,s) is minimum, are merged.

### Maximum Intra-Group Information Linkage

For this method, one seeks to maximize the intra-group informational overlap in each merging step. The groups with the maximal intra-group informational overlap is linked (merged). Intra-group informational overlap is defined as the cumulative information among the itoms belonging to both the two centroids. In other words, the two clusters r and s are merged such that, before merger, the informational overlap between the two clusters r and s, is at a maximum. SI(r,s), the informational overlap between clusters r and s, is computed as

SI(r,s)=ΣSI(i)

where points i is an itom in both the centroid for r, and in the centroid for s. At each stage of hierarchical clustering, the clusters r and s, for which SI(r,s) is maximal, are merged.
Theory on Merging Databases with Applications in Database Updating and Distributed Computing

Theory on Merging Databases

If we are given two distinct databases, and we want to merge them into a single database, what are the characteristics of this merged database? What are the itoms? What is its distribution function? How can a search score from each individual database be translated into a score for the combined database? In this section, we first give out theoretical answers to these questions. We then will show how the theory can be applied in real-world applications.

Theorem 1. Let D₁, D₂ be two distinct databases with itom frequency distribution F₁, (f₁(i), i=1, . . . , n₁), F₂, (f₂(j), j=1, . . . , n₂), total number of cumulative itom number N₁ and N₂, and total distinct itoms n₁ and n₂. Then, the merged database D will have N₁+N₂ total itoms, total number of distinct itoms not less than max(n₁, n₂), and an itom frequency distribution function F:

$$\begin{matrix}f ( i ) = {f}_{1} ( i ) + {f}_{2} ( i ) if i belongs to both {D}_{1} and {D}_{2} ; \\ = {f}_{1} ( i ) if i belongs to only {D}_{1} ; \\ = {f}_{2} ( i ) if i belongs to only {D}_{2} .\end{matrix}$$

Proof: The proof of this theorem is quite obvious. For F to be a distribution function, it has to satisfy: (1) 0<=f(i)/N<=1. (for i=0, . . . , n), and (2) Σᵢ₌₁ . . . , nf(i)/N=1.

This is because:

$$\begin{matrix}0 <= f ( i ) / N = ( {f}_{1} ( i ) + {f}_{2} ( i ) ) / ( {N}_{1} + {N}_{2} ) <= ( {N}_{1} + {N}_{2} ) / ( {N}_{1} + {N}_{2} ) = 1 , \\ for all i = 0 , … , n . & 1 ) \\ \begin{matrix}{\sum }_{i = 1 … , n} f ( i ) / N = ( {\sum }_{i = 1 … , n} {f}_{1} ( i ) + {\sum }_{i = 1 … , n} {f}_{2} ( i ) ) / N \\ = ( {\sum }_{i = 1 … , n 1} {f}_{1} ( i ) + {\sum }_{j = 1 … , n 2} {f}_{2} ( j ) ) / ( {N}_{1} + {N}_{2} ) \\ = ( {N}_{1} + {N}_{2} ) / ( {N}_{1} + {N}_{2} ) \\ = 1.\end{matrix} & 2 )\end{matrix}$$

What is the impact of such a merge on the information amount of each itom? If an itom is shared by both D₁ and D₂, the Shannon information function is: SI₁(i)=−log₂f₁(i)/N₁, SI₂(i)=−log₂f₂(i)/N₂. The new information amount for this itom in the merged space D is:

SI(i)=−log 2(f1(i)+f2(i))/(N1+N2). From Theorem 1, we know this is a positive number.

If an itom is not shared by both D₁ and D₂, the Shannon information function is: SI₁(i)=−log₂f₁(i)/N₁, for i in D₁ but not in D₂. The new information amount for this itom in the merged space D is: SI(i)=−log₂f₁(i)/(N₁+N₂). Again we know this is a positive number. The case for itoms in D₂ but not in D₁ is similar. What are the implications on Shannon information amounts of these itoms? For some special cases, we have the following theorem:

Theorem 2. 1) If the database size increases, but the frequency of an itom does not change, then the information amount of that itom increases. 2) If the itom frequency increases proportionally to the increase in total amount of cumulative itoms, then the information amount of that itom does not change.
Proof: 1) for any itom that is in D₁ not in D₂:

SI(i)=−log₂f1(i)/(N₁+N₂)>SI₁(i)=−log₂f₁(i)/N₁.
2) Because the frequency is increased proportionally, we have f₂(i)/N₂=f₁(i)/N₁, i.e. we have: f₂(i)=(N₂/N₁) f₁(i). Therefore:

$$\begin{matrix}SI ( i ) = - {log}_{2} ( {f}_{1} ( i ) + {f}_{2} ( i ) ) / ( {N}_{1} + {N}_{2} ) \\ = - {log}_{2} ( {f}_{1} ( i ) + ( {N}_{2} / {N}_{1} ) {f}_{1} ( i ) ) / ( {N}_{1} + {N}_{2} ) \\ = - {log}_{2} {f}_{1} ( i ) ( {N}_{1} + {N}_{2} ) / ( ( {N}_{1} + {N}_{2} ) {N}_{1} ) \\ = - {log}_{2} {f}_{1} ( i ) / {N}_{1} \\ = {SI}_{1} ( i ) .\end{matrix}$$

For other cases not covered by Theorem 2, the information amount of an itom may increase or decrease. The above simple theory has powerful applications in the implication of our search engine.

### Applications in Database Merging

If we have to merge several databases to form a combined database, Theorem 1 tells us how we can perform such merges. Specifically, the new distribution function is generated by merging the distribution functions from each individual databases. The itoms for the merged database will be the union of all itoms from each component database. The frequency of this new itom in the merged database is obtained by adding the frequency for each of the itom across on the databases we are merging.

### Applications in Database Updating

If we are updating a single database with additional entries, for example, on a weekly or monthly schedule, the distribution function Fₒ must be updated as well. If we don't want to add any new itoms to the distribution, we can simply go through the list of itoms in Fₒ to generate a distribution function Fₐ (Fₐ will not have any new itoms). According to Theorem 1, Fₙ is obtained by going through all itoms with non-zero frequency in Fₐ, and add them to the corresponding frequency in Fₒ.

There is one shortcoming of the above-method the new distribution. Namely, previously identified itom list in Fₒ may not reflect the complete itom list in Fₙ should we re-run the automated itom identification program. This shortcoming can be resolved in practice by generating a candidate pool of itoms using thresholds, say ½ of the required thresholds for the identification of itoms. Then in updating, one should check if any of these candidate itoms are now new itoms after merging event. If yes, they should be added into the distribution function Fn. Of course, this is only an approximate solution. If substantial data is added, let's say over 25% of original data size for Fₒ, or that the new data is very distinct from the old ones from the sense of itom frequency, then one should re-run the itom identification program on the merged data anew.

### Distributed Computing Environment

When database size is big, or that the response time for a search has to be very short, then the need in distributed computing is obvious. There are two aspects of distributed computing for our search engine: 1) distributed itom identification. 2) distributed query search. In this subsection, we will first give some background on environment, terminology, and assumptions of distributed computing.

We will call the basic unit (with CPU, local memory, with local disk space or without) a node. We will assume there are three distinct classes of nodes, namely: “master nodes”, “slave nodes”, and “backup nodes”. A master node is a managing node that distributes and manages jobs, it also serve the purpose of interfacing to user. A slave node is a node that perform partial of the computational task as given by the master node. A backup node is a node that may become master node or slave node on demand.

The distributed computing environment should be designed in a way of fault-tolerant. The master node distributes jobs to each “slave nodes”, and collects the results from each slave node. The master node also merges the results from slave nodes to generate a complete result for the problem in hand. The master node should be designed fault-tolerant. For example, if the master node fails, another node, from the backup node pool should become a master node. The slave node should also be designed as fault-tolerant. If one slave node dies, the backup node should be able to become a clone to that slave node in a short time. One of the best way to have fault tolerance is to have a 2-fold redundancy on the master node and each of the slave nodes. During the computation, both nodes will perform the same task. The master node only need to pick up response from one of the cloned slave node (the faster one). Of course this kind of 2-fold redundancy is a resource hog. A less expensive alternative is to have only a few backup nodes, with each backup node being able to become a clone for any of the slave node. In this design, if one slave dies, it will take some time for the backup node to become fully functional slave node.

In the environment that extra-robustness is required, both these methods can be implemented together. Namely, each node will have a fully cloned duplicate that has the same computational environment, and will run the same computation job in duplication. In the mean time there is a backup node pool, with each node can become the clone to the master node or any of the slave node. Of course, the system administrator should also be noticed whenever there is a failing node, and the problem should be fixed quickly.

### Application in Distributed Itom Identification

Suppose a database D is partitioned into D₁, . . . , Dₙ, the question is: can we run a distributed version of itom identification program to obtain its distribution function F, with the identification of all itoms and their frequencies? The answer is yes!

Let's assume the frequency thresholds used in automated itom identification is Tr, we will use Tr/n as the new thresholds for each partitioned database (Tr/n means for each frequency threshold, we divide it by a common factor n). (F, Tr) means a distribution generated using threshold Tr. After we obtain the itom distribution with Tr/n for each Di, we merge them all together to obtain a distribution F using threshold Tr/n, (F, Tr/n). Now, to obtain (F, Tr), one just need to drop these itoms that does not meet the new threshold Tr.

The implementation of distributed itom identification in the environment given in subsection 9.4 is obvious. Namely, a master node will split the database D into n small subsets, D1, . . . , Dn. Each of the n slave nodes will identify the itoms in this subset Di with smaller thresholds, Tr/n The result is communicated back to the master node when the computation is completed. The master node now combines the results from each slave nodes to form a complete distribution function for D with threshold Tr.

### Application in Distributed Query Search

Suppose we are given (D, F, Tr), where D is the database, F its itom distribution function, and Tr the thresholds used to generate this distribution. We will split the database D into n subsets: D₁, . . . , Dₙ. We will distribute the itom distribution function for D into n slave nodes. Thus, the search program is run under the following environment: (Dᵢ, F, Tr), i.e., searching only a subset of D but using the same distribution function for the combined dataset D.

For a given query, after all the hit list from the specific Di is obtained, the hit lists above the user-defined threshold (or default threshold) are sent to the master node. The master node merges the hit list from each slave node into a single list by sorting through the individual hits (just to re-order the results) to generate a combined hit list. There is no adjustment on the score needed here, as we used the distribution function F to calculate the score. The score we have is already a hit score that is for the entire database D.

This distributed computing design speeds the search from several aspects. First, in each slave node, the amount of computation is only limited onto the much smaller database, Dᵢ. Secondly, because the database is much smaller now, it is possible to store the complete data into memory, so that disk access is mostly or completely eliminated. This will speed up the search significantly, as our current investigation on search speed shows up to 80% of search time is due to disk access. Of course, here not only the content of Dᵢ, but also the complete distribution function F has to be loaded into memory as well.

### Introduction to Itomic Measure of Information Theory

In the co-pending patent applications, we have put forward a theory for accurately measure information amount of a document under the assumption of a given distribution. The basic assumptions of the theory are:
1. The basic units of information are itoms. For textual information, itoms are words and phrases either identified internally or defined externally. An entry in a database can be viewed as a collection of itoms with no specific order.
2. For a given informational space, the information amount of an itom is determined by a distribution function. It is the Shannon information. The distribution function of itoms can be generated or estimated internally using the database at hand, or provided externally.
3. Similarity between itoms is defined externally. A similarity matrix can be given to the data in addition to the distribution function. An externally defined similarity matrix will change the information amount of itoms, and reduce the total information amount of the database at hand.
4. The similarity matrix A=(a(i,j)), is a symmetric matrix, with diagonal numbers 1. All other members 0<=a(i,j)<=1.
5. Information amount is additive. Thus, one can find the information amount of an itom, an entry within a database, and the total information amount of a database.
6. If we use frequency distribution as an approximation for the information measure for a given database, the frequency distribution of a merged database can be easily generated. This theory has serious implications on distributed computing.

This concept can be applied to compare different entries, to find their similarity and differences. Specifically, we have defined an itomic distance.
1. The distance between two itoms is the summation of the IA (information amount) of the two itoms, if they are not similar.
2. The distance between two similar itoms is measured by: d(t₁, t₂)=IA(t₁)+IA(t₂)−2*a(t₁, t₂), where a(t₁, t₂) is the similarity coefficient between t₁ and t₂.
3. The distance between two entries can be defined as the summation of
   a. For non-similar itoms, the IA of all non-overlapping itoms between the two entries.
   b. For itoms with similarity, we have to minus the similarity part out.

To measure the similarity between two entries, or segments of data, we can use either the distance concept above, or we can define:
1. The similarity between two entries, or two informational segments can be defined as the summation of information amount of all overlapping itoms.
2. Alternatively, we can define similarity between two entries as the summation of information amount of all overlapping itoms, minus all the information amount of non-overlapping itoms.
3. Alternatively, in defining similarity, we can use some simple measures for non-overlapping itoms, such as the total number of non-overlapping itoms, or the information amount of non-overlapping itoms multiplied by a coefficient beta (0<=beta <=1).

### Direct Applications

### Direct Applications

1. Scientific literature search. Can be used by any researcher.

Scientific literature database, either contains abstracts or full-text articles, can be searched using our search engine. The database has to be compiled/available. The sources of these databases are many, including journals, conference collections, dissertations, curated databases such as MedLine and SCI by Thomson.

2. Patent search: is my invention novel? Any related patents? Prior-arts?

A user can put in a description of his/his client's patent. The description can be quite detailed. One can use this description to search the existing patent abstract or full-text database, or the published applications. The related existing patents and applications will be found in this search.

3. Legal search of matching cases: what is the most similar case in the database of all prosecuted cases?

Suppose a lawyer is preparing the defense of a civil/criminal case, he wants to know how similar cases are persecuted. He can search a database of civil/criminal cases. These cases can contain distinct parts, such as summary description of the case, defendant lawyer's arguments, supporting materials, judgment of the case, etc. To start, he can write a summary description of the case in hand, and search against the summary description database of all recorded cases. From there onward, he can further prepare his defense by searching against the collection of the defendant lawyer's arguments using his proposed defendant arguments as a query.

4. Email databases. Blog databases. News databases.

In an institution, emails are quite a large collection. There is many occasions when one needs to search a specific collection of the emails (may it be the entire collection, a sub collection within a department, or send/received by a specific person). Once the collection is generated, our search engine can be applied to search against the contends of this collection. For Blog database and News database, there is not much different. The content search will be the same, which is a direct application of our search engine. The meta data search may be different, as each data set has a specific meta data collection.

5. Intranet databases: Intranet webpages, web documents, internal records, documentation, specific collections.

Many institutions and companies have large collection of distinct databases. These databases may be product specifications, internal communications, financial documents, etc. The need to search against these intranet collections is high, especially when the data are not much organized. If it is a specific intranet database, the content is usually quite homogenous, (for example, Intranet HTML pages), one can build a searchable text database from the specific format quite easily.

6. Journals, newspapers, magazines, and publication houses: is this submission new? Are there any previous related publications? Identifying potential reviewers?

One of the major concern to various publication houses such as journals, newspapers, magazines, trade markets, and books is whether the submission is new or it is a duplication of others. Once a database of previous submissions is generated, a full-text search against this database should reveal any potential duplications.

Also, in selecting reviewers for a submitted article, using the abstract of the paper or a key paragraph in the text to search against a database of articles will reveal a list of candidates of reviewers.

7. Desktop search: we can provide search of all the contents in your desktop, in multiple file formats (MS-Word, Power point, Excel, PDF, JPEG, HTML, XML, etc.)

In order to search against a mosaic type of file formats, some file format convention is needed. For example, the PDF file, DOC file, EXCEL file, they all have to be first converted to plain text format, and compiled into a text database before search can be performed. A link to the file location of these files should be kept in the database, so after search is performed, the link of hits will point to the original file, instead of the converted plain text file. The alignment file, (it is shown through the left-link produced in our current interface), however, will use the plain text.

8. Justice Dept., FBI, CIA: criminal investigation, anti-terrorists

Suppose there is a database of criminals and suspects, including suspects of international terrorists. When a new case comes in, with a description of the criminal involved, or the crime theme, then it can be searched against the criminal/suspect database or the crime theme database.

9. Searching against congress and government agencies' legislatures and regulations, etc.

There are many government documents, regulations, and congress legislatures concerning various matters. For a user, it is hard to find specific documents concerning a specific issue. Even for trained individuals, this task may be very demanding because the vast amount of material collection. However, once we have a complete collection of these documents, searching against them using a long text as query will be easy. We don't need much an internal structure for these data, we also don't need to train the users a lot.

### 10. Internet

Searching Internet is also a generic application of our invention. Here the users are not limited to searching by just a few words. He can ask complex questions, entering detailed description of whatever he wants to search. On the backend, once we have a good collection of the Internet content, or the Internet content of a specific segment of his concern, then the searching task is quite easy.

Currently, we don't have meta data for Internet content searches. We can have distinct partitions of Internet content, though. For example, in the first implementation of our “Internet Content Search Engine”, we can have the default database to be the one that contains all Internet content, but also giving the option to the user to narrow his search to a specific partition, may it be a “product list”, “company list”, “educational institutions”, just to give a few examples.

### Email Screening Against Junk Mails

One problem with today's email system is that there are too many junk mails (advertisements and solicitations of various sorts). Many email services provide screening against these junk mails. These screening methods are of various flavors, but mostly based on matching keywords and strings. These methods are insufficient against the many different flavors of junk emails. They are not accurate enough. As a result, we run into problems of two folds: 1) insufficient screening: many junk mails escape the current screening program and end up in users regular email collections; 2) over screening: many important emails, normal/personal emails are screened out into junk mail category.

In our approach, we will first establish a junk email database. This database contains known junk mails. Any incoming email is first searched against this database. Based on the hit score, it is assigned a category: (1) junk mail, (2) normal mail, (3) uncertain. The categories are defined by thresholds. These having hit score against the junk mail database above a high-threshold are automatically put in category (1); these with hit scores lower than a low-threshold or with no hits at all are put in normal mail category. The ones that are in between the high- and low-thresholds, category (3), may need human intervention. One method of handling category (3) is to let them into the normal mail box of recipient, and in the mean time, have a person go through to further identify it. For any identified new junk mails, they will be appended to the known junk mail database.

Users can nominate to email administrators new junk emails they received. Users should forward suspected/identified junk emails to the email administration. The email administrator can further check on the identity of the submitted emails. Once the junk mail status is for certain, he can append these junk mails into the junk email database for future screening purpose. This is one way to update the junk mail database.

This method of junk mail screening should increase the accuracy that the current searching algorithms lacks. It can identify not only junk mails that are identical to known ones, but can also identify modified ones. Junk email originator will have a hard time to modify sufficiently his message to escape our junk mail screening program.

### Program Screening Against Virus

Many viruses embed themselves in mails on other format of media, and infect computer systems and corrupt file systems. Many virus checking and virus screening programs are available today (for example, McAfee). These screening methods are of various flavors, but mostly based on matching of keywords and strings. These screening methods are insufficient against the many different flavors of viruses. There are not accurate enough. As a result, we run into problem of two folds: 1) insufficient screening: many viruses or viruses infected files escape the screening program; 2) over screening: many normal files are mistakenly assigned as an infected files.

In our approach, we will first establish a proper virus database. This database contains known viruses. Any incoming email, or any existing file within the file system during a screening process, is first searched against this database. Based on the scoring, it is assigned a categorization: (1) virus or virus infected, (2) normal file, (3) uncertain. The categorization is based on thresholds. These hitting the virus database above the high threshold are automatically put in category (1) these below the low threshold or with no hits are put in normal file category. The ones that are in between the high and low thresholds may need human invention. One method of handling category (3) is to lock the access to these files, and in the mean time, have an expert to go through it to further identify whether it is infected or not. For any identified new virus (those with no exact match in the current virus database), they will be put into the virus database, so that in future these viruses or their variants will not pass through the screening.

Users can nominate to security administrators new virus they see or perceive. These suspected files should be further checked by an expert using methods including, but not limited to, our virus identification method. Once the virus status is determined, he can append the new virus to the existing virus database for future screening purpose. This is one way to update the virus database.

This method of virus screening should increase the accuracy that the current searching algorithms lacks. It can identify not only virus that are identical to the known ones already, but can also identify modified versions of the old virus. Virus developers will have a hard time to modify sufficiently his virus to escape our virus-screening program.

### Application in Job-Hunting, Career Centers, and Human Resources Departments

All career centers, job-hunting websites, and human resources departments can use our search engine. Let's use a web-based career center as an example. The web-based “XXX Career Center” can license and install on their server our search engine. The career center should have 2 separate databases, one contains all the resumes (CV_DB), and the other contains all the job openings (Job_DB). For a candidate who gets to the site, he can use his full CV, or part of his CV as query and search against the Job_DB to find the best matching job. For a headhunter or a hiring manager, he can use his job description as query and search the CV_DB, and find the best matching candidates. The modifications of this version of application to non-web based databases, to human resources departments are obvious, and are not given in detail here.

### Identification of Copyright Violations and Plagiarism

Many publication houses, news organizations, journals, and magazines are concerned about the originality of submitted works. How can the submission be checked to make sure it is not something old? How to identify potential plagiarism? It is not only a matter of product quality, it can also mean legal liability. Our search engine can be applied here easily.

The first step is to establish a database of concerned data, that the others may violate. The bigger this collection, the better the potential copyright violation or plagiarism will be identified. The next step is very typical. One just need to either submit part or even the complete submitted material and search against this database. Violators can be identified.

A more sensitive algorithm for identifying copyright violations or plagiarism is to use the algorithm specified in Section 6. The reason being in copied material, not only the itoms are duplicated, but also likely the order of these itoms are either completely kept, or slightly modified. Such a hit is easier to be pick up by an algorithm that accounts for the order of appearance in itoms.

### An Indirect Internet Search Engine

We can build an indirect full-text as query, informational relevance search engine with little cost. We call it an “Indirect Internet Search Engine”, or IISE. The basic idea is that we are not going to host all web content locally and generate the distribution function. Instead, we will use existing Internet keyword-based Internet servers as an intermediate.

### Preparation of a Local Sample Database and Distribution Function

The key toward calculating a relevance score is the distribution function. Usually we generate this distribution function by an automated program. However, if we don't have the complete database available, how can we generate an “approximated” distribution function? This type of questions has been answered many times in statistics. For simplicity, let's assume we know all the itoms of the database already (for example, this list of itoms can be imported directly from word and phrase dictionaries the web data covers.) Namely, if we choose a random sample, and if the sample is large enough, we can generate a decent approximation of the distribution function. Of course, the bigger the sample size, the better the approximation. For those rare itoms that we may miss out in a single sample, we can simply assign the highest score we have for the itoms we already sampled.

In practice, we will take a sample Internet database we have collected (with about 1 million pages) as the starting point. We will run our itom identification program on this data set to generate a distribution function. We will add onto this set all dictionary words and phrases we have access to. Again, for any itom with a zero frequency in the sample data set, we will assign a high information amount to it. We will call the sample database D_s, and the frequency distribution function F_s, or (D_s, F_s) for short.

### Step-by-Step Illustration of how the Search Engine Works

Here is the outline of procedure of a search:
1. User inputs a query (keywords or full-text). We will allow user using specific markers to identify phrases that contain multiple words, if he choose. For example, a user can put specific phrases in quotation markers or parenthesis to indicate it is a phrase.
2. IISE parses the query according to an existing itom distribution locally setting on the server. It will identify all existing itoms in the distribution function. The default way of itom recognition for an unrecognized word is to take it as an individual itom. For unrecognized words within a specific marker for phrase, the whole content within that marker will be identified as a single itom.
3. For any itom that is not in the distribution function, we assign a default SI-score. This score should be a relatively high one, as our local distribution function is a good representation of common words and phrases. Anything unrecognizable will have to be quite rare. These newly identified itoms and their SI-scores will be incorporated into further computation.
4. We choose a limited number of itoms (using the same rules we have been using where the complete local distribution function exists). Namely, we will use up to 20 itoms if the query is shorter than 200 words. For anything above that we will add the new number of 10% of the query word count. For example, if a query is 350 words, we will choose 35 itoms. The default way of choosing itoms is by their SI-score. Higher SI-score itoms take priority. However, we will limit the number of itoms not in the local distribution to be less than 50%.
5. Split the itoms into 4-itom groups. Here the use of 4 is arbitrary. Depending on the system performance, it can be modified (anywhere from 2 to 10). The selection can be random, namely those with higher information amount should be mixed with those with lower information amount. If the last group is less than 4, up it up to 4 by adding the lowest information amount words in this list, or by dipping into the pool of unused itoms (where the ones with the highest information amount will be chosen first).
6. For each itom group, send the query to “state of art” keyword Internet search engines. For example, right now, for the English language queries, we should use “Yahoo”, “Google”, “MSN”, and “Excite”. The number of how many search engine to use is arbitrary as well. For the purpose of illustration, we will assume it is 3.
7. Collect the responses from each search engine, for each group to form a local temporary database. We should retrieve all the webpages from the search result, with limit from each website to 1,000 webpages (links) (Here 1,000 is a parameter that may change depending on computation speed, server capacity and result site from the external search engine).
8. We will name this retrieved database DB_q, to symbolize it is a database obtained from a query. Now, we run our internal itom identification program to identify new itoms contained within this database. As this is not a database of random, we will have to adjust the information amount for each itom identified this way so it will be comparable to our existing distribution function. Any itom in the original query, but not in the identified list should also be added in now. We will call this distribution: F_q. Please notice, F_q contains itoms not in our local distribution function (D,F). By merging these two distributions we obtain (D_m, F_m). This is our updated distribution function, to be used onward.
9. For each candidate returned, do a pair-wise comparison with the query, generate a SI-score.
10. Rank all the hit based on the SI-score, report a list of hits with scores to the user via our standard interface. The reporting of hits, of course, is also controlled by session parameters settable by users. Default set of parameters should be provided by us.

### Search Engine for Structured Data

The general theory of measuring informational relevance using itomic information amount can be applied to structured data as well as unstructured. In some aspects, application of the theory to structured data has even more benefits. This is because the structured data is more “itomic”, in the sense that the information is more likely at itomic level, and the relevancy of order of these itoms are less important as in the unstructured data. Structured data can be in various forms, for example, XML, relational databases, and object-oriented databases. For the simplicity of description, we will focus only on structured data as defined in a relational database. The adjustment of theory developed here into measuring informational relevancy in other structural formats are obvious.

A relational database is collection of data where data is organized and accessed according to the relationships between data. Relationships between data items are expressed by means of tables. Assume we have a relational database that is composed of L tables. Those tables are usually related to each other through relationship such as foreign keys, one-to-many, many-to-one, many-to-many mappings, other constraints and complicated relationship defined by stored procedures. Some tables may contain relationship only within, and not without. Within each table, there are usually a primary id field, followed by one or many other fields that contain information determined by the primary id. There are different levels of normalization for relational databases. These normal forms aim at reducing data redundancy and consistency, and making the data easy to manage.

Distinct Items within a Column as Itoms

For a given field within a database, we can define a distribution, as we have done before, except the content is limited to only the content in this field (usually called a column in a table). For example, the primary_id field with N rows will have a distribution. It has N itoms, with each primary_id an itom, and its distribution function of F=(1/N, . . . , 1/N). This distribution has the maximal information amount for a given N number of itoms. For other fields, let's say, a column with list of 10 items. Then, each of these 10 items will be a distinct itom, and the distribution function will be defined by the occurrence of the items in the row. If a field is a foreign key, then the itom of that field will also be the foreign key themselves.

Generally speaking, if a field in a table has relatively simple entries, like numbers, one to a few word entries, then the most natural choice is to treat all the unique items as itoms. The distribution function associated with this column then is the frequency of occurrence of these items.

For the purpose of illustration, let's assume we have a table of journal abstracts.
Primary_id
Title
List of authors
Journal_name
Publication_date
Pages

Here, the itoms for Primary_id will be the primary_id list. The distribution is F=(1/N, . . . , 1/N) where N is total number of articles. Journal_name is another field where each unique entry is an itom. Its distribution is F=(n₁/N, . . . , nₖ/N), where n₁, . . . nₖ are the number of papers from journal i (i=1, . . . , k) in the table, k is the total number of journals.

The itoms in the pages field is the unique page numbers appeared. To generate a complete list of unique itoms, we have to split the pages into individual ones. For example, pp 5-9, should be translated into 5, 6, 7, 8, 9. The combination of all unique page numbers within this field forms the itom list for this field.

For publication dates, the unique list of all months, years, and dates appeared in the database is the list of itoms. They can be viewed in a combination, or they can be further broken down into separate fields, i.e., year, month, and date. So, if we have N_{y} unique years, Nm unique months, and N_{d} unique dates, then the total number of unique itoms are: N=N_{y}+Nₘ+N_{d}. According to our theory, if we break the publication dates into three subfields, the cumulative information amount from these fields will be smaller compared to have all them in a single publication date field with mixed information about the year, month, and date.

Items Decomposable into Itoms

For more complex fields, such as the title of an article, or the list of authors, the itoms may be defined differently. Of course, we can still define each entry as a distinct itom, but this will not be much helpful. For example, if a user wants to retrieve an article by using names of one author or the keywords within the title, we will not be able to resolve at itom level if our itoms are the complete list of unique titles and unique author lists.

Instead here we consider defining the more basic components within the content as itoms. In the case of author field. Each unique author, or each unique first name or last name can be an itom. In the title field, each word or phrase can be an itom. We can simply run the itomic identification program on the content of individual field to identify itoms and generate their distribution function.

### Distribution Function of Long Text Fields

The abstract field is usually long text. It contains information similar to the case of unstructured data. We can dump the field text into a large single flat file, and then obtain the itom distribution function for that field as we have done before for a given text file. The itoms will be words, phrases, or any other longer repetitive patterns within the text.

Informational Relevance Search of Data within a Table

In informational relevance query, we don't seek exact matches of every field a user asks. Instead, for every potential hit, we calculate a cumulative informational relevance score for the whole hit to a query. The total score from a query with matching in multiple fields is just the summation of information amount of matching itoms in each field. We rank all the hit according to this score and report back to the user this ranked list.

Using the same example as before, suppose a user inputs a query:
Primary_id: (empty)
Title: DNA microarray data analysis
List of authors: John Doe, Joseph Smith
Journal_name: J. of Computational Genomics
Publication_date: 1999
Pages: (empty)
Abstract: noise associated with expression data.
   The SQL for the above query would be:
   select primary_id, title, list_of_authors, journal_name, publication_date, page_list, abstract from article_table where
   title like ‘% DNA microarray data analysis %’
   and (author_list like ‘% John Doe %’) and (author_list like =‘% Joseph Smith %’
   and journal_name=‘J. of Computational Genomics’
   and publication_date like ‘%1999%’
   and abstract like ‘% noise associated with expression data %’

The current keyword search engine will try to match each word/string exactly. For example, the words “DNA microarray data analysis” in the title have all to appear in the title of an article. Each of the authors will have to appear in the list of author. This will make defining a query hard. Because the uncertainty associated with human memory, any specific information among the input fields may be wrong. What the user seeks is something in the neighborhood of the above query. If missing a few items, it is OK.

In our search engine, for each primary_id, we will calculate an information amount score for each of the matching itoms. We then summarize all the information amount for that primary_id. Finally, we rank all those with score above zero according to the cumulative information amount. The match in a field with more diverse information will likely contribute more to the total score then a field with little information. As we only count for positive matches, a mismatch does not hurt at all. In this way, a user is encouraged to put as much information as he knows about the subject he is asking, without the penalty of missing any hits because of his submitting the extra information.

Of course, this will be a CPU expansive operation, as we have to perform a computation for each entry (each unique primary_id). In implementation, we don't have to do this way. As itoms are indexed (reverse index), we can generate a list of candidate primary_ids which contains at least one itom, or at least two itoms, for example. Another way of approximation is to define screening thresholds for certain important fields (fields with large information amount, for example, the title field, the abstract field, or the author field). Only candidates with at least one score in the selected fields above the screening thresholds will be further computed for the real score.

Additional Tables (Distribution and Reverse-Index) Associated with Primary Table

In a typical relational database table, each important column where contain an index to facilitate search. So there is an associated index table with the primary table for those indexed fields. Here we will make some additions as well. For each column X (or at least the important columns), we will have two associated tables, one called X.dist, and the other X.rev. In the X.dist table, it lists the itom distribution of this field. The X.rev is the reverse index for the itoms. The structure of these two tables is essentially the same to the case for a flat-file based itom distribution table and reverse index table.

### A Single Query Involving Multiple Tables

In most occasions, a database contents many tables. A user's query may involve knowledge from many tables. For example, in the above example about a journal article, likely, we may have the following tables:

Article_Table
Article_id (primary)
Journal_id (foreign)
Publication_date
Title
Page_list
Abstract

Journal_Table
Journal_id (primary)
Journal_name
Journal address

Author_Table
Author_id (primary)
First_name
Last_name

Article_author
Article_id Author_id

When the same query is issued against this database, it will form a complex query where multiple tables will be involved. In this case, the SQL language is:

select ar.primary_id, ar.title, au.first_name, au.last_name, j.name, ar.publication_date,
ar.page_list, ar.abstract from article_table as ar, journal_table as j, author_table as au, article_author as aa
where ar.article_id=aa.article_id and ar.journal_id=j.journal_id and au.author_id=aa.author_id and ar.title like ‘% DNA microarray data analysis %’
and (au.first_name=‘John’ and au.last_name=‘Doe’) and (au.first_name=‘Joseph’ and au.las_t name=‘Smith’
and j.name=‘J. of Computational Genomics’
and ar.publication_date like ‘%1999%’
and ar.abstract like ‘% noise associated with expression data %’

Of course this is a very restrictive query, and likely will generate very few returns. In our approach, we will generate a candidate pool, and rank this candidate pool based on the informational relevance as defined by the cumulative information amount of overlapped itoms.

One way to implement a search algorithm is via the formation of a virtual table. We first join all involved tables to form a virtual table with all the fields needed in the final report (output). We then run our indexing scheme on each of the field (itom distribution table and reverse index table). With the itom distribution tables and the reverse indexes, the complex query problem as defined here is reduced to the same problem we have solved for the single table case. Of course the cost of doing so is pretty high: for every complex query, we have to form this virtual table and perform the indexing step. The join type can be a left outer join. However, if “enforced” constraints are applicable to some fields in secondary tables of the join, (i.e. tables other than the table containing the primary_ID), then in some embodiments an “inner join” can be applied to those Tables where the enforced fields occur, which may result in saving some computation time.

There are other methods to perform the informational relevance search for complex queries. One can form a distribution function and a reverse index for each important table field in the database. When a query is issued, the candidate pool was generated using some minimal threshold requirements on these important fields. Then the computation of exact score for the candidates can be calculated using the distribution table associated with each field.

### Search Engine for Unstructured Data

### Environment of Unstructured Data

There are many unstructured data computer systems in a company, an institution, or even within a family. Usually unstructured data sets on desktop hard disks, or on specific file servers that contains various directories of data, including user home directories, and specific document folders. The file format can be very diverse.

For simplicity, we will assume a typical company with a collection of N desktop computers. Those computers are linked via a local area network. The files on the hard disks of each individual computer are accessible within the LAN. We further assume that the desktop computer contains various file formats. The ones are to our interest are those with significant text contents. For example, in the formats of the Microsoft word, power pointer, Excel spread sheet, PDF, GIF, TIG, postscript, HTML, XML.

Now we assume there is a server that is connected to the LAN as well. This server runs a programmer for unstructured data access, termed SEFUD (search engine for unstructured data). The server has access power to all the computers (to be called clients) and to certain directories that contain user files (the access to client files does not have to be complete, as some files on user computers may be deemed private, and inaccessible to the server. These files will not be searchable). When SEFUD is running, for any query (keywords, full-text), it will search each computer within the LAN, and generate a combined hit file. There are different ways to achieve this objective.

### Itom Indexing on Clients

On each client we have a program called “file converter”. The file converter converts each file in various formats into a single text file. Some file formats may be skipped, for example binary executables and zipped files. The file converter may also truncate a file if the file is extremely large. The maximum file size is a parameter a user can define. Anything in the original file that is longer than the maximum file size will be truncated after the conversion.

The converted text file may be in the standard XML file, or in a FASTA file, as will be used here as an example. Our FASTA format is defined as:

>primary_file_id meta_data: name_value_pairs

Text . . .

The meta_data should at least contain the following information for the file: the computer name, the document absolute path, access mode, owner, last date of modification, and file format. The text field will contain the converted text from the original document (may be with truncation).

The concatenated FASTA files from the whole computer will form a large file. At this stage, we run our itom indexing algorithm on the data set. It will generate two files that are associated with the FASTA file: the itom distribution list file and the reverse index itom lookup file. If the itoms are assigned an ID, than we should have one more file: the mapping between itom ID and its real text content.

This itom indexing program can be run at night when nobody is using the computer. It will take a longer time to generate the first itom index files; but the future ones will be generated incrementally. Thus the time spent on these incremental updates on daily basis will not be that costly computer resource wise.

### Search Engine for the Distributed Files

There are two different ways to perform the search. One is to perform it locally on the server, and the other is to let each individual computer running its own search and then to combine the search results on the server.

### Method 1. Thick Server, Thin Client

In this approach, the server performs most of the computation. The resources requirement from the client is small. We will first merge the itom distribution files into a single itom distribution file. As each individual distribution file contains the list of its own itoms and its frequency, and the itomic size of the file, then the generation of a merged distribution function is quite simple (see previous patent applications). The generating of the combined reverse index file is as well direct. As the reverse index is sorted file of itom occurrence, one just need to add a computer_id in front of the primary file id for each file listing within the reverse index.

Of course, one can simply concatenate all the original FASTA files, and generate the itomic distribution files from there. The benefit of this approach is that the itoms automatically generated will likely be more accurate and extensive. But this approach is more time-costly, and lost the flavor of distributed computing.

Here is the outline of server computation for a typical search:
1. Before a query is present, the server will have to collect all the itomic distribution files and itomic reverse index file from each client. It then generates a itom distribution file and reverse index file appropriate for all the data from the clients.
2. When a query is presented to the server, it is first decomposed into itoms based on the itom distribution file.
3. With the query itoms known, one can generate a candidate pool of hit documents by using the reverse index file.
4. Then the server will retrieve the text file of candidate hits from the localized FASTA files in each client.
5. Run 1-1 comparison program for each candidate vs. the query. Generate a SI-score for each candidate hit.
6. Rank the hits based on their SI-scores.
7. A user interface with the top hits and their meta-data, sorted by the scores, will be presented to the user. There are multiple links available here. For example, the left link associated with the primary_file_id may bring up an alignment between the query; the hit, and the middle link with meta-data about the file also contains a links to the original files; and the link from the SI-score may list all the hit itoms and their information amounts as usual.

### Method 2. Think Client, Thin Server

In this method, the computation requirement on the server is much limited, and the computation of query search is mostly carried out on the client. We will first not merge the itom distribution files into a single itom distribution file. Instead, the same query is distributed into each client, and the client will perform a search on its local flat-file database. It will then report all the hits back to the server. The server, after receiving hits-report from each individual client, will perform another round of SI-score calculation. It generates the final report after this calculation step, and reports the result to the user.

The key difference here from Method 1 is that the score the server received from clients are local scores only appropriate for the local data setting on that individual client. How can we transform into the global score that applicable to the aggregated data for all clients? Here we need one more piece of information: the total amount itomic number at each individual client. The server will collect all itoms reported by each client, and based on the information amount for each itom from all the clients and the total itomic number for each client, the server will adjust the score for each itom. After that, the score for each from each client will be adjusted based on the new itomic information appropriate for the cumulative data for all clients. Only at this stage, the comparison of hits from distinct clients at the SI-score become meaningful, and the re-ranking of hits based on the adjusted scores are applicable to the combined data set from all clients.

Here is the outline of server computation for this distributed search approach:
1. When a query is presented to the server, it is sent directly to each client without of parsing into itoms.
2. Each client performs the search using the same query against its own unique dataset.
3. Each client sends back the hit files for the top hits.
4. Server generates a collection of unique itoms from the hit lists. It retrieves the frequency information for these itoms from the distribution table in the clients. It calculate a new information amount for each unique itom that appeared in the reported hits.
5. Server re-adjusts the hit score from each client by first adjusting the itomic information amount for each unique itom.
6. Rank the hits based on their SI-scores.
7. A user interface with the top hits and their meta-data, sorted by the scores, will be presented to the user. There are multiple links available here. For example, the left link associated with the primary_file_id may bring up an alignment between the query; the hit, and the middle link with meta-data about the file also contains a links to the original files; and the link from the SI-score may list all the hit itoms and their information amounts as usual.
   Search Engine for Textual Data with Sequential Order

### Introduction to Search of Ordered Strings

This is something substantially new. So far, we assumed the order of itoms does not matter at all. We only care whether they are present or not. In some occasions, one may be not satisfied with this kind of matches. One may want to identify hit with exact or similar order of itoms. This is a much more restrictive search.

In certain occasions not only the involved itoms are important for a search, but also the exact order of appearance. For example, in safeguarding against plagiarism, an editor might be interested in finding not only historical articles that are related to this file by content, but also if there is any segment of the paper that has significant similarity to existing documents: the exact order of words for a certain length segment of the article. In another occasion, suppose a computer company is worried about the copyright violation of its software programs. Is it possible a certain module is duplicated in an competitor/imitator's code? We all have experience in hearing similar tones of music, but are from different songs. Is the similarity by random, or the composer of that music stole some good lines of music from an old piece?

In all this occasions, the question is obvious. Can we design a program that will identify the similarity between different data? Can we associate statistical significance to the similarities we identified? The first problem can be solved by a dynamic programming algorithm. The second problem has been solved in sequence search algorithms concerning genetic data.

This searching algorithm would be very similar to protein sequence analysis, except where in sequence analysis they are amino-acids, now we have itoms instead. In protein search each match is assigned a certain positive score, in our search each match of an itom is assigned a positive score (its Shannon information). We may as well define gap initiation and gap extension penalties. After all this work, we can run dynamic programming to identify HSPs in the database where not only the content is matching at itomic level, but also the order is preserved.

Once the similarity matrix between itoms are given (see section V), and the Shannon information amount for each itom is given, the dynamic programming algorithm to find the HSPs is a direct application of known dynamic programming routine. Many trained programmers know how to implement such an algorithm. It is not detailed here.

Our contribution to plagiarism lays in the introduction of itoms and their information amount. Intuitively, a matching on a bug in the code, or a mistyped word is a very good indicator of a plagiarized work. This is an intuitive application of our theory: the typo or the bug are rare in the collection of software, thus they have very high information content. A match of 3 common words in an article might not indicate a plagiarization, but a match of 3 rare words, or 3 misspelled words in an article in the same order would strongly indicate plagiarization. One can see the importance of incorporating itom frequency into the computation of statistical significance here.

Dynamic programming, Levenshtein Distance, and Sequence Alignment

Dynamic programming was the brainchild of an American Mathematician, Richard Bellman (1957). It describes the way of finding best solution to a problem where multiple solutions exists, and of course, what is “best” or not is defined by an objective function. The essence of dynamic programming is the Principle of Optimality. This principle basically is intuitive:

An optimal solution has the property that whatever the initial state and the initial solutions are, the remaining solutions must constitute an optimal solution with regard to the state resulting from the first solution.
Or put in plain words:
If you don't do the best with what you have happened to have got, you will never do the best with what you should have had.

In 1966, Levenshtein formalized the notion of edit distance. Levenshtein distance (LD) is a measure of the similarity between two strings, which we will refer to as the source string (s) and the target string (t). The distance is the number of deletions, insertions, or substitutions required to transform s into t. The greater the Levenshtein distance, the more different the strings are. The Levenshtein distance algorithm has been used in: spell checking, speech recognition, DNA and protein sequence similarity analysis, and plagiarism detection.

Needleman-Wunsch (1970) were the first to apply edit distance and dynamic programming for aligning biological sequences. The widely-used Smith-Waterman (1981) algorithm is quite similar, but solves a slightly different problem (local sequence alignment instead of global sequence alignment).

### Statistical Report in a Database Searching Setting

We will modify the Levenshtein distance as a measure of the distance between two strings, which we will refer to as the source string (s) and the target string (t). The distance is the information amount of mismatched itoms, plus penalties for deletions, insertions, or substitutions required to transform s into t. For example, suppose each upper case is an itom. Then,
If s is “ABCD” and t is “AXCD”, then D(s,t)=IA(B)+IA(X), because one substitution (change “B” to “X”) is sufficient to transform s into t.

The question posed is, how can we align two strings with minimal penalty? There are other penalties in addition to mismatches. These are penalty for deletion (IA(del), and insertion (IA(ins)). Let's assume IA(del)=IA(ins)=IA(indel). Of course a match has penalty=0.

Example: s₁=“A B C D”, s₂=″A X B C″.

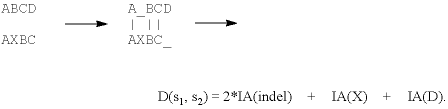

We observe that in an optimal match, if we look at the last matched position, there are only 3 possibilities: match or mismatch; one insert in the upper string; one insert in the lower string.

Generally speaking, we have the following optimization problem. Let X=(x₁, x₂, . . . , xₘ) and Y=(y₁, y₂, . . . , yₙ) be sequences of itoms. Let M_{m,n} denote the optimization criteria of aligning X and Y at (m,n) position, then Mm,n is a matrix of distances. It can be calculated according to:

M_{m,n}=min (M_{m-1,n-1}+d(xₘ, yₙ),M_{m,n-1}+IA(indel),M_{m-1,n}+IA(indel))

where d(xₘ, yₙd)={−IA(xₘ)−IA(yₙ) for xₘ not equal yₙ; IA(xₘ) if xₘ=yₙ}.

As border conditions we have: M_{0,0}=0 and all other values outside (i.e. matrix-elements with negative indices) are infinity. Matrix M can be computed row by row (top to bottom) or column by column (left to right). It is clear that computing M_{m,n} requires O(m*n) work. If we are interested in the optimal value alone, we only need to keep one column (or one row) as we do the computation.

The optimal alignment is recovered from backtracking from the Mm,n-position. Ambiguities are not important, they just mean that there is more than one possible alignment with optimal cost.

In the summary statistics, we will have a numerical number between a query and each hit entry. The optimized, M(q,h) between query and hit, denotes how good the two sequences align in this itomic distance space. The hit with the highest score should be the top hit. It is computed by adding the total information amount of matched itoms, minus the penalties for the indels and those that does not match.

Then concept of similar itoms can also be introduced to the ordered itom-alignment problem. When two similar itoms are aligned, it would result a positive score instead of negative. As the theory is very similar to the case of sequence alignment with a similarity matrix, we are not going to provide details here.

### Search by Example

Search by example is a simple concept. It means if I have one entry of a certain type, I want to find out all other ones that are similar to this one in our data collection. Search by examples has many applications. For example, for a given published paper, one can search scientific literatures, to see if there are any other ones that are similar to this one. If there is, what is the similarity extent? Of course, one can also find similar profiles of medical records, similar profiles of criminal records, etc.

Search by example is a direct application of our search engine. One just need to enter the specific case, and search the database that contain all other cases. The application of this search by example is really defined by the underlying database provided. Sometimes, there are might be some mismatch between the example we know and the database underlying. For example, we can have an example of a CV, and the database can be a collection of available jobs. In another example, the example may be a man's preference in looking for a mate, and the database underlying can be a collection of preference/hobby database given by candidate ladies.

### Applications Beyond Textual Database

The theory of itomic measure is not limited to textual information. It can be applied to many other fields. The key here is to identify a collection of itoms for that data format, and define a distribution function for the itoms. Once this is done, all other theory we developed so far will naturally apply, including clustering, search, and database searches. Potentially, the theory can be applied to search graphical data (pictures, X-rays, finger prints, etc.), to musical data, and even to analysis alien messages if someday we do receive messages from them. For each field of these applications, it needs to be an independent research project.

### Searching Encrypted Messages

As our search engine is language independent, it can also be used to search for encrypted messages. Here the hardest part is to identify itoms, as we don't have clearly defined field separators (such as spaces, and punctuations). If we can identify the field separators externally (using some algorithms not related to this search engine), then the rest is pretty routine. We start to collect statistical data for all the unique “words” (those separated by field separators), and the composite “itoms” based on their appearing frequencies.

Once itoms are identified, the search is the same as searching other databases, so long the query and the database are encrypted the same way.

### Search of Musical Contents

Recorded music can be converted in a format of 1-dimensional strings. If this is achieved, then we can build a music database, similar to the building of a text database. Tones for distinct organs can be written in separate paragraphs, so that one paragraph will only contain music notes for one specific organ. This is to make sure the information is recorded in one-dimensional format. As order is the essence in music, we will employ only the algorithm specified in an above section.

In the simplest implementation, we will assume each note is an itom, and there is no composite itoms involving more than one note. Further we can use the identity matrix to compare the itoms. Similar or identical musical notes will be able to be identified using dynamic programming algorithm.

In more advanced implementation, the database can be pre-processed like text database, where not only each individual note is treated as an itom, but also some common ordered note patterns with sufficient appearance frequency can be identified as composite itoms. Also we can use the Shannon information associated with each itom to measure the overall similarity. One particular concern in music search is a shift in the tone of a music, i.e., the two music pieces may be very similar, but because they have a different tone, there is no appearance in the first glance. This problem can be fixed in various ways. One easy way is for each query, generating a few alternates, where the alternates are the same music piece except a different tone. When performing search, not only the original piece, but also all the alternates are searched against the database collection.

### Appendices

### 0. Differences in Comparison with Vector-SPACE Model

Here are some techniques we used to overcome the problems associated with classical vector space model (VSM).
1. From semi-structured data to unstructured data. There is a key concept in called document. In indexing, it applies weight to terms based on their document appearances. In search, it assigns whether the entire document is relevant or not. There is no granule that is smaller than a document. Thus, VSM is intrinsically designed not for unstructured data, but rather for well-controlled homogenous data collection. For example, if your corpus is unstructured, a document may be a simple title with no content, while another can be a book of 1,000+ pages. VSM will much likely identify the book as a relevant document to a query, than the simple title document.
   a. Vector-space model uses a concept called TF-IDF weighting, thus allowing each term to be differentially weighted in computing a similarity score. TF stands for term frequency, and IDF is inverted document frequency. This weighting scheme ties the weighting to an entity called document. Thus, to use this weighting efficiently, document collection has to be homogenous. To go beyond this limitation, we used a concept called global distribution function. This is the Shannon information part. It only depends on the overall probabilistic distribution of terms within the corpus. It does not involve document at all. Thus, our weighting scheme is completely structure-free.
   b. In search, we use a concept called relevant segment. A document can thus been split into multiple segments, depending on the query and the relevancy of the segments to the query. The boundaries of segments are dynamic. They are determined at run-time, depending on the query. The computation of identifying relevant segments does not depend on the concept of document either. We use two concepts to fix the problem, one called paging, and the other called gap-penalty. In indexing, for very long documents, we do it one-page at a time, allowing some overlap between the pages. In search, neighboring pages can be merged together if they are deemed as both relevant to the query. By applying a gap-penalty of un-matching itoms, we define the boundary of segments to be these parts in a document that are related to the query.
2. Increase informational relevance instead of word matching. VSM is a word-matching algorithm. It views a document as a “bag of words”, where there is no relationship among the individual words. Word-matching has apparent problems: 1) it cannot capture concepts that are defined by multiple words; 2) it cannot identify related documents if they match in the conceptual domain, but with no matching words.
   a. We use a concept called itom. Itoms are the informational atoms that made up of documents. An itom can be a single word, but it can be a much more complex concept as well. Actually, we don't have any limit on how long an itom is. In a crude sense, a document can be viewed as a “bag of itoms”. By going beyond simple words, we can measure informational relevance much more precisely in the itom-domain, not just the word domain. In this way, we can improve significantly on precision.
   b. Actually, we don't just view a document as “bags of itoms”, but rather the order of matching itoms matters to a certain extent as well: they have to cluster together within the realm of the query. Thus, by using the concept of itoms, we avoid the trap of “bad of words” problem, because we allow the word order to matter in complex itoms. In the mean time, we avoid the problem of being too frigid: itoms can be shuffled within the realm of a query, or a matching segment without affecting the hit-score. In this sense, the concept of itom is just the perfect size for search: it allows the word orders to matter only in these occasions where they do matter.
   c. VSM fails to identify distantly related documents, where there is matching concepts, but no matching words. We overcome this barrier by applying a concept called similarity matrix. To us, itoms are informational units, there are relations among them. For example, UCLA as an itom is similar (actually identical to) another itom: University of California, Los Angeles. A similarity matrix for a corpus is computed automatically during the indexing step; and can be provided by user if there is external information deemed useful for the corpus. By providing this relationship among itoms, we really enter into the conceptual searching domain.
3. Resolving the issue of computational speed. Even with its many shortcomings, VSM is a pretty decent search method. Yet its usage in the market place has been very limited since its invention. This is due to the intensive computational capacity required. In the limited cases where VSM is implemented, the searches are performed off-line, rather than “on the fly”. Since a service provider has no way to know the exact query a user may have ahead of time, this off-line capacity is of limited use, for example, in the “related-document” links for given documents. We are able to overcome this barrier because:
   a. The advance in computer science has made possible many computational task previously deemed impossible. It is appropriate time now to re-visit those computational expansive algorithms and see if they can be bring to the user community.
   b. Genomic data are larger than the biggest collection of human textual contents. To search genomics data efficiently, bioinformatics scientists have designed many efficient pragmatic methods for computation speed. We have systematically applied these techniques for speed improvement. The result is a highly powerful search method that can handle very complex queries “on the fly”.
   c. Efficient using of multiple layers of filtering mechanisms. Given the huge number of documents, how can we quickly zoom into the most relevant portions of the data collection? We have designed elaborated filtering mechanisms that screen out large quantity of irrelevant documents in multiple steps. We only focus the precious computation time on these segments that are likely to produce high informational relevance score.
   d. Employing massively distributed in-memory computing. Our search method is designed in such a way that it can be completely parallelized. Large data collection is split into small portions, and stored locally on distributed servers. Computer memory chips are cheap enough now so that we can load the entire indexes for the smaller portion into system memory. In the mean time, we compute relevancy measure at a global scale, so that all the high-scoring segments from various servers can be just sorted to generate an overall hit list.

### I. File Converter

### 1.1. Introduction

The licensed file converter (Stellent package) converts different file formats (docs, PDFs, etc.) into XML format. We have a wrapper that craws file directories or URLs, generates a file list, and then for each file within the list, it calls the Stellent package to convert the file into an XML file. If the input file is an XML already, then the Stellent package is not called. Our indexing engine only works on FASTA-format plain-text databases. Following the file conversion step, we need a tool to convert the XML-format plain-text files into a FASTA format plain-text database.

This step, XML to FASTA, is the first step of our search engine core. It works between a licensed file converter and our indexer.

### 1.2. Conversion Standards

The XML-format plain-text database should contain homogenous data entries. Each entry should be marked by <ENTRY></ENTRY> (where ENTRY is any named tag specified by the user); and the primary ID marked by <PID></PID> (where PID is any name specified by the user). Each entry should have only ONE <PID></PID> field. Primary IDs should be unique within the database.

Here are the rules for conversion:
1) The XML and FASTA databases are composed of homogenous entries.
2) Each entry is composed of, or can be converted to, 3 fields: a single primary ID field, a metadata field constituted by a multitude of metadata, specified by Name and Values pairs, and a single content field.
3) Each entry should have one and ONLY one primary ID field. If there are multiple primary ID fields within an entry. Only the first one is used. All others are ignored.
4) Only the first-level child tags under <ENTRY> will be used to populate the metadata and content fields.
5) All other nested tags will be IGNORED. (Precisely, the <tag> is ignored. The </tag> is replaced with a “.”)
6) Multiple values of tagged fields for metadata and content, excluding primary ID field, will be concatenated into a single field. A “.” is automatically inserted between each value IF THERE IS NO ENDING PERIOD ‘.’.

To illustrate the above rules, we give an XML entry example below. “//” symbolize inserted comments.

| | |
|---|---|
| <ENTRY> | //begins the entry |
| <PID> Proposal_XXX </PID> | //one and only, primary ID |
| <ADDRESS> | //level-1 child. Meta-data. |
| <STR> XXX </STR> | //level-2 child. Tag ignored |
| <CITY> YYY </CITY> | |
| <STATE> ZZZ </STATE> | |
| <ZIP>99999<ZIP> | |
| </ADDRESS> | |

| | |
|---|---|
| <AUTHOR> Tom Tang </AUTHOR> | //metadata field |
| <AUTHOR> Chad Chen </AUTHOR> | //another value for the |
| | metadata |

```
  <TITLE> XML to FASTA conversion document </TITLE> //another
  metadata
```

| | |
|---|---|
| <ABSTRACT> | //content |

This document talks about how to transform an XML-formatted entry into
FASTA-formatted entry in plain-text file databases.
</ABSTRACT>

| | |
|---|---|
| <CONTENT> | //another content |

```
      Why I need to write a document on it? Because it is important.
.........
  </CONTENT>
</ENTRY>
```

During the conversion, we will inform the conversion tool that <PID> indicates the primary ID field; the <ADDRESS>, <AUTHOR>, <TITLE> are metadata fields; and <ABSTRACT> and <CONTENT> are content fields.

After conversion, it will be:

>Proposal_XXX \tab [ADDRESS: XXX. YYY. ZZZ. 99999]
[AUTHOR: Tom Tang. Chad Chen] [TITLE: XML to FASTA conversion
document]\newline
This document talks about how to transform an XML-formatted
entry into FASTA-formatted entry in plain-text file databases.
Why I need to write a document on it? Because it is important.
.........

Here, all the <CITY><STR><STATE><ZIP> tags are ignored. 2 author fields are merged into one. The <ABSTRACT> and <CONTENT> fields are merged into a single content field in FASTA.

### 1.3. Command-Line Interface: IV XML2FASTA

We assume that the “File converter interface” has completed. It generates a single plain-text XML-formatted database, XML_db, and it is successfully indexed by iv_txt_dbi. (If iv_txt_dbi cannot index your XML-format file, I suggest you first fix the problems before running the conversion program.)

iv_XML2FASTA will take XML_db, and generate a single FASTA-format text file, called: XML_db.fasta. The necessary fields are: entry=<ENTRY> and id=<PID> fields. The optional fields are metadata fields, and content fields. If no metadata fields are specified, no metadata will be generated. All contents within the entry, other than the primary ID, will be converted into the “content” fields. However, if you specify metadata fields or content fields by XML tags, then ONLY the information within the specified tags will be converted correspondingly. Here is the command line interface:

| iv_xml2fasta XML_db <entry=***> <id=***> [meta=***] | |
|---|---|
| [content=***] | |
| Entry: | XML entry tag |
| ID: | XML primary ID tag |
| meta: | meta data fields in FASTA |
| content: | content fields in FASTA |

where < >signals necessary fields, and [ ] signals optional fields.

To achieve the exact conversion as specified above, we should run:

```
iv_xml2fasta XML_db entry=<ENTRY> id=<PID> meta=<ADDRESS>
    meta=<AUTHOR>  meta=<TITLE> content=<ABSTRACT>
    content=<CONTENT>
```

On the other hand, if we run:

iv_xml2fasta XML_db entry=<ENTRY> id=<PID> meta=<TITLE>
content=<ABSTRACT> content=<CONTENT>

then, <AUTHOR> and <ADDRESS> fields will be ignored in metadata; and <CONTENT> will be ignored in content. The output will be:
>Proposal_XXX \tab [TITLE: XML to FASTA conversion document]\newline
This document talks about how to transform an XML-formatted entry into FASTA-formatted entry in plain-text file databases.

If we do:

iv_xml2fasta XML_db entry=<ENTRY>id=<PID>

then, we will get:

>Proposal_XXX \newline
XXX. YYY. ZZZ. 99999. Tom Tang. Chad Chen.XML to FASTA
conversion. This document talks about how to transform an XML-
formatted entry into FASTA-formatted entry in plain-text file
databases. Why I need to write a document on it? Because it is
important. .........

Now there is no meta data at all, and all the information in various fields are converted into the content field.

If a specified metadata field has no tag in some entries, it is OK. The tag name is still retained. For example, if we run:

```
iv_xml2fasta XML_db entry=<ENTRY> id=<PID> meta=<ADDRESS>
    meta=<AUTHOR>  meta=<TITLE> meta=<DATE>
    content=<ABSTRACT> content=<CONTENT>
```

then, we will get:

>Proposal_XXX \tab [ADDRESS: XXX. YYY. ZZZ. 99999] [AUTHOR:
Tom Tang. Chad Chen] [TITLE: XML to FASTA conversion document]
[DATE: ] \newline
This document talks about how to transform an XML-formatted
entry into FASTA-formatted entry in plain-text file databases.
Why I need to write a document on it? Because it is important.
.........

The [Date:] field of metadata is empty.

This tool requires that the XML data to be quite homogenous: all the entries have to have the same tags to mark the beginning and ending, same tags for the primary ID fields. The requirement for the metadata fields and content fields are relaxed a little bit. It is OK to miss a few metadata fields or content fields. But it is best that the metadata fields and the content fields in all the entries are homogenous.

### 1.4. Management Interface

In the manager interface, when the “XML to FASTA” button is clicked, a table is presented to the manager:

| XML Tags | Action | FASTA Fields |
|---|---|---|
| PID | To Primary ID −> | |
| ADDRESS | | |
| AUTHOR | To Meta Data−> | |
| TITLE | | |
| ABSTRACT | To Content | |
| CONTENT | | |
| | [convert] | [stop] [resume] |

[Progress bar here, showing % completed]

The XML tag fields are taken from a random sample of ˜100 entries taken from the XML database. The listed tags are taken from a “common denominator”: the UNION of all the first-level child tags in these samples. Only those fields that are unique within the sample can be selected as primary ID. The selection process has to go in Sequential: first the primary ID, then the metadata fields, and finally the content fields.

A user first highlights one field in the left column. When an “Action” is selected, the corresponding field on the left column that is highlighted is added to the right column in the corresponding category (Primary ID, Metadata, and Content).

Those fields in the left column that is not selected will be ignored. The content within those tags will not appear in the FASTA file.

When the [covert] button is clicked, the conversion starts. [convert] button should only be clicked after you have finished all your selections. When [stop] is clicked, you can stop the converting, and either [resume] later, or start [convert] again (therefore killing the previous process). A “progress bar” on the bottom shows what percentage of the files is finished.

This program should be relatively fast. No multithreading is planned at this moment. Implementing multithreading can be done relatively easily as well if needed.

### 1.5. Incremental Updating

Here we are concerned with incremental updates. The approach is to keep the old files (a single FASTA file, called DB.fasta.ver) untouched, and to generate two new accessory files, DB.incr.fasta.ver, and DB.inc.del.ids.ver that contain the altered information for the files/directories to be indexed. A third file, DB.version, is used to track the update versions.

### Steps:

1) From DB.fasta.ver, generate a single, temporary list file, DB.fasta.ids. This file contains all the primary_IDs and their time stamps.

2) Traverse the same directories as the last time, and get all the file listings and their time stamp. (Notice, the user may added new directories, and removed some directories in this step).

3) Compare these file listings with the old one, generate 3 new listings:
(1) deleted files. (including those from the deleted directories).
(2) updated files.
(3) added new files. (including those from the newly added directories).

3) For (2) & (3), run the converting program, one file at a time, generate a single FASTA file. We will call it: DB.incr.fasta.ver.

4) The output files:
1: DB.incr.fasta.ver: A list file of all the ADDED and UPDATED files.
2: DB.incr.del.ids.ver: A combination of (1) & (2). We will call it: DB.incr.del.ids.ver.

5) Generate a DB.version file. Inside this file, you record the version information:

| Version_number | Type | Date |
|---|---|---|
| 1.0 | Complete | mm-dd-yyyy |
| 1.1 | Incremental | mm-dd-yyyy |
| 1.2 | Incremental | mm-dd-yyyy |
| 2.0 | Complete | mm-dd-yyyy |

One additional step, if the incremental updating program was run before, and the incremental data has already populated the index files, then, run (this would be the very first step, even before step 1)):

0) Using the plain-text DB tools developed to first merge the 3 files (DB.fasta.ver, DB.incr.fasta, and DB.incr.del.ids) into a single file, and rename that file DB.fasta.ver+1.

In the mean time, insert into DB.version:
ver+1.0 Complete mm-dd-yyyy
   where “ver+1” is a sequential number. It is derived from the earlier info in the DB.version file.

Here is how we do that: (1) Remove the deleted entries from DB.fasta; (2) Rnsert the new entries in DB.incr.del.ids.ver into DB.fasta.ver; (3) Delete all the incremental files.

The use of a version file allows the decoupling of Incremental updates from the Converter and the incremental updates from the Indexer. The converter can run multiple updates (thus generating multiple incremental entries within the DB.version file) without running the Indexing programs.

If the Indexing program for a particular Incremental version is completed, then the updating of DB.fasta into a comprehensive DB is MANDATORY. Step 0) should be run.

### II. Indexing

### 2.1 Introduction

Indexing step is an integral part of a search engine. It takes input from the file conversion step, which is a FASTA-formatted plain-text file that contains many text entries. It generates various index files to be used by the search engine in search steps. Since the data amount a search engine handles can be huge, the indexing algorithm needs to be highly efficient.

Requirements:
ID mapping of docs.
Identification of itoms (words and phrases).
Inverted index file of those itoms.
Intermediate statistics data to be used for future updating purpose.
High performance.

### 2.2 Indexing Steps Diagram

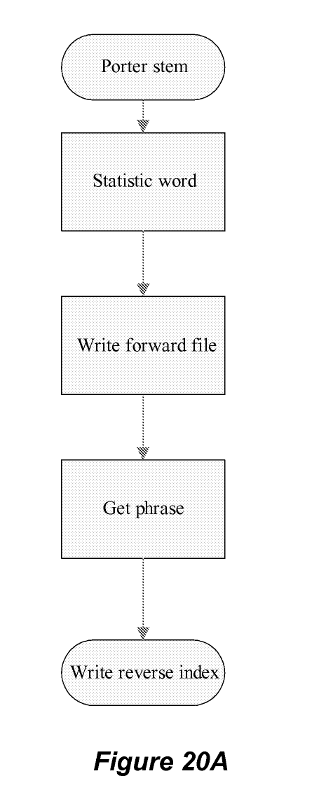

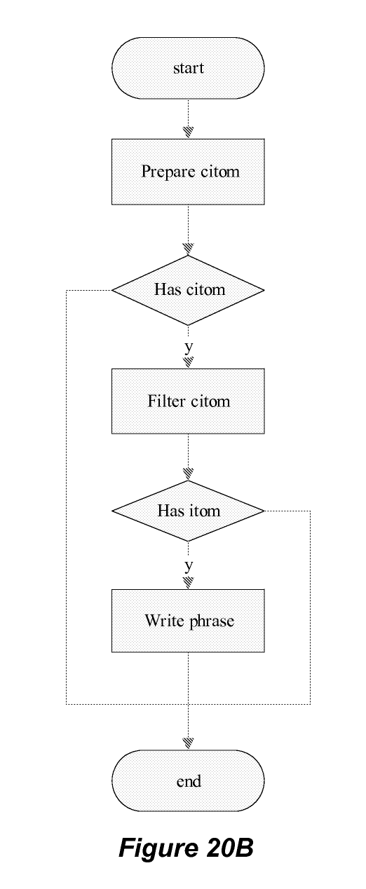

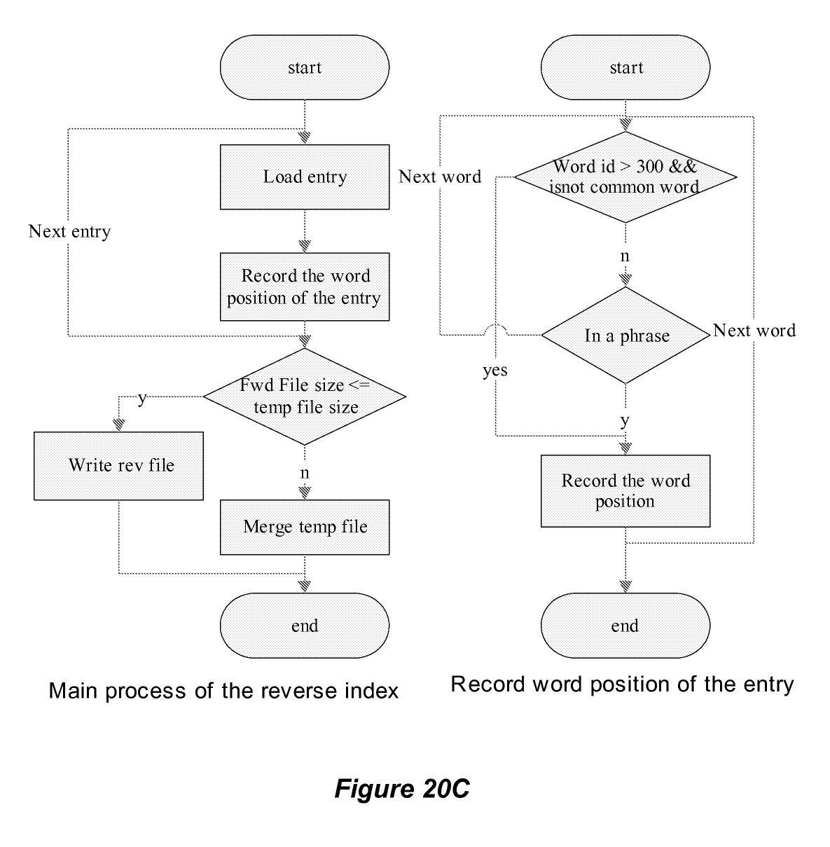

FIG. 20A. Outline of major steps in our indexer. It includes the following steps: stemming via Porter stemmer, word-counting, generating a forward index file, phrase (composite itom) identification step, and the generating of inverted index (reverse index) file.

### 2.3 Engineering Design

### New Class 1: IVStem: Stemming the FASTA File Via Porter Stemmer

For each entry in the FASTA file, do:
1) Assign a bid (binary ID), replace the pid (primary ID) to the bid;
2) Identify each word, stem it using Porter Stemmer;
3) Remove all punctuation, write sentence tokens to the right position;
4) Write the result to the stem file.

The new class uses the tool flex 2.5 to identify the word, the sentence and the other contents.

Assume our FASTA text database has the name of DB.fsata, the stemmer generates the following files:
1. DB.stem file
It records all entries that all word has been stemmed, and converted to small case. It replaces all pid to bid. It removes all sentence separator, and replace it by other tokens. Every entry takes 2 lines: one line contains only the bid, and the other line contains the meta data and the content.
2. DB.pid2bid file
It is a map from pid to bid.
3. DB.off file
It is the offset of every entry's start, and the length in bytes to the end of the entry.

### New Class 2: IVWord: Generating Word Frequency And Assigning Word IDs

The IVWord class uses the DB.stem file as input file, statistic all words' frequency, sort them by the frequency in descend rule, assign each word a word id, so that the common will get a very lower word id. It generates the following files:
4. DB.itm
This is the word statistics of the stem file. It contains the frequency of all the words within DB after stemming. It sorts the words by their frequency and assign a unique ID to each word, with the most frequent word has the smallest ID (1). Each line records a word, its frequency, and its id. The first line is intentional left blank.
5. DB.itm.sta
It records the first word offset, all word count, the frequency summation of all word.
6. DB.maxSent
For every entry, this file records the word count of its longest sentence. It will be used in the phrase identification step.
7. DB.sents
It records frequency distribution of sentence length. For example, a line in the file with “10 1000” means that there are 1000 sentence has 10 words; “20 1024” means that there are 1024 sentence having 20 words.

### New Class 3: IVFwd: Generating the Forward Index File

There is a step to convert the stem file to binary forward index file. The forward index file is directly derived from the DB.stm file, and the DB.itm file. In the conversion step, each word in the DB.stm file is replaced by its word ID given in the DB.itm file. This binary forward file is only an intermediate output. It is not required in the search step, but rather it is used to speed up the phrase identification step.

It will generate 2 files:
8. DB.fwd
Each word in DB.stm is replaced by the word ID, sentence separator replaced by 0. There is no separator for each entry in this file. The entry beginning position is recorded in the DB.fwd.off file.
9. DB.fwd.off
For the bid of every entry, its offset and its length in bytes in the DB.fwd file is recorded here.

### New Class 4: GetPhrase: Identifying Phrases Through Statistical Means

This class handles the automated composite itom (e.g. phrase) identification. Phrase identification can be done in many different ways, using distinct association discovery methods. Here we just implemented one scenario. We will call a candidate itom a “citom”, which is simply a continuous string composed of more than one words. A citom becomes an itom if it meets our selection criteria.

From the DB.fwd file, we compute the frequency of each citom, and then check if it meets the selection criteria. Here are the selection criteria:
1. Its frequency is no less than 5.
2. It appears in more than one entry.
3. It passes the chi-square test (see later section for detailed explanation).
4. The beginning or ending word within the phrase cannot be a common word (defined by a small dictionary).

The itom identification step is a “for” loop. It starts with citoms of 2 words. It generates the 2-word itom list. From the 2-word itom list, we will compose the 3-word citoms, and exam each of the citiom using the above rules. Then we continue with 4-word itom identification, 5-word, . . . , until there is no itom identified at all. The itom identification loop ends there.

For a fixed n-word itom identification step, it can be divided into 3 sub-steps:

FIG. 20B: Sub steps in identifying an n-word itom. 1) Generating candidate itoms. Given an itom for n−1 words, any n-word string containing that itom is an citiom. The new word can be added either to the left or the right of the given itom. 2) Filter the citom using the rules (1-3). All citoms failing the rules are dropped. 3) Output the citom that passed 2). Check rule (4). All citoms that pass rule (4) are new n-word itoms, and are written into DB.itm file. The “for” loop will end if no citom or no new itoms is found.

This step will alter the following files:
1. DB.itm
Newly identified composite itoms are appended to the end of this file.
2. DB.itm.sta
For each identified itom, insert a line in this file. The line contains info on the offset of the itom, and its frequency count. A summary line for the entire file is also updated, with information on the size of this file, the total itom count, and the total cumulative itom count.

This step will generate the following files:
1. DB.citmn, where n is a numeric (1, 2, 3, . . . )
Each citom, which does not meet the requirements of an itom, in the update process, may become an itom. We record those citoms in the DB.citmn file. The files contain those citoms that are: 1) frequency of 3 or above; 2) appeared in more than on entries; 3) either failed the chi-square test, or that it has a common word in the beginning or ending.
2. DB.phrn, where n is a numeric (1, 2, 3, . . . )
Each length phrase will write in the files. (???) In the reverse index file, can load the phrase by these files.
3. Cwds file
Convert common word dictionary to the binary word id files, sorted by id;

Improved:
Use a maxSent struct to store every entry's max sent length, if the current phrase length if big than the entry's max sentence length, skip it; if not find any citom in the entry, change the value to 0, so the next time this entry will be skipped even if the entry has the current length citom.
Divide the big citom map into some small map by the citom's first word. Then can speed up the search, and provide a way to use multi thread(divide data by word id).

### New Class 5: Revldx: Generate the Inverted Index File (Reverse Index File)

This class handles the creation of inverted index file (also known as the reverse index file). For each word, it records which entries it appears at what positions within that entry. For a common word, we only record those that appears within an itom (phrase). For example, “of” is a common word. It will not be recorded in general. However, if “United States of America” is an itom, then that specific “of” will be recorded in the Revldx file. For an entry, the position count starts with 1. Each sentence separator will take one position.

FIG. 20C. Diagrams showing how the inverted index file (aka reverse index file) is generated. The left diagram shows how the entire corps is handled; and the right diagram gives more detail on how an individual entry is handled.

### New Class 5: StemDict: Stem Dictionary

The common word list is provided through a file. These words need to be stemmed as well. StemDict can stem this list. This class accepts a text file as a input, keep the order of all words and the line. Its output are stemmed words. It uses the flex tool as well.

### 2.4 Phrase Identification and the Chi-Square Rule

In this subsection, we give more theoretical details about itom identification using association rules. In itom identification, we want to discover the unusual association of words in sequential order. We use an iterative scheme to identify new itoms.

Step 1: Here we only have stemmed English words. In step 2, we will identify any two-word combination (in sequential order) that is above certain pre-set criteria.

Step n: Assume we have a collection of know itoms (include words and multi-words phrases), and a database that is decomposed into component itoms. Our task is to find those 2-itom phrases within the DB that is also above certain pre-set criteria.

Here are the criteria we are using: We will call any 2-itom in association: A+B, an citom (candidate itom). The tests we do include:
1) Minimum Frequency Requirement: the frequency of A+B is above a threshold.

F_{obs}(A+B)>Min_obs_freq
2) Ratio test: Given the frequencies of A and B, we can compute the Expected Frequency of (A+B). The Ratio test is to test whether the observed frequency divided by the expected frequency is above a threshold:

F_{obs}(A+B)/Fₑₓₚ(A+B)>Ratio_threshold.
3) Percentage test: the percentage of A+B is a significant portion of either all occurrence of A or all occurrence of B:

max(F_{obs}(A+B)/F(A), F_{obs}(A+B)/F(B))>Percentage_threshold
4) Chi-square test:
Assume that A and B are two independent variables. Then, the following table should follow a Chi-square distribution of degree 1.

| Category | A | Not_A | Total |
|---|---|---|---|
| B | F(A + B) | F(Not_A + B) | F(B) |
| Not_B | F(A + Not_B) | F(Not_A + Not_B) | F(Not_B) |
| Total | F(A) | F(Not_A) | |

Given frequency of A and B, what is the expected frequency of A+B? It is calculated by:

Fexp(A+B)=F(A)/F(A_len_citom)*F(B)/F(B_len_Citom)*F(A+B_len_Citom)

where F(X_len_citom) is the total number of citoms with word-length X.

In Chi-square test, we want:

[Fobs(A+B)−Fexp(A+B)]**2/Fexp(A+B)+[Fobs(Not_A+B)−Fexp(Not_A+B)]**2/Fexp(Not_A+B)+[Fobs(A+Not_B)−Fexp(A+Not_B)]**2/Fexp(A+Not_B)+[Fobs(Not_A+Not_B)−Fexp(Not_A+Not_B)]**2/Fexp(Not_A+Not_B)
Chi_square_value_degree_{—}1(Significance_Level)
   where the significance level is selected by the user using a Chi-square test distribution table.

In theory, any combination of the above rules can be used to identify novel itoms. In practice, 1) is usually applied to every candidate first to screen out low-frequency events (where any statistically measure may seem powerless). After 1) is satisfied, we apply either 2) or 4). If one of 2) or 4) is satisfied, we consider the citom a newly identified itom. 3) was used before. 4) seems to be a better measure than 3), and we have been replacing 3) with 4).

### 2.5 Handling of Common Words

### Definition

Common words, also known as stop words, are the words that occur with very high frequency. For example, ‘the’, ‘of’, ‘and’, ‘a’, ‘an’ are just a few common words.

In indexing step, we maintain a common word dictionary. This dictionary can be edited. This dictionary needs to be stemmed as well.

### Usage

1) In the itom identification step, the stemmed common word dictionary is loaded and used. After reading the file, they were assigned a unique word_ID, and these IDs were output into the inverted index file.

2) Also in the itom identification step, if an identified phrase has a common word as beginning or ending, it is not viewed as a new itom, and is not written into the newly identified itom collection.

3) In the inverted index file, a common word is not entered unless it is appeared within an itom of an entry. In another word, within the inverted index file, there is appearance of common words. However, this list is a partial list: it only contains the appearance of those common words that appeared within an itom defined by the DB.itm file.

### III. Searching

### 3.1 Introduction

The searching part is composed of: web interface (for query entry and result delivery); search engine client (receives the query and delivers to the server); search engine server (query parsing, and the actual computation and ranking of results). We have substantially improved the searching algorithm for search precision and speed. The major changes/additions include:
1) Recording word indices instead of itom indices. Itoms are resolved at the search time dynamically (dynamic itomic parser).
2) Using sparse array data structure for index storage and access.

### Definitions:

Word: a contiguous character string without space or other delimiters (such as tab, newline, etc.)

Itom: a word, a phrase, or a contiguous string of limited length. It is generated by indexing algorithm (see Chapter II).

Si-score: Shannon information score. For each itom, the Si-score is defined as log 2(N/f) where f is the frequency of the itom, and N the total itom count in the data corps.

### 3.2 Engineering Design

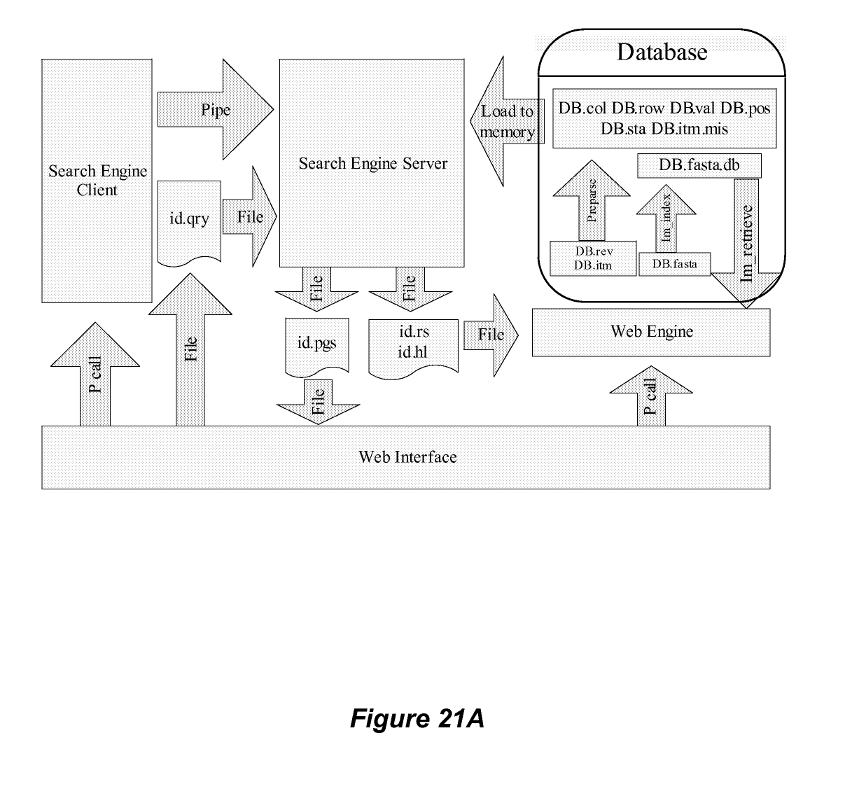

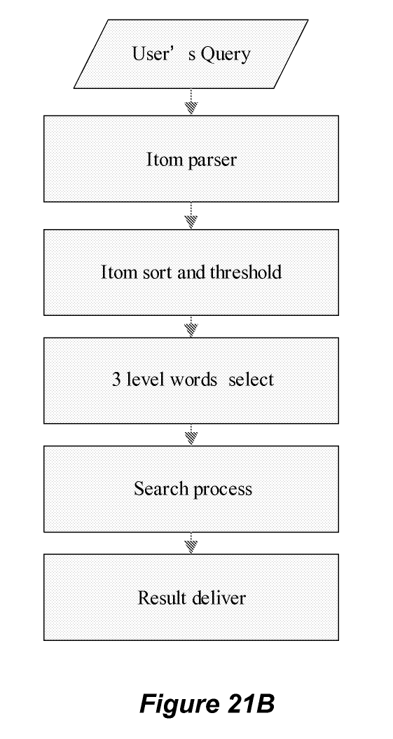

There are four major components for the search engine: the web interface, the search engine client, the search engine server, and the indexed database files and interfaces. This arrangement is shown in FIG. 21A. The web interface receives user search request, and delivers result to the user. The Search engine client sends the request to search engine server. The search engine server parses the query into its components, generates the hit candidates and ranks them according to their Si-scores. The database components (index files, and a plain-text database interface) interacts directly with web interface for delivering the individual hits with highlighting.

FIG. 21A: Architecture of search platform. Notes: P call=process call

FIG. 21A. Overall architecture of search engine. The web interface receives user search request, and delivers result to the user. The Search engine client sends the request to search engine server. The search engine server parses the query, and generates the hit candidates and ranks them according to Si-score. The database components interacts directly with web interface for delivering the individual hits with highlighting.

FIG. 21B shows the search engine from a data flow point of view. A user submits his query via the web interface. The server receives this request. It sends it to the itom parser, which identifies the itoms within the query. These itoms are then sorted and grouped according to pre-defined thresholds. These selected itoms are broken down to its component words. A 3-level word selection step is used to select the final words to be used in the search, as the inverted index file only records the words and their positions in the corps.

The search process takes the input words, retrieves the indices from the inverted index file. It generates the candidate entry lists based on these indices. The candidate entries are reconstructed based on the hit-words they contain and their positions. The query is now dynamically compared to each candidate to identify the matching itoms, and to generate a cumulative score for each hit entry. Finally, the hits are sorted according to their score and delivered to user.

FIG. 21B. Data flow chat of search engine. User's query first passes through a itom parser. These itoms are then sorted and grouped according to pre-defined thresholds. A 3-level word selection step is used to select the final words to be used in the search. The search process takes the input words, generates the candidate lists based on these words, re-constructs the itoms dynamically for each hit, and computes a score for each hit. These hits are sorted according to their score and delivered to user.

### 3.3. Web Client Interface

The web client interface is a program on the server that handles the client requests from web clients. It accepts the request, processes it, and passes the request to the server engine.

Here is an outline of how it works: the client program is under web_dir/bin/. When a query is submitted, web page will call this client program. This program then outputs some parameters and content data to a specified named pipe. The search engine server checks this pipe constantly for new search requests. The parameters and content data passed through this pipe include a joint sessionid_queryid key, and a command_type data. Search engine server will start to run the query after it reads the command_type data from the client.

### 3.4. Search Server Init

The search engine needs the following files:
1) DB.itm: a table file containing the distribution of all itoms, in the format of “itom frequency itom_id”.
2) DB.rev: reverse index (inverted index) file. It is in FASTA format:
   >itom_id
   bid (position_{—}1, position_{—}2) bid (position_{—}3, position_{—}4) where bid are the binary ids of data entries from the corps; position_n are the positions of these itoms within the entry.

Search engine parses reverse index file into four sparse arrays. We call them row, col, val, and pos arrays.
1) row array stores store col array index.
2) col array store all binary_ids.
3) val array store position indices.
4) pos array store position data of itoms appear in original database.

With val and row arrays we could retrieve index of all binary ids and all positional data by itom id. In order to increase the loading speed of index files, we split the reverse index into these 4 arrays, and output them individually on hard disk as individual files in the indexing step.

When search engine starts up, it will:
1) Read DB.row, DB.col, DB.val and DB.pos files into memory instead of reading reverse index file.
2) Open DB.itm file, read in the “itom->itom_id”, “itom_id->frequency” data into memory.
3) Build the itom score table by “itom->frequency” data.

### 3.5. Itom Parser

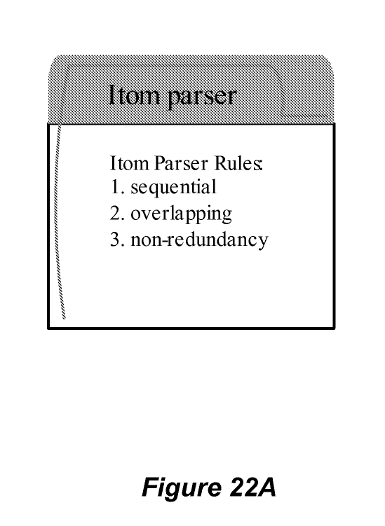

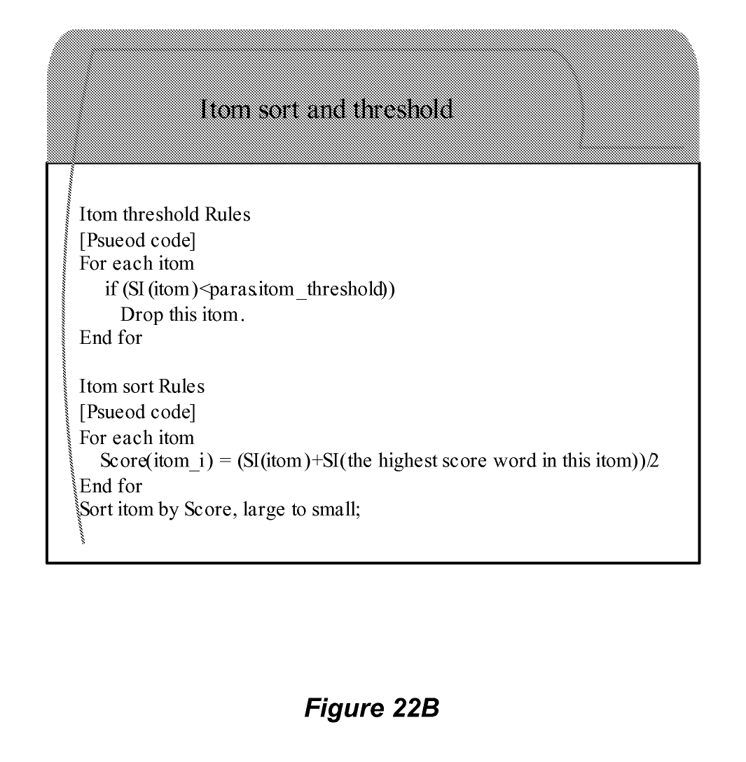

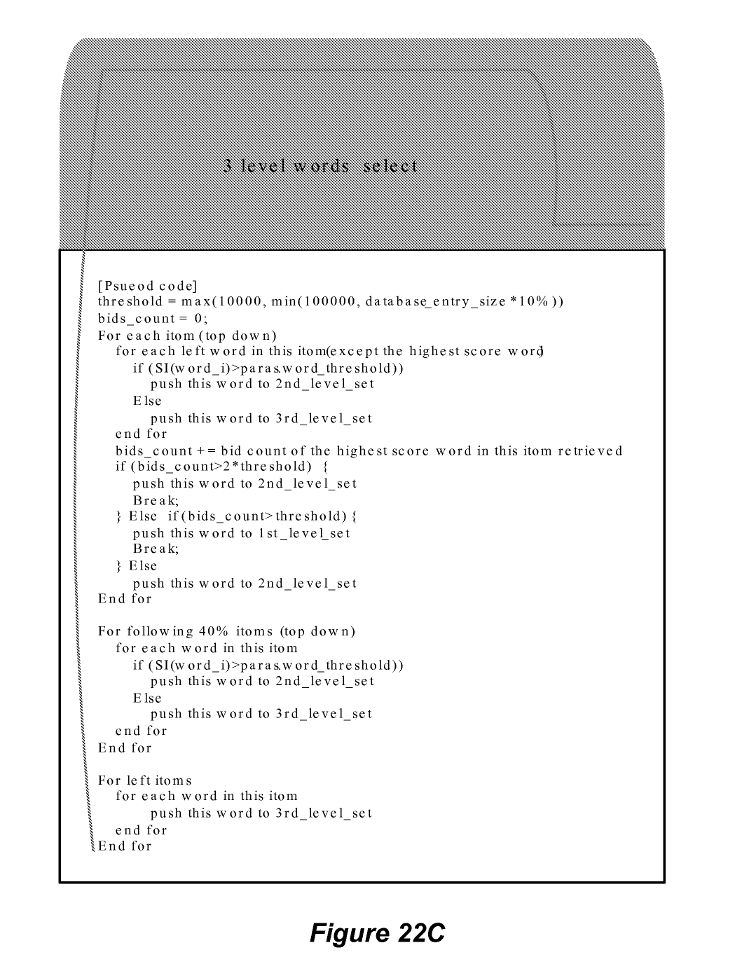

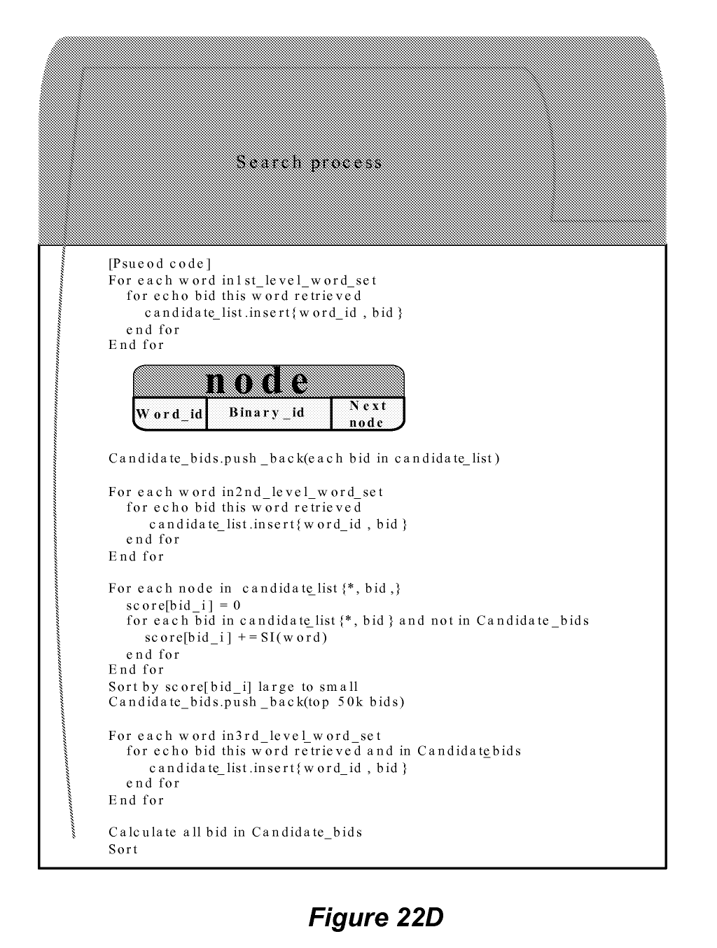

FIG. 22A. Distinct itom parser rules.

When user submits a query, the query is first processed by the itom parser. The itom parser performs the following functions:
1) Stem the query words using Porter stemmer algorithm (same way as the corps are stemmed).
2) Parser the stemmed query string to itoms by non-overlapping, redundant, sequential rules.
3) Sort itom list.
4) Split these itoms to word and assign these words to 3 levels, each level contains some words.

Here is an explanation of these parser rules:
1) Sequential: we go from left to right (according to the order of language). Each time we shift by 1-word. We look for the longest possible itom starting with this word.
2) Overlapping: we allow partial overlaps between the itoms from the parser. For example, suppose we have string: w1−w2−w3−w4, where w1+w2, w2+w3+w4 are itoms in DB.itm, then the output will be “w1+w2”, “w2+w3+w4”. Here “w2” is the overlapped word.
3) Non-redundant: if the input string is “A B”, where “A” and “B” are composed of words. If A+B is an itom, then the parser output for “A B” should be just A+B, and not any of components that are wholly contained (e.g. “A” or “B”). Using the example of “w1−w2−w3−w4” above, we will output “w1+w2”, “w2+w3+w4”, but we will not output “w2+w3” even though “w2+w3” is also an itom in DB.itm. This is because “w2+w3” is fully contained within a longer itom “w2+w3+w4”.

### Itom Selection Threshold and Sorting Rules

FIG. 22B. Itom selection and sorting rules.

In selecting candidate itoms for further search, we use a threshold rule. If an itom is below this threshold, it is dropped. The dropped itoms are very common words/phrases. They usually carry little information. We provide a default threshold value which will filter out very common words. This threshold is a parameter a user can adjust.

For the remaining itoms, we will sort them according to a rank. Here is how they are sorted:
1) For each itom, calculate (si-score(itom)+si-score(the highest score word in this itom))/2
2) Sort score from high to low.

### 3-Level Word Selection

FIG. 22C. Classifying words in query itoms into 3 levels.

For a full-text as query search engine, computation speed is a key issue. When we design our algorithm, we aim at 1) not missing any top-scoring hit; 2) not mis-scoring any hit or segment; 3) using filters/speeding-up methods whenever 1) and 2) are not compromised. Assigning 3 distinctive levels for words in the query itom collection is an important step in achieving these objectives.

As the inverted index file is a list of words instead of itoms, we need to select words from the itom collection. We group the words into 3 levels: 1st level, 2nd level, and 3rd level. We treat differently the entries containing words in these levels.
1) For words making into 1st level, all the entries will be considered in the final list for score computation.
2) For entries containing words in the 2nd level yet without any 1st level word, we will compute an approximate score, and select top 50,000 bids (entries) from the list.
3) For the 3rd level words, we will not retrieve any entries containing them if these entries do not contain 1st level and 2nd level words. In another word, 3rd level words do not generate any hit-candidates. We will ONLY consider them in these bids that are in the collection of level-1 and level-2 bids in the final score computation.

FIG. 22C shows the pseudo-code on how to classifying words in the query itoms into the 3-levels. Briefly, these are the classification logic:
1) We maintain and update a 1st-level bid number count (bid_count). This count is generated interactively by looking up the word frequencies in the DB.itm table. We also compute a bid_count_threshold. Bid_count_threshold=min(100 K, database-entry-size/100).
2) For each sorted itom, if itom si-score is lower than itom threshold, all words within this itom are ignored.
3) For the top max(20, 60%*total_itom_count) itoms, for the highest si-score word within the itom,
   a) if bid_count<bid_count_threshold, it is a 1st-level word;
   b) if bid_count>bid_count_threshold, it is a 2nd-level word.
4) For other words within the itom,
   a) If si(word)>word_si_threshold, it is a 2nd-level word.
   b) If si(word)<word_si_threshold, it is a 3nd-level word.
5) If there is remaining itoms (40% lower-scoring itoms), for each word within the itom,
   a) If si(word)>word_si_threshold, it is a 2nd-level word.
   b) If si(word)<word_si_threshold, it is a 3nd-level word.

### 3.6 Search Process

### 3.6.1 Overview

There are two types of searches: global search or segmented search (aka local search). In a global search, we want to identify all the entries that have matching itoms with the query, and rank them according to a cumulative score, irrespective the size of the entries or where the matching itoms appear within the entries. In a segmented search, we will consider the matching itoms within an entry and where these matches occur. Segments containing clusters of matching itoms are single out for output. For databases with inhomogeneous entry sizes, global search may produce poor hit list because it is biased toward long entries, whereas a segmented search will correct that bias.

In searching, we first need to generate a candidate list of entries for the final computation of hit scores and for ranking the hits. From this candidate list, we then compute the score for each candidate based on the itoms it shares with the query, and how these itoms are distributed within the candidate for segmented searches. For global search, an overall score is produced. For segmented search, a list of segments and their scores within the candidate are generated.

The candidate list is generated from the 1st level words and 2nd level words. While all entries containing 1st level words are a hit candidate, the entries containing 2nd level words are screened first, and only the top 50,000 bids in this set is considered a candidate. Level 3 words do not contribute to the generation of final candidates.

FIG. 22D: Generating candidates and computing hit-scores.

### 3.6.2 Search Logic

Here is an outline of search logic:

For 1st level words:
1) Retrieve bids with each word in 1st level.
2) Reserve all bids retrieved. These bids are automatically inserted into the hit candidate set.
   For 2nd level words:
1) Retrieve bids with each word in 2nd level.
2) Except those bids retrieved by 1st level words, we compute a si-score for the remaining bids based on 2nd level words.
3) Sort bids by this cumulative si-score.
4) Reserve up to 50,000 bids from these pool. This set of bids is added to the hit candidate set.
   For 3rd level words:
1) No new bid contribution to the hit candidate set.
2) Retrieve all bids with each word in 3rd level. Trim these lists to just retain the subset of those bids/positions where the bid appeared in the hit candidate set.

For those entries that made into the final hit candidate set, we can reconstruct each entry based on the positional information retrieved so far for words in all levels (level 1, 2 & 3). We will perform both global search and segmented search based on the re-constructed entries. In global search, an overall score for the entire entry is generated, based on the cumulative matching between query itoms and itoms within the entry. For segmented search, a gap penalty is applied for each of the non-matching word within a segment. The lower and upper boundaries of segments are determined so that the overall segment score can be maximized. There is a minimum threshold requirement for segments. If the score for the candidate segment is above this threshold, it is kept. Otherwise, it is ignored.

In computing for the overall score, or segment score for the segments, we use a procedural called “dynamic itom matching”. The starting point of “dynamic itom matching” is a collection of query itoms from the query, following the “sequential, overlapping, and non-redundant” rules in Section 3.5. For each candidate hit, we re-construct its text from the inverted index file, using all the itomic words and their positions that have been retrieved. The gaps within the positions are composed of non-matching words. Now, we run the same parser (with the “sequential, overlapping, and non-redundant” rules) on the re-constructed entry to identify all its matching itoms. From here:
1) Total score of the entry can be computed using all the identified itoms.
2) Segments and segment scores can be computed using the identified itoms, their positions within the entry, and the gap sizes between those itoms. Naturally, gap sizes for neighboring itoms or overlapping itoms are zero.

### 3.6.3 Score Damping for Repeated Appearances of Itoms in Hit

One challenge in search is how to handle repetitions in query and in hits. If an itom appears once in query, but k times in hit, how should we compute its contribution toward a total score? The extremes are: 1) just add the SI(itom) once, and ignore the 2nd or 3rd, . . . appearances. Or, 2) we can multiply the SI(itom) by the repetition times k. It is obvious that neither of these two extremes are good. The appropriate answer is to use a damping factor, α, to damp out the effects of multiple repetitions.

More generally, if an itom appears in query n times, and in hit k-times, how we should calculate the total contribution from this itom? Here we give out two scenarios of how to handle this general case. The two methods differ in how fast the damping occurs when query itom is repeated n times within query. If n=1. then 2 methods are identical.
1) Fast damping

SI_total(itom)=k*si(itom), for k<=n;

n*si(itom)+Sum_{i=1, . . . , (k-n)}αⁱ⁺¹*si(itom), for k>n.
2) Slow damping

$$\begin{matrix}SI\_total ( itom ) = k * si ( itom ) , for k <= n ; \\ = n * si ( itom ) ( 1 + {Sum}_{i = 1 , … , [ ( k - n ) / n ]} {α}^{i} ) , \\ for k > n and ken == 0 ; \\ = n * si ( itom ) ( \begin{matrix}1 + {Sum}_{i = 1 , … , [ ( k - n ) / n ]} {α}^{i} + \\ ( ( k - n ) \% n ) / n * {α}^{[ ( k - n ) / n ] + 1}\end{matrix} ) , \\ for k > n and ken != 0.\end{matrix}$$

Here si(itom) is the Shannon information score of the itom. SI_total is the total contribution of that itom toward the cumulative score in either global or segmented search. α is the damping coefficient (0<=α<1). % is the modulus operator (the remainder of division of one number by another); and [(k−n)/n] means the integer part of (k−n)/n.

In the limiting case, when k goes to infinity, there is an upper limit for both method 1) and 2). For 1), it is:
1) Limiting case for fast damping

SI_total(itom)=n*si(itom)+(1/(1−α)−1)*si(itom)
2) Limiting case for slow damping

SI_total(itom)=n*si(itom)/(1-a).

### 3.6.4 Algorithm for Identifying High-Scoring Segments (HSS)

Previously we identify HSS via accessing the forward mapping file (DB.itom.fwd, FASTA file of pid to itom_id mapping). Candidates are first generated from the reverse mapping file (DB.itom.rev, FASTA file, itom_id to pid mapping), and then each candidate is retrieved from the DB.itom.fwd file. This is a bottleneck of search speed, as it requires the disk access of forward index file. In the new implementation, we will calculate local scores from the reverse index file only, which is already read into memory at engine startup time. The positional information of each itom is within the DB.itom.rev file (reverse index file, aka inverted index file) already.

### Assumptions:

Query: {itom1, itom2, . . . itom_n}. The inverted index file in memory contains the hit itoms and their file and position information. For example, in memory we have:

Itom1 pid1:pos1,pos2,pos3 pid2:pos1 pid3:pos1 . . . .
Itom2 pid1:pos1,pos2,pos3 pid2:pos1pid3:pos1 pid4:pos1 pid5:pos1 . . .
Itom_n pid1:pos1,pos2,pos3 pid2:pos1 pid3:pos1 pid4:pos1 pid5:pos1 . . .

### Algorithm:

The pseudo code is written in PERL. We will use a 2-layer hash (hash of hash): HoH {pid} {position}=itom. This hash records what itom in what entry, and the position in each occurrence. HoH hash is generated by reading the hit itoms mentioned above from the reverse mapping file.

Intermediate output: two arrays, one tracks positive scores, one tracks negative scores.

Final output: a single array with positive and negative scores.

For each pid in HoH, we want to generate two arrays:
1) Positive-score array, @pos_cores, dimension: N.
2) Negative-score array, @neg_scores, dimension: N−1.
3) Position array, positions of for each hit itom

To generate these arrays:

```
for each $pid in (keys %HoH) { #$pid is the keys
    %H_entry = %HoH{$pid} # H_entry{position}= itom for a
    single entry.
    for each $position sort { $H_entry{$a} [symbol] $H_entry{$b}}
    %H_entry {
        $itom=$H_entry->{$position};
        $score=SI($itom);
        $itom_pos=$position;
        push(@position, $position);
        push (@pos_cores, $score);
        if ($temp_ct>0) {
            push(@neg_scores)=
            ($position−$old_position)*$gap_penalty;
            $old_position=$position;}
        $temp_ct++;
    }
    @HSSs= identify_HSS(@pos_score, @neg_score, @positions);
}
```

Now the problem is reduced to finding the high scoring segment between a stretch of positive and negative scores, and report back the coordinates for the HSSs.

The final segment boundaries are identified by an iterative scheme that starts with a seeding segment (a single positive-scoring stretch in the above array: @pos_score). Suppose we have a candidate starting segment, we will perform an expansion on each side of that segment, until there is no extension possible. Please notice, the neighboring stretch (to the left or the right) is a negative-scoring stretch, followed by a positive-scoring stretch. In the expansion, we will view this negative-scoring stretch followed by positive-scoring stretch as a pair. We may choose distinct ways of extending the seeding segment into a long HSS via:
1) 1-pair look-ahead algorithm;
2) 2-pairs look-ahead algorithm;
3) Or, in general, K-pairs look-ahead algorithm (K>0).

In 1-pair look-ahead algorithm, we will allow for no decreasing in the cumulative information measure score for every single pair we extend (e.g., adding a single pair of the negative-score stretch followed by a positive-score stretch). Thus, at the end of a single iteration of 1-pair look-ahead algorithm, we will either extend the segment by 1-pair of negative-scoring stretches followed by positive-scoring stretches, or we cannot extent at all.

In 2-pairs look-ahead algorithm, we will allow for no decreasing in the cumulative information measure score for every two pairs we extend (e.g., adding 2-pairs of the negative-score segment followed by a positive-score segment). If the 2-pair step causes a decrease in the cumulative information score, we will drop the last pair, and check if the 1-pair extension is OK. If yes, then our new boundary is extended by only 1-pair of stretches. If not, we default back to the original segment.

This 2-fair look-ahead algorithm will generate longer segments compared to 1-pair look-ahead algorithm, as it contains the 1-fair look-ahead algorithm within its computation.

In general, we may perform a K-pairs look-ahead, which means we will allow a dip in the cumulative information score up to K−1 pairs, so long the K-pairs in totality increases the overall information score if we extend our segment boundary by K-pair times. For larger K, we will generate longer HSSs, if all other conditions remain the same.

### 3.6.5 Summary

To summarize what we said so far, for each bid in the hit candidate set, we do:
1) Retrieve all position for each word from the query itoms (with si(itom)>threshold).
2) Sort by positions retrieved from the inverted index file.
3) Using a dynamic parser to identify all matching itoms in the bid.
4) Calculate global score and segment score with damping.

### 3.7. Result Delivering

After search process, retrieved-bids-set have enough information:
1) Global score;
2) Segment scores;
3) Positional information for high-scoring segments;
4) Query highlighting information;
5) Information of matching itoms.

There are 3 output files from a search process. They are:
1) Hit summary page. It contains info about:
   Bid, global score and segment scores.
2) Highlighting data file. It has:
   Bid, query highlight information, highest score segments position information
3) Listing of matching itoms. This file has limited an access control. Only a subset of users can access this info. It contains:
   Itom_id, itom, si-score, query frequency, hit frequency, cumulative score.

The webpage interface programs then translate those files into HTML format and deliver them to users.

### IV. Web Interface

The web interface is composed of a group of user facing programs (written in PHP), backend search programs (written in C++), and a relational database (stored in MySQL). It manages user accounts, login and user authentication, receives user queries and posts it to the search engine, receives from search engine the search results, delivers both summary result pages and detailed result pages (for individual entries).

### 4.1 Database Design

User data are stored in a relational database. We currently use MySQL database server, and the customer database is Infovell_customer. We have the following tables:
2) User: containing user profile data, like user_id, user_name, first_name, last_name, password, email, address, etc.
3) DB_class: containing database information, including names and explanations about the database, like MEDLINE, USPTO, etc.
4) DB_subtitle: parameters for search interface.
5) user_options: parameters user can specify/modify during search time. Default set of values provided.

### 4.2 Sign-In Page and Getpassword Page

index.php page is the first customer facing page on the web. It let user to sign in, or get his “password” or “userid” if an account already exists. When server.infovell.com is clicked from a web browser, index.php delivers a user-login page.

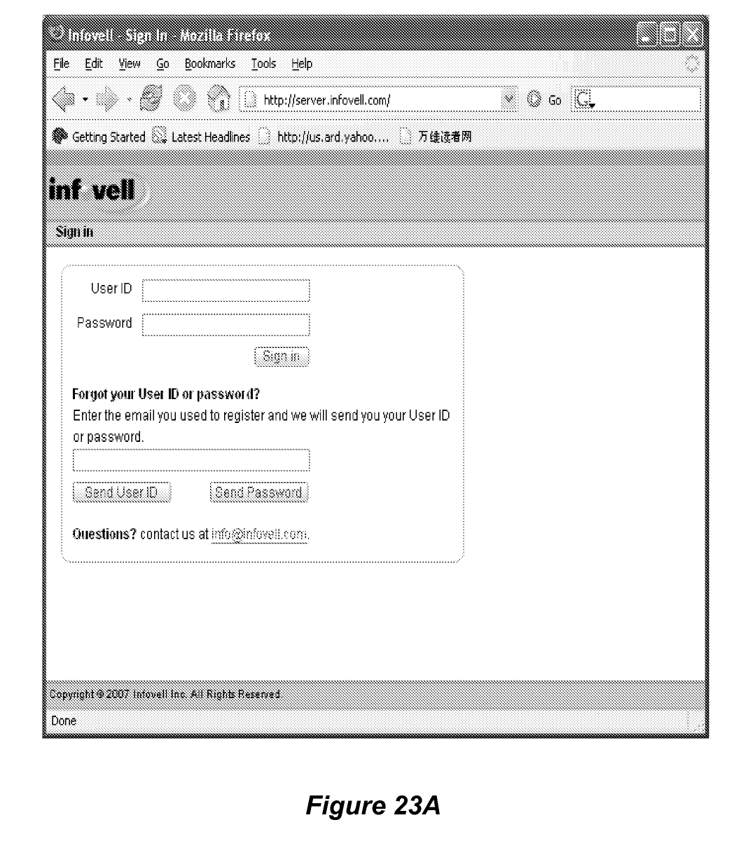

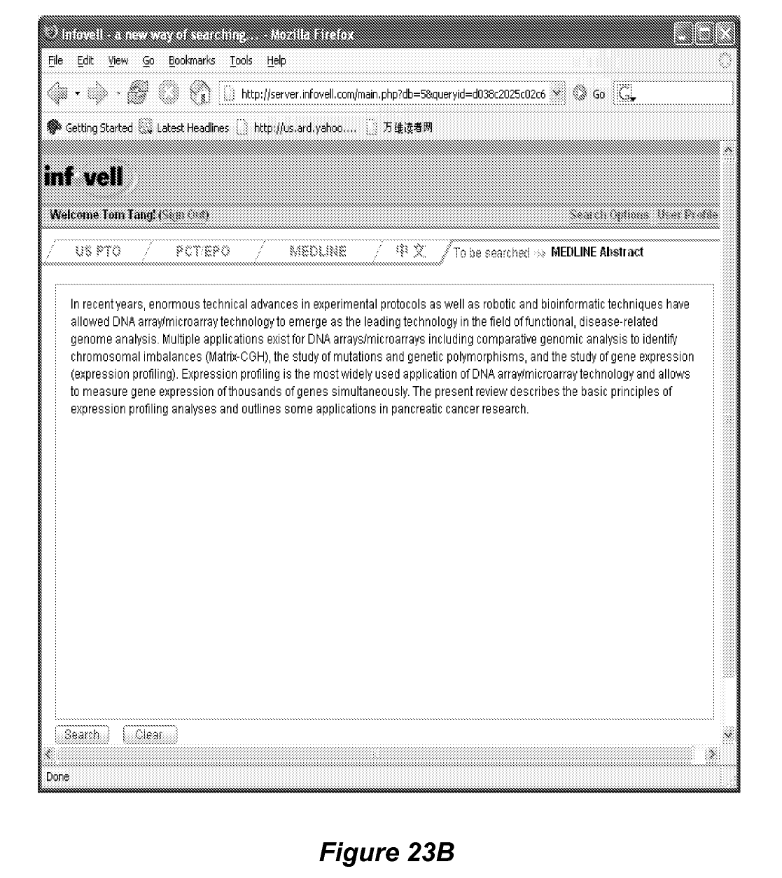

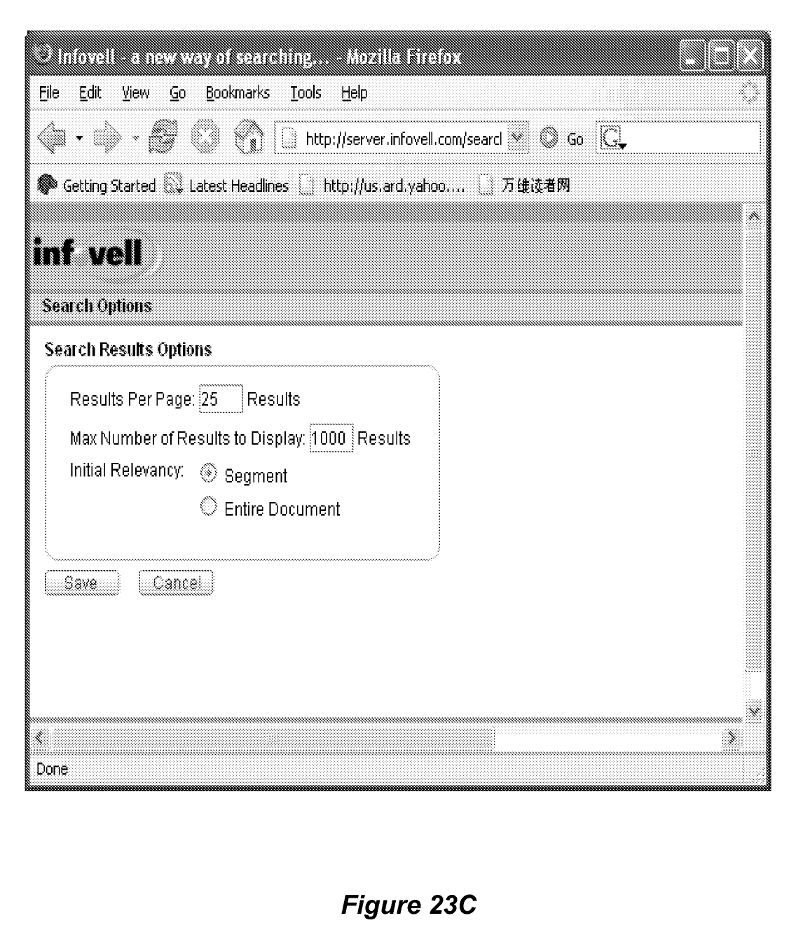

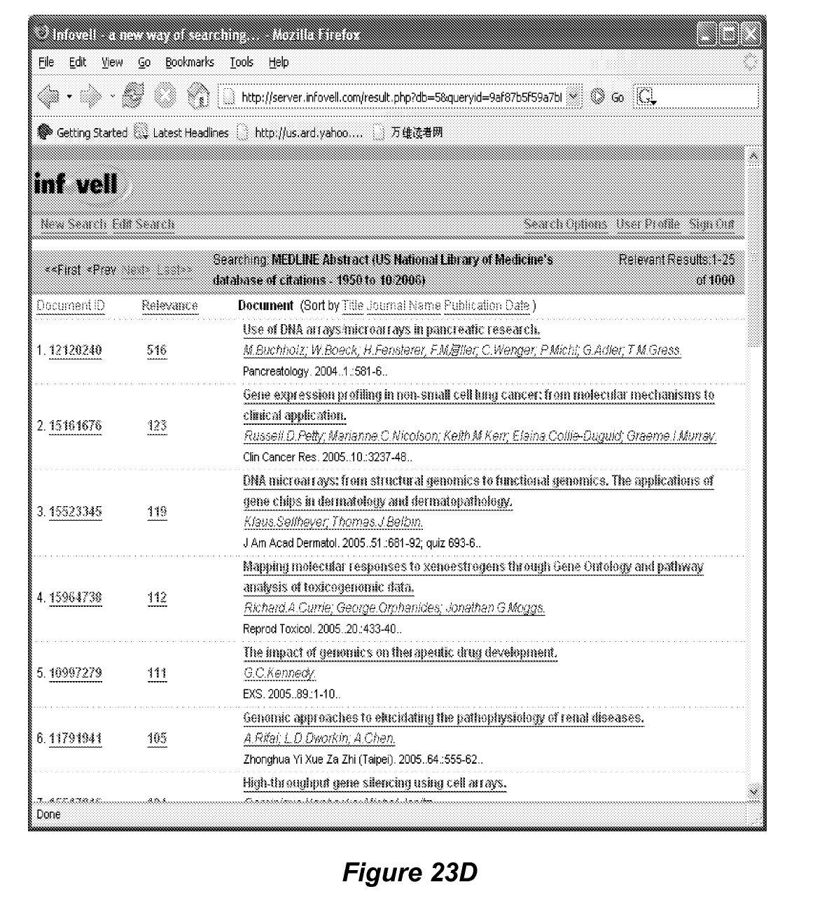

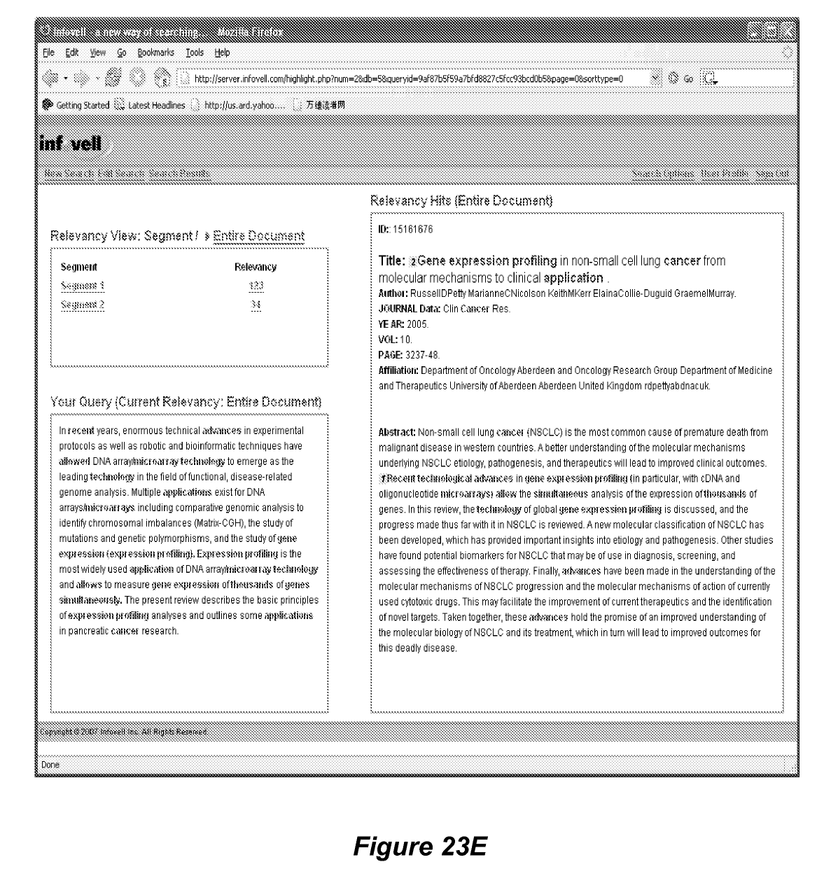

FIG. 23A. User login page. It collects user information include userid, password. When an email is provided for an existing user, “send user ID” button will send the user userid, and “send password” button will send the user password.

If “Sign in” button is clicked, it will trigger the following actions:
1) index.php will post the parameters to itself, get userid, and password.
2) Query the User table in MySQL Infovell_customer database.
3) If failed checking the userid and password, it will display error message.
4) Else it will set some session values to let user sign in, then go on for main.php

If “Send User ID” or “Send Password” button is clicked:
1) index.php will post the email info to getpassword.php.
2) getpassword.php will query the User table in MySQL Infovell_customer database.
3) If no such email, it will show an error message
4) Else it will send email to user's email address with information of “userid” or “password”.
5) Redelivering the login-page by running index.php

### 4.3 Search Interface

After login, the user is presented with the main query page (delivered by main.php). A user must select a database to search (with default provided after login), and a query text. There are two buttons on the button of the query box: “Search” and “Clear”. When “Search” button is clicked, it will get the information on query text and on which database to search. The search options should also be defined. “Search Options” on the upper right corner let a user change these settings, and “User Profile” button next to “Search Options” let a user to manage his personal profile.

FIG. 23B. Main query page. There are multiple databases available to search, and a user should specify which one he wants to search. Two bottom buttons (“Search” and “Clear”) let the user either to fire off a search request, or clear the query entry box. The two buttons on the upper right corner let the use modify his search options (“Search Options” button) and manage his personal profile (“User Profile” button). Shown here we have an entire abstract of a research article as query.

If a user clicks the “Clear” button, main.php will clear all text in the query text area, using a javascript program. It re-delivers the main query page.

If a user clicks the “Search” button, it will trigger the following sequences of actionsL
1) main.php: post query to search.php program.
2) search.php: search.php receives the query request, and performs the following tasks sequentially:
   (i) generate a random string as queryid. Combine queryid with its sessionid to generate a unique key for recording the query: sessionid_queryid; write the query to a file: html_root/tmp/sessionid_queryid.qry
   (ii) start a client, a C++ program, to pass search options to search engine via a named pipe: sessionid_queryid and search command type. If the client returns error code, go on for error.php
   (iii) go on to progress.php
3) progress.php: once received the request from search.php, it will do:
   (i) read html_root/tmp/sessionid_queryid.pgs once every second until it's content is larger than 100 (which means searching is complete).
   (ii) if return 255 from html_root/tmp/sessionid_queryid.pgs file, then go to run: noresult.php
   (iii) if return 100 from html_root/tmp/sessionid_queryid.pgs file, then go to run: result.php to show results.

Which database to search:

1) main.php: one of the cookies is the pipe number (db=pipe number). The pipe number decides which database to be searched.

How to pass search options to search engine server:
1) main.php: click on “Search Options” to run searchoptions.php
2) searchoptions.php: when “save” button is clicked, search options will be written to html_root/tmp/sessionid.adv
3) when the client starts, it passes sessionid to search server. Search server will load the new options data if a sessionid.adv file exists.

FIG. 23C. “Search Options” link. This page allow user to set search time options.

### 4.4 Results Pane

After clicking on the “Search button”, the result will be delivered with a time delay.

FIG. 23D. Sample result summary page. Meta data are delivered on the right column. Each underlined field is sort-able (via clicking on “Sort by” link at the column header area). Relevance link provides a highlighting page where query and a single result is compared in a side-by-side fashion.

When searching complete, results should be shown on results page.

1) result.php: a C++ program will be startup to parser the result file(html_root/tmp/sessionid_queryid.rs). It then returns the results information.

2) Show the summary page of results on web page.

### 4.5 Highlighting Page

When click on the “Relevancy score” cells on the result summary page delivered by result.php, the highlighting page will be displayed via a program: highlight.php.

3) highlight.php: a C++ program that parsers the result file (html_root/tmp/sessionid_queryid.h1), then return the highlighting information.

4) With the highlighting information, highlight.php delivers a result page with matching itoms highlighted.

FIG. 23E. Highlighting page for a single hit entry. High-scoring segments from the hit entry is shown here (numbers in yellow color). The matching itoms within the high-scoring segments are highlighted in blue color here. Users can toggle between various high-scoring segments, or switch between a “global view” (by clicking the “Entire Document” button on top) or the Segmented view (default).

### 4.6 End Search Session

A user can end the search session by clicking the “Sign out” button which is present in the main query page (upper left corner), as well as the summary result page, and the highlighting page (upper left corner).

### V. Query Expansion and Similarity Matrix

Itoms as basic information units are not necessarily independent of each other. There are two distinct types of itomic relations. 1) Distinct itoms that means the same thing. Synonyms and abbreviated names form this category. For example, tumor or tumour; which one you use depends on which country you are from. In another example, USA, United States, United States of America, all contain the same information (may be slightly different, but who cares). 2) Distinct itoms that have related meaning For example: tumor vs cancer, “gene expression data” vs “gene expression”.

For synonyms, synonym file induces an expansion of itom list, and a reduction in SI for the involved itoms. This step applies to the SI-distribution function.

For related itoms, we have an automated query expansion step. We expand query to include itoms that a related in meaning. In search, we adjust the Shannon information computation of these itoms based on a similarity coefficient. The similarity coefficient for a synonym is 1.0.

There are many issues remain with regard to query expansion and similarity matrix.

### 5.1 Existing Method of Synonym Handling

Use internal synonym file: there is an internal synonym file, which contains the most common synonyms used in English language. These synonyms are words of the same meaning in British usage vs. US usage. The collection contains a few hundred such words.

Upload user-defined synonym file: A user can provide additional synonym file. It will be used in all subsequent searches once uploaded. The file should follow the format: a synonym group should be listed together, with each synonym separated by a comma, followed by a space. A semicolon is used to end the group. The new group starts in a new line.

Here is the content of an example file:
way, road, path, route, street, avenue;
period, time, times, epoch, era, age;
fight, struggle, battle, war, combat;

SI-score adjustment: Shannon information for all involved itoms should be adjusted. For example, the adjusted SI for the first case:

$$\begin{matrix}SI ( way ) = SI ( road ) \\ = SI ( path ) \\ = SI ( route ) \\ = SI ( street ) \\ = SI ( avenue ) \\ = - {log}_{2} ( \begin{matrix}f ( way ) + f ( road ) + f ( path ) + \\ f ( route ) + f ( street ) + f ( avenue )\end{matrix} ) / N\end{matrix}$$

This adjustment step should be done when the SI-score vector is loaded into memory, before any search computations. This SI-adjustment if not done, should be implemented before the similarity matrix computation.

### 5.2 Definition of Similarity Matrix

A similarity matrix SM is a symmetric matrix that shows the inter-dependency of itoms. It has L*L dimensions, where L is the total number of unique itoms within a given distribution. All components of SM range between 0 and 1 (0<=x<=1). The diagonal elements are all 1.

In practice, SM is a very sparse matrix. We can use a text file to express it. Here is an example:

Itom₁ itom₂:x₁ itom₃:x₂ itom₃:x₃, where xᵢ coefficients between 0,xᵢ<=1.

Also, because SM is symmetric, we only need to record half of the matrix members (those that are above the diagonal). As a convention, we will assume that all the itom_ids on the right side of above formula are greater than the itom1.

Example 1: In the old synonym file, for the synonym list: way, road, path, route, street, avenue. If we assume itom_id(way)=1100, itom_id(road)=1020, itom_id(path)=1030, itom_id(route)=1050, itom_id(street)=1080, itom_id(avenue)=1090, then, we have the following representation:

1100 1020:1 1030:1 1050:1 1080:1 1090:1

One should take note that all the itom_ids following the first_ID should have a smaller number. We can do this because the similarity assumption of SM. Also, we did not list 1100 on the right-side, as 1100 will have similarity 1.0 by default.

Example 2: Suppose we have an itom: “gene expression profile data”, and the following are itoms as well: gene expression profile, expression profile data, gene expression, expression profile, profile data, gene, expression, profile, data.

In the SM, we should have the following entry (I did not use itom IDs here. One should assume gene_expression_profile_data has the highest ID as compared to all other itom IDs used in this example).

gene_expression_profile_data gene_expression_profile:x1 expression_profile_data:x2 gene_expression:x3 expression_profile:x4 profile data:x5 gene:x6 expression:x7 profile:x8

Comments: 1) “data” is not included in this entry, because “data” has SI<12.

2) The coefficient xi is computed this way:

x1=SI(gene_expression_profile)/SI(gene_expression_profile_data)

x2=SI(expression_profile_data)/SI(gene_expression_profile_data)

x3=SI(gene_expression)/SI(gene_expression_profile_data)

x4=SI(expression_profile)/SI(gene_expression_profile_data)

5=SI(profile_data)/SI(gene_expression_profile_data)

x6=SI(gene)/SI(gene_expression_profile_data)

x7=SI(expression)/SI(gene_expression_profile_data)

x8=SI(profile)/SI(gene_expression_profile_data)

The SI-function we use here is the one allowing the redundancy. In this way, all the x, satisfy the condition of 0<xᵢ<=1.

### 5.3 Generating Similarity Matrix for a Given Distribution

### 5.3.1 Assumptions

1. Itom IDs are generated according to an ascending scheme. Namely, the most common itoms have the shortest IDs, and the rarest itoms have the longest IDs. This itom ID assignation can be an independent loop separated from the itom identification program (see Itom Identification Specs). This method of itom ID assignment has positive implications:
1) on ASCII file size for both forward and reverse index files.
2) on compression/memory management.
3) on automated similarity matrix generation (this document).

2. An minimum coefficient x value is pre-set: minSimCoeff=0.25. If the component itom is <minSimCoeff, then it is not included in the SM.

3. Including similarity measures for wholly-contained itoms only. This version of the automated matrix generation only handles the case where an itom is completely contained within another. It does not consider the similarity in case of partial overlaps, for example, in a+b and b+c.

The partially similar itoms as in a+b vs. b+c, or between a+c vs. b+c+d will be considered in future iterations. The similarity-matrix approach outlined here can handle these kinds of similarities.

5.3.2 Input (DB.itom) and output (DB.itom.SM)

Psuedo code:

```
for l = L, l>0, l −− {
    break down itom(l) into components, all possible components
    (i=0, ...K)
      (You Sheng has the code to do this already)
    for i=0; i<=K; i++ {
        compute x(li) = SI(itom(i))/ SI(itom(l));
        if x(li) <minSimCoeff {next;}
        push (@SM(l), x(li));
    }
    write “itom(l) \t itom(0) ... itom(K)\n”;
}
```

### 5.4 Utilizing Similarity Matrix in Query Expansion

### 5.4.1 Read-In Similarity Matrix

In read-in similarity matrix, we have to expand the compressed expression into a full-blown matrix we can use. For each itom, our objective is to re-construct the entire list of itoms that have similarity to this specific itom. Suppose we use @itom_SC(1) (1=0, . . . , L) to indicate the similar itoms to itom(1).

### 5.4.2 Psuedo Code

```
for l = L, l>0, l −− {
    add “itom(l) \t itom(0) ... itom(K)\n” -> @itom_SC(l);
    for i=0; i<=K; i++ {
    add itom(l) -> @itom_SC(i);
}
```

Now, @itom_SC(1) contains all the similar itoms to it.

### 5.4.3 Query Expansion Via Similarity Matrix

1) Given a query text, we perform a step of non-redundant itomic parser step. In this step, the query text are decomposed into itoms by a group of longest possible itoms without overlap (as discussed elsewhere herein).

We will call this itom set: @itom_Proper.

2) For the top 40 SI-score itoms in @itom_Proper (with min-SI score >12), we will obtain a list of @itom_Expanded, with their occurrences @itom_Expanded_Ct, and their SI-score in @itom_Expanded_Sc.

For each itom_Proper member,
(1) Look up @itom_SC(1) for that itom.
(2) If an expanded itom is already in the query itom list, ignore.
(3) Compute its SI for this occasion.
   SI-score is re-computed by multiplying the similarity coefficient with the itom SI-score of what it is similar to.
   If an expanded itom has SI<12, ignore.
(4) Record the itom in @itom_Expanded, its occurrences in
@itom_Expanded_Ct, and its SI-score in @itom_Expanded_Sc. An average score is recorded in @itom_Expanded_Sc for an itom that been pulled in from distinct @itom_Proper itoms. For each occurrence of the itom,
   SI(itom)_updated=(SI (itom)_old+SI (itom)_this_occurance)/2 where SI(itom)_old is the previous SI-score for this expanded itom, SI(itom)_this_occurance is the new SI-score for the new itom_proper

For example, if (a1, a2, a3, a4, a5) are proper itoms, and they all extend to itom b in the itom expansion. Then, itom b should have:

| Itom | Occurance | SI-score |
|---|---|---|
| b | 5 | [SI(a1) + . . . + SI(a5)]/5 |

Notice, for each aᵢ, SI_expanded(b) = SI(b) * [SI(aᵢ)/SI(b)] = SI(aᵢ).

3) We will use the same 20-40% rule to select itoms from the @itom_Expanded to be included in the search. Namely,
a. if @#itom_Expanded (total number of elements) is <=20, then all itoms will be used in search.
b. If @#itom_Expanded >50, 40% of itoms will be used.
c. If 20<@#itom_Expanded <=50, top 20-SI itoms will be used.

### 5.4.4 Scoring a Hit

The SI-score for an itom depends on where it is coming from. Itoms in @itom_Expanded should us @itom_Expanded_Sc, the adjusted SI-scores determined in the query expansion step. In another words,
1) If an itom is directly included in the query, it SI-score from the DB.itom will be used.
2) If an itom is included in the query via a similarity matrix, then the SI-score for this itom should be from @itom_Expanded_Sc, not from DB.itom.

### VI. Federated Search

Federated search means searching multiple databases the same time. For example, if we have MedLine, US-PTO, PCT, and other databases, instead of search each individual database one at a time, we may want to search all the (or a collection of at least 2 of) databases. Federated search can be the default search mode, meaning if a user does not specify any specific database, then we will perform a search for all the available databases (or the collection of databases the user have the access privilege). Of course, a user should have the power to select the default collection of databases to be searched in federation within his access privilege. Typically but not necessarily, the databases are different (in the sense that they have different schemas), or they are queried through different nodes on a network, or both.

Once determined to perform a federated search, there are two ways of performing the search (computing the hit scores of individual entries in each database), and two ways of delivering the results to the user. For hit-score computation, A1: we can compute a federated score that will be equivalent to the hit score if all the databases are merged into a single one; or A2: we can have the hit score from the individual database stay unchanged. For result delivering, B1: we can deliver a single hit list which combines all the hits from individual databases. Or, B2: we can deliver a summary page that contains summary information from each individual database, and another click will lead to the hit-summary page for the specific database the user specified.

It is most natural to combine A1 with B1, and A2 with B2. But other combinations are OK as well.

### 6.1 Two Ways of Computing Hit Scores

### 6.1.1 Computing a Federated Score for a Hit (A1)

This method of scoring is implemented very similar to the computation of hit scores in a distributed search. Namely, there is only one single itom distribution table for the entire federation of databases. All the individual databases use this single table to score its hits. The scores for individual hits have global meaning: there are comparable. Thus, a hit in one database can be compared with another hit from another database.

The single itom table can be generated from the simple combination of all the individual tables (adding the frequency of each itom, and then compute a new SI-score based on the new frequency, and total database itom*frequency count). We can call this itom distribution table: DB_fed.itm.

Because the itom collections from the databases are likely distinct, we have to map the merged itom distribution table back into individual databases (thus, to keep the itom IDs for each database unchanged, just their scores adjusted). In this way, we don't have to change any other index files for the databases (e.g., the entry_ID mapping file or the inverted index file). The only file that needs modification is the DB.itm file. We can call this new table: DB.itm.fed. Notice, for DB1, and DB2, DB1.itm.fed is not the same as DB2.itm.fed.

### 6.1.2 Computing a Non-Federated Hit Score (A2)

The second way of hit score computation is to disregard the federated nature completely once the search task is rendered to individual database. The server will compute hit scores for hits within the database the same way as a non-federated search. This is nothing more to say here.

### 6.2 Delivering Results

### 6.2.1 In a Single Hit List (B1)

Once the computation of hit scores is complete, and the hit set generated from individual databases according to either A1 or A2, the results can be merged together into a single hit list. This hit list is sorted by the hit score (federated score for Al, or non-federated score for A2). We can insert the database information somewhere within each hit, for example, by inserting a separate column in the hit page that displays the database name.

### Meta-Data Issue

There will be no universal header data, though. As the header data (meta-data fields) may be different from database to database. In general when we perform a federated search, we will not be able to sort by the metadata fields as we can do in specific database searches on controlled data collection. We can still display each individual hits in the summary page according to its meta-data fields, though.

### Delivering the Individual Hit

We can preserve the specificity in displaying hits here. Namely, each hit from a specific database will have a specific style of displaying it, the same way as individual hit is displayed in non-federated searches.

### 6.2.2 In Multiple Hit Lists (B2)

This is a more traditional way of displaying results in a federated search. A summary page is first returned to user, containing summary information from each individual database (e.g., database name; database size; how many hits are found; the top score from this DB, etc.). The user can now select a specific database, and the summary page for that database will be displayed next. This result page will be exactly the same as he performed a non-federated search for this database specifically.

### Meta-Data Fields is Not an Issue

There is no meta-data issue here. As hits from a specific database is delivered together, the meta-data fields for the database can be delivered the same way as non-federated search.

### 6.3. Architectural Design of Federated Search

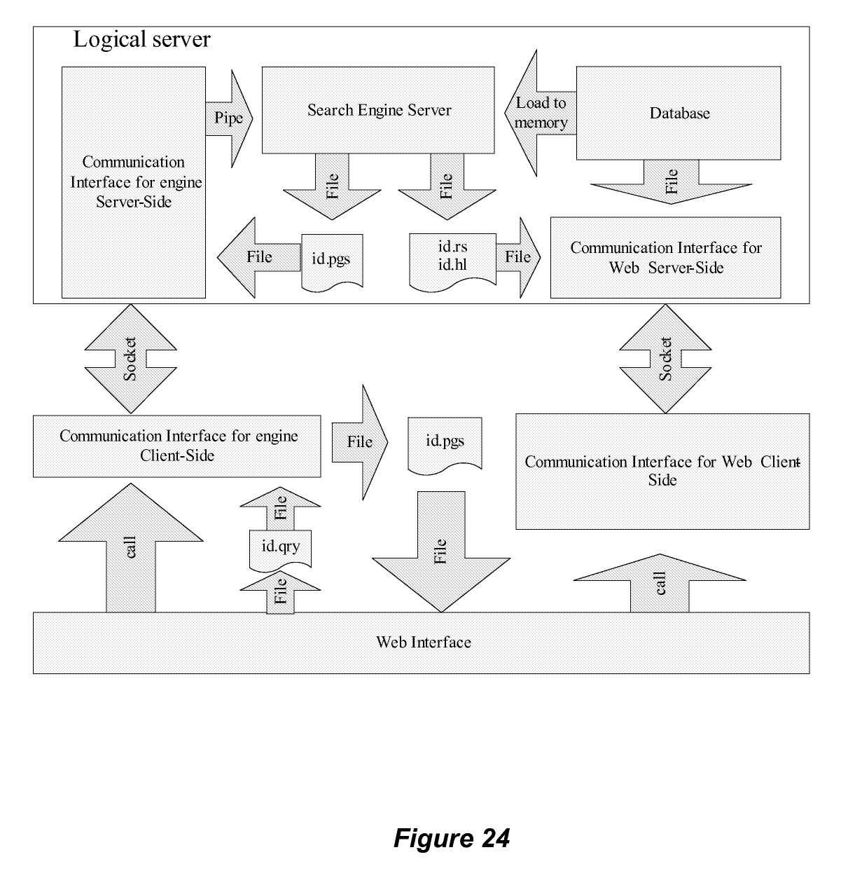

FIG. 24. Overall Architecture of Federated Search. The web interface receives user search request, and delivers result to the user. The Communication Interface from the Client-Side sends the request to the Communication Interface in the Server-Side running on a logical server. The Communication Interface from the Server-Side passes the request to the Search Engine Server. The Search Engine Server generates the hit candidates and ranks them according to the hit-scores. The Communication Interface program in the Client-Side interacts with Communication Interface program in the Server-Side to deliver results (summary information and the individual hits with highlighting data).

The Communication Interface for engine in the Client-Side is a program on the server that handles the client requests from web clients. It accepts the request, processes it, and passes the request to the Server-Side.

The Communication Interface fir engine in the Server-Side is a program running on the logical server that handles the requests from the Communication Interface for engine in the Client-Side. It accepts individual request, processes it, and passes the request to the Search Engine Server.

Outline of how they Work Together

The client-side program is under web_dir/bin/. When a query is submitted, web page will call this client-side program. This program then connects to the remote logical server Communication Interface in the Server-Side, which then passes the request content to the Server-Side. This program in the Server-Side outputs some parameters and content data to a specified named pipe on the logical server. The Search Engine Server checks this pipe constantly for new search requests. The parameters and content data passed through this pipe include a joint sessionid_queryid key, and a command_type data. The Search Engine Server will start to run the query after it reads the command_type data. A Server-Side program checks id.pgs for search progress. When a search is finished, the Server-Side program passes some content data to the Client-Side to indicate that searching finished on this logical server. For a federated search, a Client-Side program will check the return status from multiple Server-Side programs. If all are done, then the Client-Side program writes to the progress file to indicate the federated search has finished.

Communication Interface for web in the Client-Side is a program on the server that handles results or highlighting requests. It accepts the request, and passes the request to the Server-Side.

Communication Interface for web in the Server-Side is a program running on the logical server that handles the requests from the Communication Interface for the web in the Clients-side. It accepts the request, gets results information or highlighting information. It then passes these data to the Client-side.

### VII. Distributed Search

The objective of distributed computing is to improve search speed and the capacity of concurrent usage (the number of concurrent users on the search engine). The solution is to have multiple small computers (relatively cheap) to serve the multitude of search requests. Let's first try to standardize some terminology:

1. Master node: a computer that receives search requests and manages other computers.

2. Slave node: a computer that is being managed by another computer

3. Load balancer: distribute jobs to a group of slave nodes based on their load.

Here we make a distinction between a master node and a load balancer. A load balancer can be viewed as a master node, but it is a relatively simple master. It only balances the load at individual nodes; whereas a master node may be involved more elaborate computing tasks such as merging search results from multiple fragments of a database.

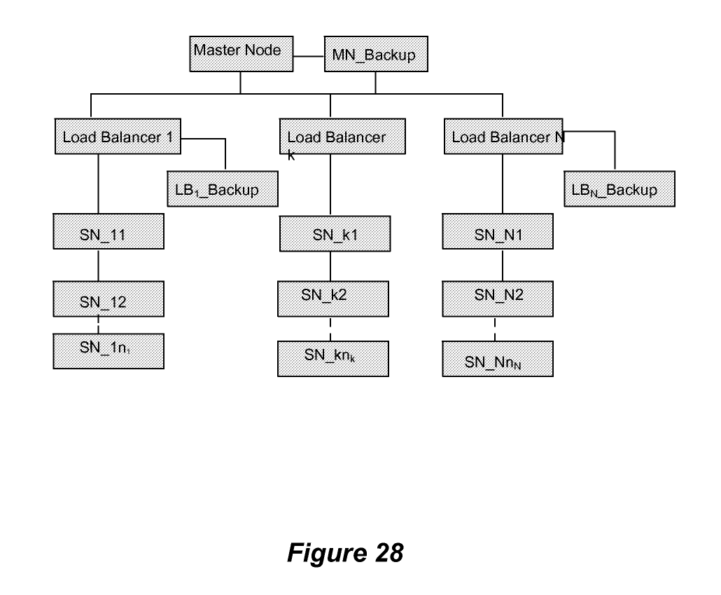

Master nodes, slave nodes, and load balancer can be integrated together to form a Server Grid. There are different ways of forming a server grid. In one formation, the database is split into multiple small DB segments. A group of computers, with a load-balancer as its head, are responsible for each DB segment. The grid master node views the load balancer for the group as slave nodes. In this configuration, we will have a single Grid Master (with potential backups), a number of Column Masters (Load balancers); and each column master manages a group of column slaves. FIG. 28 shows a schematic design of this formation.

FIG. 28. A Schematic design of a distributed computing environment. Master Node (MN), with Backup MN_Backup, receives search requests and distributes the task into a group of N Load Balancers (LB), with backups as well. Each LB manages a group of Slave Nodes (SN), which either performs search or indexing on a segment of database (DB[i], i=1, . . . . N).

### 7.1 The Task of a Load Balancer

The load balancer receives search requests. It observes the load of each individual server. Depending on the load of them, it distributes the search job to a single machine, usually the machine with least load at the moment of request. When the search is completed, the result is sent from the slave nodes, and presented to user or the requesting computer.

### 7.2 Managing DB Fragments via a Master Node

Consider the simplest scenario: we have a single computer serves as the master node. There is a group of slave nodes. Each slave node has a fragment of the database, DB[i], i=1, . . . , N, with N being the number of slave nodes.

7.2.1 In searching

The master node:
1) Receiving a search request.
2) Send the same request to all the slave nodes.
3) Each slave node performs a localized search, on the DB fragment DB[i]. The score generated here has to be global.
4) The master node combines the search results, sorts them according to the hit scores, and presents the result to user.
5) In responding to user's request to individual hit, the master determines which DB[i] to retrieve the hit based on its ORIGINAL PRIMARY ID. The highlighting information for that specific hit is already available once the specific slave node is determined.

The slave node:
1) Receives a search request.
2) Searches its DB fragment.
3) Generate hit list, and send the result the master node.

The key here is how the DB is indexed. Each slave node contains the reverse index file that is just for the DB fragment. Yet, the itom distribution table has to be for the entire database. Only in this way, the scores computed can be sorted.

### 7.2.2 In Indexing

This configuration works for indexing as well. When a database comes in, the master node will distribute each slave node a DB fragment, let's say DB[i], i=1, . . . , N with N being the count of slave nodes. Each slave node indexes its DB[i] individually, generating an itom distribution table DB[i].itm, and a reverse index file DB[i].rev.

The itom distribution tables from all the slave nodes will be merged into a single table, with combined frequencies. This will be the DB.itm table. This table is then mapped back to individual slave nodes, thus generating a DB[i].itm.com (.com means combined). DB[i].itm.com contains the new itom frequency with the old itom ID. This table will be used together with the DB[i].rev for search and scoring.

### VIII. Itom Identification and Itomic-Measures

### 8.1 Definition of Itom

Word: a continuous string of characters without a word separator (usually, ““, space).

Itom: the basic information units within a given database. It can be a word, a phrase, or a contiguous stretch of words that satisfies certain selection criteria.

Itoms can be imported from external sources, for example, an external phrase dictionary or taxonomy. Any phrase in the dictionary or taxonomy, with a frequency >0 in the data corpus, can be an itom. Those itoms are imported itoms.

Itoms can be classified as single-word itoms, and composite itoms. The identification of single-word itoms is obvious. From here on, we will focus on how to identify composite itoms within a given database. We will use the following convention:
citom, or c-itom, candidate itom. Initially, it is just continuous n-words.
itom: citom that meets a certain statistical requirement, generated by the itomic identification program.

### 8.2 Itom Identification Via Associative Rules

Association analysis is a data mining concept, involving identifying two or more items in the large collection that are related. Association rules have bee applied to many areas. For example, in market basket analysis, given a collection of customer transaction history, we may ask if there is a tendency for customers who bought “bread” also tended to buy “milk” the same time. If yes, then, {bread}->{mild} would form an association. Besides market basket data, association analysis is applicable to many domains, particularly on online marketing, e.g. online book selling, online music/video selling, online move rental, etc.

Association analysis can also be used to identify relationship among words. In our specific case, association analysis can be used to identify the “stronger than random” association of two or more words in a data collection. Those associations, once passing a certain statistical test, can be viewed as candidate itoms. Of course, the association analysis can be applied to study not just associations of neighboring words. Association rules can be applied to find association of words within a sentence, or within a paragraph as well. We will only focus on applying association rules to itom identification here (e.g., association rules for neighboring words).

In addition to the association rule discovery methods we have outlined in Chapter 2 (minimum frequency requirement, ration test, percentage test, and Chi-square test), here we list a few of the most common association rules that can be used for itom identification. These methods may be used individually or in any combination for the purpose of identifying itoms for a data collection.

Here we give a brief outline of how to apply association rules to identify itoms. We will use the identification of 2-word itom as an example. As each of the word in the example can also be itoms, these methods can be used to identify itom of any length.

Problem: Given a word or itom, A, among all other words that is next to it, find the ones that have an identifiable association with A.

TABLE 8.1

| Word/Itom | B | Not_B | Total |
|---|---|---|---|
| A | f₁₁ = F(A + B) | f₁₀ = F(A + Not_B) | f₁₊ = F(A) |
| Not_A | f₀₁ = F(Not_A + B) | f₀₀ = F(Not_A + Not_B) | f₀₊ = F(Not_A) |
| Total | f₊₁ = F(B) | f₊₀ = F(Not_B) | |

Table 8.1. Table showing the association of two words (itoms) A and B: itoms. Not_A: an itom not starting with A. Not_B: an itom not ending with B. N: total number of two-itom associations. fᵢⱼ: frequency of observed events (1 stands for yes, and 0 for not). f₁₊: total count of phrases started with A. f₀₊: total count 2-word counts not starting with A.

Definitions:
Association Rule A->B: Word A tends to be followed by B.
Support of A->B: s(A->B)=f₁₁/N. A rule with low support may simply occur by chance. We eliminate all terms with too low support by removing f₁₊<5. Since f₁₁<f₁₊, we are keeping all rules with support >=5.
Confidence of A->B: c(A->B)=f₁₁/f₁₊. The higher the confidence, the more likely if if A happens, B will follow it.
Given a set of transactions, find all the rules having support >=min_sup and confidence >=min_conf, where min_sup and min_conf are the corresponding support and confidence thresholds.
Interesting factor of A->B, IF(A,B)=s(A->B)/[s(A)*s(B)]=N*f₁₁/(f₁₊*f₊₁)

$$IF ( A , B ) = \{ \begin{matrix}1 , if A and B is independent ( f 11 = f 1 + {}^{*} f + 1 / N ) \\ > 1 , if A and B positively correlated \\ < 1 , if A and B negatively correlated\end{matrix}$$

IS-measure: IS(A,B)=s(A->B)/sqrt[s(A)*s(B)]=cos(A,B)=f₁₁/sqrt(f₁₊*f₊₁)
Correlation coefficient: f(A,B)=(f11*f00−f01*f10)/sqrt(f1+*f+1*f0+*f+0)

$$f ( A , B ) = \{ \begin{matrix}0 , & if A and B is independent \\ ( 0 , 1 ] & if A and B positively correlated \\ [ - 1 , 0 ) & if A and B negatively correlated\end{matrix}$$

There are some known problems for using correlation coefficient to discover association rules: (1) the f-coefficient gives equal importance to both co-presence and co-absence of terms. It is our intuition, that when sample size is big, co-presence should be more important than co-absence. (2) It does not remain invariant when there are proportional changes in the sample size.

TABLE 8.2

| Measure | Definition |
|---|---|
| Correlation, φ | (f₁₁* f₀₀ − f₀₁*f₁₀)/sqrt(f₁₊*f₊₁*f₀₊*f₊₀) |
| Interest Factor, IF | N*f₁₁/(f₁₊*f₊₁) |
| Cosine, IS | f₁₁/sqrt(f₁₊ * f₊₁) |
| Odds ratio, α | f₁₁*f₀₀/(f₁₀*f₀₁) |
| Kappa, κ | [N*(f₁₁ + f₀₀) − f₁₊*f₊₁ − f₀₊*f₊₀]/(N² − f₁₊*f₊₁ − f₀₊* f₊₀) |
| Piatetsky-Shapiro, PS | f₁₁/N − (f₁₊* f₊₁)/N² |
| Collective strength, CS | (f₁₁ + f₀₀)/(f₁₊*f₊₁ + f₀₊ *f₊₀) *(N − f₁₊ *f₊₁ − f₀₊*f₊₀)/(N − f₁₁ − f₀₀) |
| Jaccard, ζ | f₁₁/(f₁₊ + f₊₁ − f₁₁) |
| All-confidence, h | min[f₁₁/f₁₊, f₁₁/f₊₁] |

Table 8.2. Common statistical methods for association rule discovery applicable to itom identification. Listed here are mostly symmetric statistical methods. There are other statistical methods, including asymmetric methods. There are not listed here.

### 8.3 Shannon Information (Shannon-Measure) for Each Itom

In computing the Shannon information amount for each itom, there are 2 alternatives, one is to use the non-redundant frequency (current case), or to use the frequency with redundancy.

SI_{—}1(a)=−log_{—}zf(a)/N

or

SI_{—}2(a)=−log_{—}zfr(a)/M

Where z is the base for the log. It can be “2” or any other number that is greater than 1. SI_{—}2 has the property:

SI_{—}2(a+b)>max (SI_{—}2(a), SI_{—}2(b))

which means that a composite itom should always has high information amount than its component itoms. This agrees with the perception about information of a certain proportion of people.

We can try either measure, and see if it produces differences in output ranking

### 8.4 Amplifying Shannon-Measure for Composite Itoms

In our studies, it appears the information amount assigned to phrases via Shannon measure is insufficient. We have designed pragmatic fixes to this problem. In one way, we apply a multiplication factor to all composite itoms. Assume si(A) stands for the Shannon measure for itom A. Then, for any given itom A,
S(A)=a*si(A), where a=1, if A is a single word. If A is a composite itom, then a >1.
   There are other alternatives as well. For example,

Alternative 1: Define a new measure S(A) by
i) S(A)=si(A), if A is a single word, si(A) is the Shannon info of word A.
ii) S(A+B)=[S(A)+S(B)]**β, where A, B are itoms, and β>=1.

This will guarantee for itom with many words to have a high score, e.g.:

$$\begin{matrix}S ( w 1 + w 2 + w 3 + w 4 ) >= S ( w 1 ) + S ( w 2 ) + S ( w 3 ) + S ( w 4 ) \\ = si ( w 1 ) + si ( w 2 ) + si ( w 3 ) + si ( w 4 ) .\end{matrix}$$

Alternative 2: For composite itoms, define a new measure S(A) by adding a constant increment to the Shannon measure for each additional word. Let's say, assign 1-bit of info for each additional word in the phrase (as the info amount for knowing the order of a+b). Thus,
i) S(A)=si(A) if A is a word;
ii) S(A+B)=si(A+B)+1. (si(A+B) is the Shannon score for phrase A+B)).
In this way, for an itom of length 40, we will have: S(phrase_{—}40_words)=si(phrase_{—}40_words)+39.

Alternative 3: Define
i) S(A)=si(A), if A is a single word, si(A) is the Shannon info of word A.
ii) if we have got all (<=n)-length itoms's score, calculate (n+1)-length itoms's score: max(sum(S(decomposed itom))*(1+f(n)), si(itom))
where f(n) is a function about itom-length or a const num.

In this way, for itom A+B, we have:
S(A+B)=max((S(A)+S(B))*(1+f(n)), si(A+B))

For itom A+B+C:(decompose to A+B, C), we have:

S(A+B+C)=max((S(A+B)+S(C))*(1+f(n)), si(A+B+C))

The rule used to decompose the itom is: sequential, non-overlapping.

There are other programmatic methods to fix the problem of insufficient scoring for composite itoms. Details are not provided here.

### IX. Boolean-like Searches and Structural Database Searches

### 9.1 The Need of Searching Structural Data

So far, we know that our search engine can search meta-data fields as well as the content text; it actually treats them uniformly with no distinction. In other words, we have no method to search the meta-data fields differently from that of the content fields. This is a serious limit. A user may want to see a certain word in the title specifically. In another example, how can I specify that a person's last name is “John”, not his first name? These questions lead us inevitably to the study of structural data. A structural data can be any format of data with structure. For example, the FASTA format we have used so far, containing the meta-data fields and the contents, is actually structural, because it has multiple fields. Structural data can be from XML files, from relational databases, and from object-oriented databases. By far, structural data from relational databases represent the largest collection these days.

The general theory of measuring informational relevance using itomic information amount can be applied to structured data with not much difficulty. In some aspects, application of the theory to structured data has even more benefits. This is because the structured data is more “itomic”, in the sense that the information is more likely at itomic level, and the relevancy of sequential order of these itoms are less important as in the unstructured data. Structured data can be in various forms, for example, XML, relational databases, and object-oriented databases. For the simplicity of description, we will focus only on structured data as defined in a relational database. The adjustment of theory developed here into measuring informational relevancy in other structural formats is obvious.

A typical table contains a primary id, followed by many fields that show the properties of the primary id. Some of these fields are “itomic” by nature, namely, they cannot be further decomposed. For example, the “last name” or “first name” field in a name list table cannot be break down further. Whereas other fields, for example, the “hobby” field may contain decomposable units. For example, “I like hiking, jogging, and rock climbing” contains many itoms within. Each field now will have its own cumulative of information, depending on the distribution function of the involved itoms. The distribution of the primary id field is a uniform one, giving each of the itom the maximum amount of information possible, while the first name field in a western country like US contain little information, compared to that in the last names.

Extending the itomic measure theory to database settings contains tremendous benefit. It will allow user to ask vague questions, or to over qualify a query. The question facing today's search to relational database is that the answers are usually either too long, or too short; and they all come back without any ranking With our approach, the database will give answers in a ranked list, based on the informational relevance to the question we ask. A user may choose to “enforce” certain restrictions, and leave other specifications as not “enforced”. For example, if one is looking for a criminal suspect within a personal database, he can specify as much as he knows, choose to enforce a few fields, such as his gender and race, and expect the search engine to return the best answers it can find in the data collection in a ranked way. We call this type of search Boolean-like informational relevance searches, or simply Boolean-like searches, to indicate 1) it has certain similarity to traditional Boolean searches; 2) it is a different method than Boolean. The search engine designed this way behaves more like a human brain than a mechanical machine. It values all the information input from a user, and does it best to produce a list of most likely answers.

### 9.2. Itoms in Structural Data

For a given field within a database, we can define a distribution, as we have done before, except the content is limited to only the content in this field (usually called a column in a table). For example, the primary_id field with N rows will have a distribution. It has N itoms, with each primary_id an itom, and its distribution function of F=(1/N, . . . , 1/N). This distribution has the maximal information amount for a given N number of itoms. For other fields, let's say, a column with list of 10 items. Then, each of these 10 items will be a distinct itom, and the distribution function will be defined by the occurrence of the items in the row. If a field is a foreign key, then the itom of that field will also be the foreign key themselves.

Generally speaking, if a field in a table has relatively simple entries, like numbers, one to a few word entries, then the most natural choice is to treat all the unique items as itoms. The distribution function associated with this column then is the frequency of occurrence of these items.

For the purpose of illustration, let's assume we have a table of journal abstracts. It may contain the following fields
Primary_id
Title
List of authors
Journal_name
Publication_date
Pages
Abstract

Here, the itoms for Primary_id will be the primary_id list. The distribution is F=(1/N, . . . , 1/N) where N is total number of articles. Journal_name is another field where each unique entry is an itom. Its distribution is F=(n₁/N, . . . , nₖ/N), where n₁, . . . nₖ are the number of papers from journal i(i=1, . . . , k) in the table, k is the total number of journals.

The itoms in the pages field is the unique page numbers appeared. To generate a complete list of unique itoms, we have to split the pages into individual ones. For example, pp 5-9, should be translated into 5, 6, 7, 8, 9. The combination of all unique page numbers within this field forms the itom list for this field.

For publication dates, the unique list of all months, years, and dates appeared in the database is the list of itoms. They can be viewed in a combination, or they can be further broken down into separate fields, i.e., year, month, and date. So, if we have Ny unique years, Nm unique months, and Nd unique dates, then the total number of unique itoms are: N=Ny+Nm+Nd. According to our theory, if we break the publication dates into three subfields, the cumulative information amount from these fields will be smaller compared to have all them in a single publication date field with mixed information about the year, month, and date. We can treat the author name fields similarly. The level of granularity on the content is really dictated by the nature of the data and the applications it has to support.

9.2.1 Field Data Decomposable into Multiple Itoms

For more complex fields, such as the title of an article, or the list of authors, the itoms may be defined differently. Of course, we can still define each entry as a distinct itom, but this will not be much helpful. For example, if a user wants to retrieve an article by using names of one author or the keywords within the title, we will not be able to resolve at itom level if our itoms are the complete list of unique titles and unique author lists.

Instead here we consider defining the more basic information units within the field as itoms. In the case of author field, each unique author, or each unique first name or last name can be an itom. In the title field, each word or phrase can be an itom. Once a field is determined to be complex, we can simply run the itomic identification program on the field content to identify itoms and generate their distribution function.

### 9.2.2 Distribution Function of Lone Text Fields

The abstract field is usually long text. It contains information similar to the case of unstructured data. We can dump the field text into a large single flat file, and then obtain the itom distribution function for that field as we have done before for a given text file. The itoms will be words, phrases, or any other longer repetitive patterns within the text.

### 9.3 Boolean-Like Search of Data in a Single Table

In Boolean-like informational relevance query, we don't seek exact matches of every field a user asks unless it is “enforced”. Instead, for every potential hit, we calculate a cumulative informational relevance score for the whole hit to a query. The total score from a query with matching in multiple fields is just the summation of information amount of matching itoms in each field multiplied by a scaling factor. We rank all the hit according to this score and report back to the user this ranked list.

Using the same example as before, suppose a user inputs a query:
Primary_id: (empty)
Title: DNA microarray data analysis
List of authors: John Doe, Joseph Smith
Journal_name: J. of Computational Genomics
Publication_date: 1999
Pages: (empty)
Abstract: noise associated with expression data.

The SQL for the above query would be:
select primary_id, title, list_of authors, journal_name, publication_date, page_list,
abstract from article_table where
title like ‘% DNA microarray data analysis %’
and (author_list like ‘% John Doe %’) and (author_list like=‘% Joseph Smith %’
and journal_name=‘J. of Computational Genomics’
and publication_date like ‘% 1999%’
and abstract like ‘% noise associated with expression data %’

The current keyword search engine will try to match each word/string exactly. For example, the words “DNA microarray data analysis” have all to appear in the title of an article. Each of the authors will have to appear in the list of author. This will make defining a query hard. Because the uncertainty associated with human memory, any specific information among the input fields may be wrong. What the user seeks is something in the neighborhood of the above query. If missing a few items, it is OK unless it is deemed “enforced”.

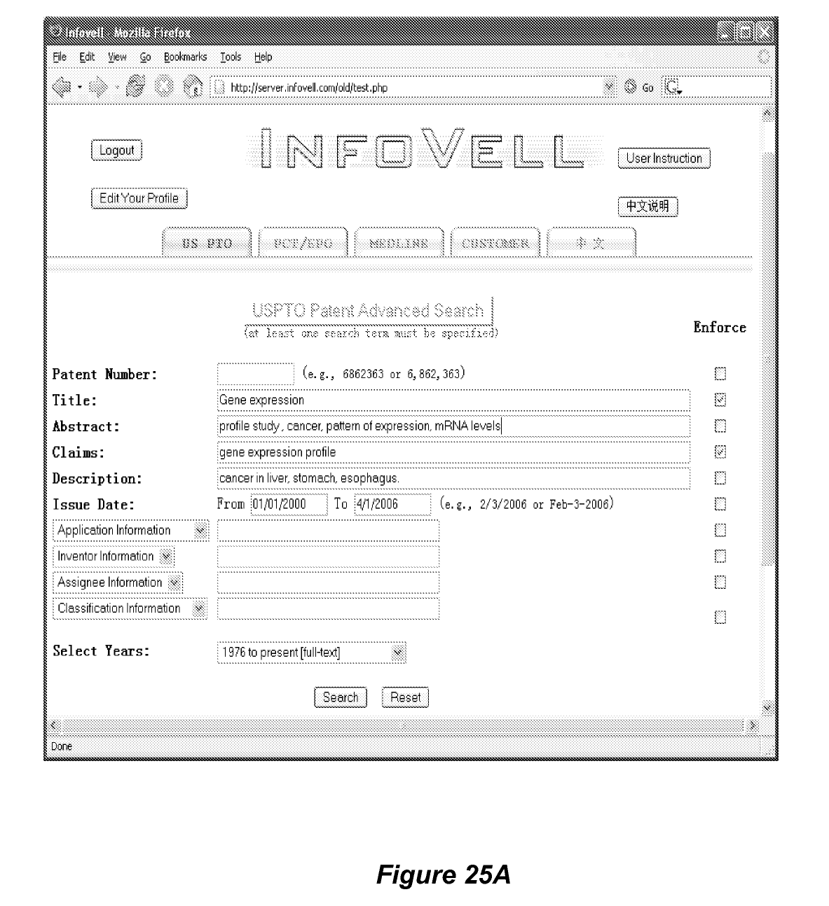

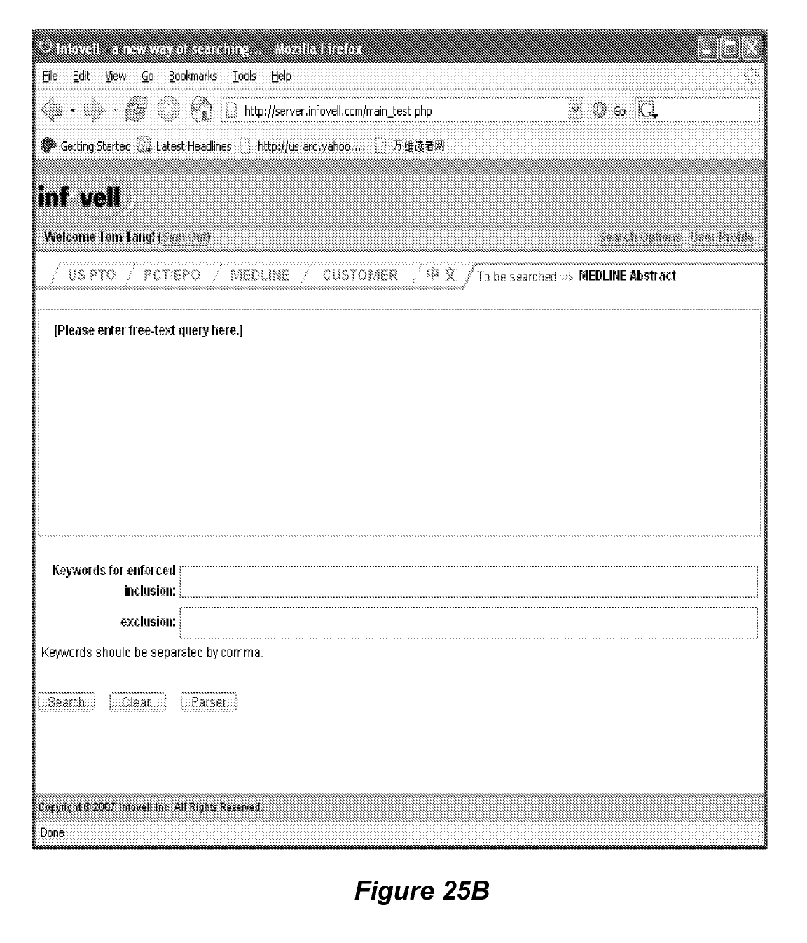

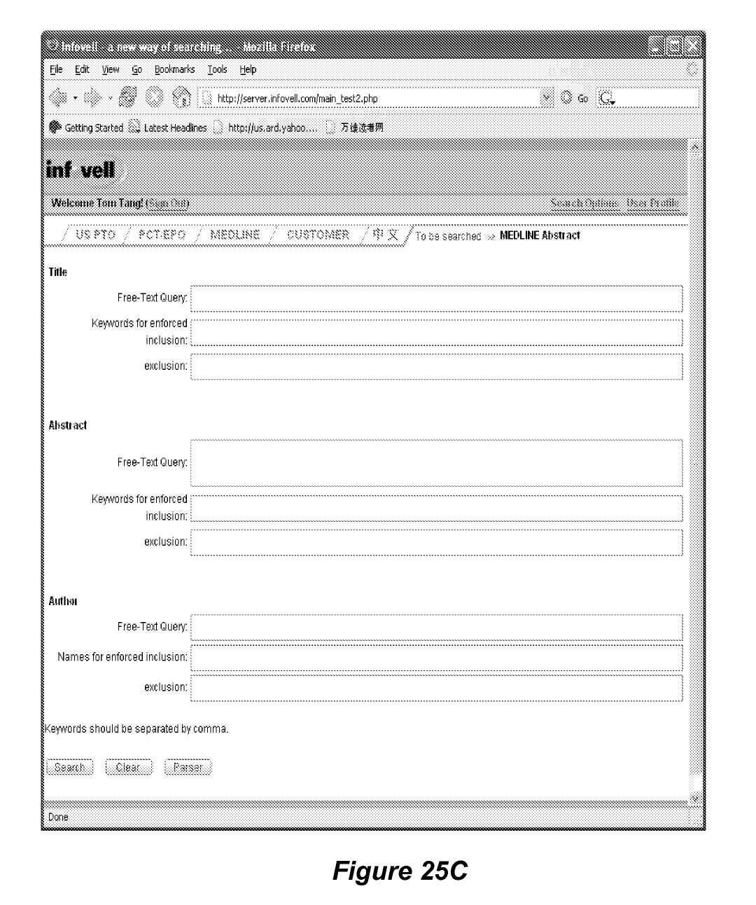

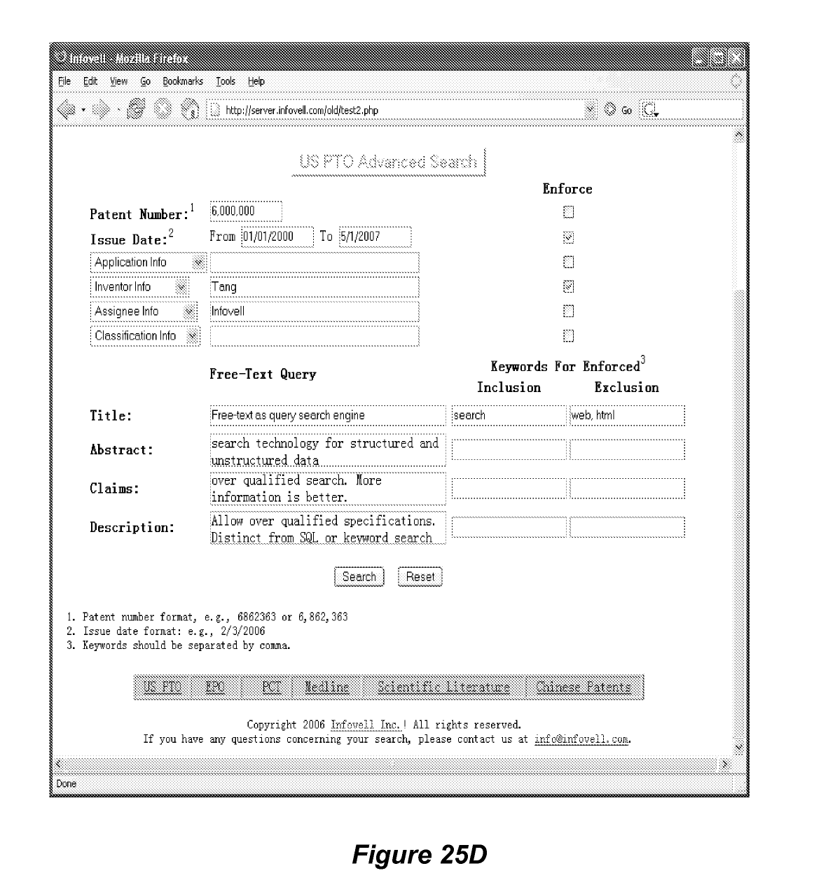

FIG. 25A. User interface for a Boolean-like search. User can specify information for each individual fields. On the right-most column, a user can choose whether to enforce the search terms. Once “Enforce” box is checked, the hits with matching requirement will be considered in the top list; and those that does not match the requirement for this field will be put into another list even they have high scores from other fields.

### 9.3.1 Ranking and Weighting of Individual Fields

In our search engine, for each primary_id, we will calculate an information amount score for each of the matching itoms. We then summarize all of the information amounts in individual fields for that primary_id. Finally, we rank all those with score above zero according to the cumulative information amount. The match in a field with more diverse information will likely contribute more to the total score then a field with little information. As we only count for positive matches, a few mismatches do not hurt at all. In this way, a user is encouraged to put as much information as he knows about the subject he is asking, without the penalty of missing any hits because of his submitting the extra information. In the mean time, if he is certain about certain information, he would have elected to “enforce” these fields.

A user may perceive certain fields to be more important than others. For example, typically a matching of an itom in the “title” field would be more significant than a matching of the same itom in the content field. We handle this kind of distinctions by applying a weight to each individual field, on top of the information measure computation for that field. Weight for each individual field can be predetermined based on a common consensus. In the mean time, such parameters will be made available to users to adjust at run time.

We break this hit list into two subsets: the one with the “enforced” fields fulfilled, and those with at least one of the “enforced” fields missed. We compute the score for the hits with violations the same way as we computed for those without any violation.

### 9.3.2 Result Delivering: Two Separated Lists

We can deliver two separated rank list, one for these with the “enforced” fields fulfilled; and one with at least one violation on the “enforced” fields. The second list can be delivered at a separate location of the return page, with a particular highlighting (such as “dim” the entire list, and use “red” color to mark the violated fields on the individual link page).

### 9.3.3 Implementation Concerns

Of course, this will be a CPU expansive operation, as we have to perform a computation for each entry (each unique primary_id). In implementation, we don't have to do this way. As itoms are indexed (inverted index file), we can generate a list of candidate primary_ids which contains at least one itom, or at least two itoms, for example. Another way of approximation is to define screening thresholds for certain important fields (fields with large information amount, for example, the title field, the abstract field, or the author field). Only candidates with at least one score in the selected fields above the screening thresholds will be further computed for the real score. As most of the user only cares the top-hits, we don't have to sort/rank extensively those distant hits with low scores (mostly very large lists).

In a typical relational database, most columns are associated with an index that speeds up the search of data in that column. In our search, we will make something similar. For each column X (or at least the important columns), we will have two associated tables, one called X.dist, and the other X.rev. In the X.dist table, it lists the itom distribution of this field. The X.rev is the reverse index for the itoms. The structure of these two tables is essentially the same to the case for a flat-file based itom distribution table and reverse index table.

In another option, we can have a single X.rev file for multitude of fields. We will have to insert one more specification to the content of the X.rev entries, namely the field information. The field information for an itom can be specified by a single ASCII letter. Whether to generate an individual inverted index file for each field, or whether to combine various fields to form a single inverted index is up to the implementer, and also depends on the nature of the data. One objective would be to reduce the size of the total index files. For example, for content-rich fields, we can use a single index file; and for those fields with limited contents; we can combine them together to generate a single index file.

### 9.4 Searching Structural Data Involving Multiple Tables

In most occasions, a database contends many tables. A user's query may involve information from many tables. For example, in the above example about a journal article, likely, we may have the following tables:

Article_Table
Article_id (primary)
Journal_id (foreign)
Publication_date
Title
Page_list
Abstract

Journal_Table
Journal_id (primary)
Journal_name
Journal address

Author_Table
Author_id (primary)
First_name
Last_name

Article_author
Article_id Author_id

When the same query is issued against this database, it will form a complex query where multiple tables will be involved. In this case, the SQL language is:
select ar.primary_id, ar.title, au.first_name, au.last_name, j.name, ar.publication_date,
ar.page_list, ar.abstract from article_table as ar, journal_table as j, author_table as au, article_author as aa
where ar.article_id=aa.article_id and ar.journal_id=j journal_id and
au.author_id=aa.author_id
and ar.title like ‘% DNA microarray data analysis %’
and (au.first_name=‘John’ and au.last_name=‘Doe’) and (au.first_name=‘Joseph’ and
au.last_name=‘Smith’
and j.name=‘J. of Computational Genomics’
and ar.publication_date like ‘%1999%’
and ar.abstract like ‘% noise associated with expression data %’

Of course this is a very restrictive query, and likely will generate zero or few returns. In our approach, we will generate a candidate pool, and rank this candidate pool based on the informational relevance as defined by the cumulative information amount of overlapped itoms.

One way to implement a search algorithm across multiple tables is via the formation of a single virtual table using the query that is directly tight to the User Interface. We first join all involved tables to form a virtual table with all the fields needed in the final report (output). We then run our indexing scheme on each of the field (itom distribution table and reverse index table). With the itom distribution tables and the reverse indexes, the complex query problem as defined here is reduced to the same problem we have solved for the single table case. Of course the cost of doing so is pretty high: for every complex query, we have to form this virtual table and perform the indexing step on the individual columns.

There are other methods to perform the informational relevance search for complex queries. One can form a distribution function and an inverted index for each important table field in the database. When a query is issued, the candidate pool was generated using some minimal threshold requirements on these important fields. Then the computation of exact score for the candidates can be calculated using the distribution table associated with each field.

### 9.5 Boolean-Like Searches for Free-Text Fields

There is need to perform Boolean-like searches on free-text fields as well. The requirement for such searches is that user can specify a free-text query, and in the mean time can apply Boolean logic to the fields. As our default operation logic is “OR” for all query terms, there is no need to implement that any more. (In reality, the “OR” operation we implemented is not strictly a Boolean “OR” operation. Rather, we screen out many of the low hits, and only kept a short list of high-scoring hits for the “OR” operation). In Boolean-like searches, we need to support “AND” and “NOT” (“AND NOT”) operations only. These operations can be operating on the unstructured text fields, or on each of the meta-data fields.

FIG. 25B shows an interface design to implement a Boolean-like search on an unstructured data corpus. A user can implicitly apply Boolean operations such as “AND”, and “NOT” in his query. Here, multiple keywords can be entered in the “Keywords for enforced inclusion” fields. All these keywords must appear in the hits. Multiple keywords can be entered in the “Keywords for enforced exclusion” fields. All of these keywords must not appear in the hits.

In implementation of such search, we first generate a hit list based on the free-text query, and compute an informational-relevance score for all of these hits. We than screen these hits using the keywords for enforced inclusion and enforced exclusion. Because, the enforced terms may exclude many hits, we need to generate a longer-list of candidate hits on the free-text query step for this type of searches.

FIG. 25B Boolean-like query interface for unstructured data. User can specify a free text (upper larger box). He can also specify keywords to be included or excluded. The inclusion keywords (separated by “,”) are supported by Boolean “AND” operations. The exclusion keywords are supported by Boolean “NOT” (e.g. “AND NOT”) operations. A qualified hit must contain all the enforced inclusion keywords, and none of the enforced exclusion keywords.

The Boolean-like searches can be expanded to text fields in semi-structured database or structured database search as well. For example, FIG. 25C gives a search interface for searching against a semi-structured database, where there are multiple meta-data fields such as Title, and Author of text type contents. The “Abstract” field is another text style field, which can benefit from “free-text” style of queries. A user can specify the free-text query to each of the fields, and can specify the enforced inclusion and enforced exclusion keywords in the same time.

FIG. 25C Boolean-like query interface for structured databases with text fields. User can specify a query text (upper larger box) to each of the text fields. He can also specify keywords to be included or excluded for each of these fields. The inclusion keywords (separated by “,”) are supported by Boolean “AND” operations. The exclusion keywords are supported by Boolean “NOT” (e.g. “AND NOT”) operations. A qualified hit must contain all the enforced inclusion keywords, and none of the enforced exclusion keywords in each of the text fields.

There are two distinct ways of implementing the above search, namely: 1) generate a rank list first and then eliminate unwanted entries; or 2) eliminate the unwanted entries first, and then generate a rank list. We will give outlines about the implementation for each method here.

### 9.5.1 Ranking First Algorithm

In search, all the free-text query information will be used to generate candidate hits. The hit candidate list is generated using all these query text itoms and a ranking based on the informational relevance measure within each text field, and across the distinct text fields. The implementation of the search will be the same as specified in Section 9.3, except we might want to generate a longer list, as many of the high-scoring hits may violate the additional constraints specified by the inclusion keywords and exclusion keywords for each of the text field. With a list of candidates in hand, we will screen them using all the enforced fields (via an operations of “AND” and “AND NOT”). All the candidates generated using the free-text queries will be screened against these “AND” fields. Only those left behind will be reported to the user, with a ranking based on the informational relevance measure the same way as specified in section 9.3.

From a computational point of view, this method is a little bit expansive. It has to compute the informational relevance values for many candidates, and eliminate them in the final stage. Yet, it has a very good side effect: if a user is interested to look at high-scoring hits with some violations of the enforced constraints, these hits are already there. For example, at the result page, some of the very high-scoring hits with violations of enforced constraints can be shown the same time, with an indicator that states the hit contains violations.

### 9.5.2 Elimination First Algorithm

In this approach, we will eliminate all the candidates that violate any of the enforced criteria first, and only compute relevance scores for the hits that have all the enforced fields fulfilled. The candidate list is shorter, hence computation-wise this method will be less expansive. The only short-coming of this approach is that the hits with violations, no matter how good they are, will not be visible in the result set.

9.6. Query Interface for Data with Itomic and Free-Text Fields

In real-world applications, the data nature can be quite complex. For example, a data collection may contain multiple fields of textual in nature, while also has data that are of specific types, such as dates, first name, last name, etc. We classify the data fields into two categories: itomic fields, and non-itomic fields, or free-textual fields (or just textual fields for short). In an itomic field, data can not be further decomposed; each entry is an itom. For free-textual fields, the entry can be further decomposed into component itoms. Both itomic fields and textual fields may be stored inside a relational database, or in table-format files.

For itomic field, in a query, we can either enforce or not enforce an itom. This type of query is shown in Section 9.3, and in FIG. 25A. For textual fields, we can specify a query with free query texts, and apply two additional constraints: the keyword list for enforced inclusion and enforced exclusion. These types of queries are covered in Section 9.5, and also in FIGS. 25B, 25C. Here, we will give out a more general search. We will consider the case where the field data falls into 2 categories: those of itomic in nature, and those of textual in nature. For itomic fields, user can enter query itoms, and specify whether to enforce it or not in query. For textual fields, user can enter free-text queries, and specify itoms for enforced inclusion or exclusion. The search result set will be ranked by informational relevance of all the query information, with all the enforced fields fulfilled.

FIG. 25D gives out one example of such a query interface, using the US PTO data content as an example. In this example, the Patent Number field, Issue date field, and the information fields for Application, Inventor, Assignee, and Classification, are all of itomic in nature. We provided the query boxes for the itomic entries, and provide a check box for “enforced” or “non-enforced” search, with default as “non-enforced”. On the other hand, the “Title”, “Abstract”, “Claim”, and “Description” fields are textual in nature. Here we provide a “free-text” query box, where a user can provide as much information as he likes. He can also specify a few keywords for “forced inclusion” or “forced exclusion”. The search results will be a ranked list of all the hits based on informational relevance, with all the forced fields fulfilled.

The implementation of this search is very similar to the outlines we give before. Namely, there are two approaches: either 1) generate a rank list first and then eliminate unwanted entries; or 2) eliminate the unwanted entries first, and then generate a rank list. There are no fundamental differences for the implementation of those search methods then the ones specified before. They are omitted here.

FIG. 25D. Advanced query interface to US PTO. The content data for a patent can be grouped into 2 categories: the itomic fields, and the textual fields. For itomic fields, user can enter query itoms, and specify whether to enforce it or not. For textual fields, user can enter free-text queries, and specify itoms for enforced inclusion or exclusion. The search result set will be ranked by informational relevance of all the query information, with all the enforced fields fulfilled.

### III. Clustering of Unstructured Data

### 10.1 Clustering Search Results

For the complex search needs today, simply providing search capacity is not sufficient. This is especially true if a user chooses to just use a few keywords to query. In such cases, the result set may be quite large (easily >100 entries), with hits all having similar relevancy scores. Usually the documents that one cares are scattered around within this set. It will be very time costly to go through them one-by-one to zoom into the few good hits. It will be nice if we can figure out how the hits are related to each other. This leads to the clustering approach, having the search engine organize the search results for you.

By clustering search results into groups, each around a certain theme, it really gives you a global view of how this data set is distributed, and likely it will point to a direction of your refined information need. We provide a unique clustering interface, where the search segments are clustered using advanced clustering algorithms that are distinct from traditional approach. We are unique in many aspects:
1) For simple queries, or for well-formatted semi-structural data, we can cluster the entire result set of documents. There is no specific restrictions on which clustering method, as most clustering algorithm will be easy to implement, for example, K-mean, or hierarchical methods. For distance measure, we use our itomic measure. The input to the clustering algorithms are the itoms and their informatic measure. The output is typical clusters or a hierarchy of documents. We provide laboring function to label individual clusters or branches, based on the significant itoms for that cluster or branch.
2) For complex queries, or for unstructured data set, we can cluster the segments in the hit return, not the documents. The segments are usually much smaller in content, and they are all highly related to the query topic user provided. Thus, we are clustering on unstructured data set for your search results. One does not have to worry about the homogeneity of the data collection. One will get clusters on segments of the data collections only of his interest.
3) Measuring distance in the conceptual space. The key toward clustering is how distance is measured in the information space. Most traditional clustering algorithms for textual data generate clusters based on shared words, putting the quality of these clusters into question. We perform clustering via a measure of conceptual distances, where the significance of single word matches is much reduced, and the complex itoms are weighted much higher.
4) Assigning unique names to each cluster that is the theme for that collection. The naming of a cluster is a tricky problem. Because we cluster around concepts instead of words, we can generate names that are meaningful, and very representative of the theme for the clusters. Our name label for each cluster is usually concise, and right to the point.

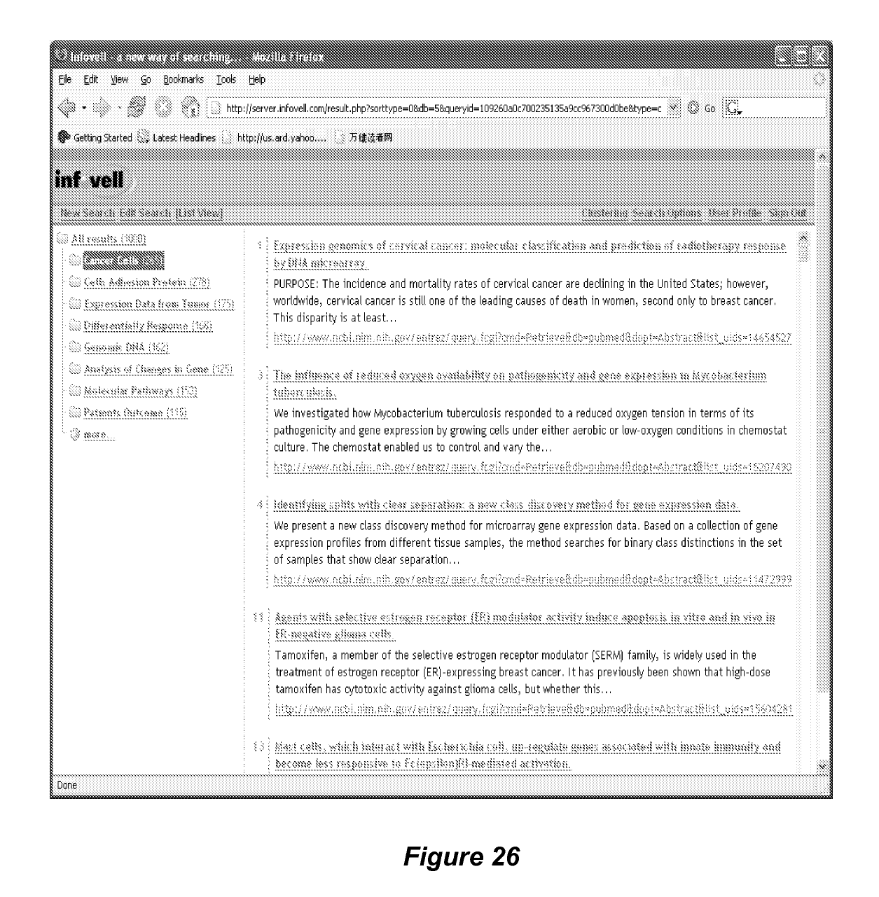

FIG. 26. Cluster view of search results. Segments from a search are passed through our clustering algorithm. Manageable clusters are generated around certain main themes. Each cluster is assigned a name that is tight closely to the main theme of that cluster.

### 10.2 Standalone Clustering

The information-measure theory for itoms we developed here can be applied to clustering documents as well, whether the document collection is semi-structured, or completely unstructured. This clustering may be stand-alone, in the sense it does not have to be coupled with a search algorithm. In the stand-alone version, the input is just a collection of documents.

We can generate the itom distribution table for the collection of corpus, the same we did for the search problem. Then, each itom is associated with an information-measure (a non-negative quantity), as we have discussed before. This information measure can be further extended into a distance measure (the triangle inequality has to be satisfied). We will called this distance measure the itomic distance. In the simplest occasion, the itomic distance between two documents (A,B) is just the cumulative information measure of the itoms that are not shared between the two documents (e.g., itoms in A but not in B, and itoms in B but not in A).

We can also define a similarity measure of the two documents, which are the cumulative information measure of the shared itoms divided by the cumulative information measure of itoms in A or in B.

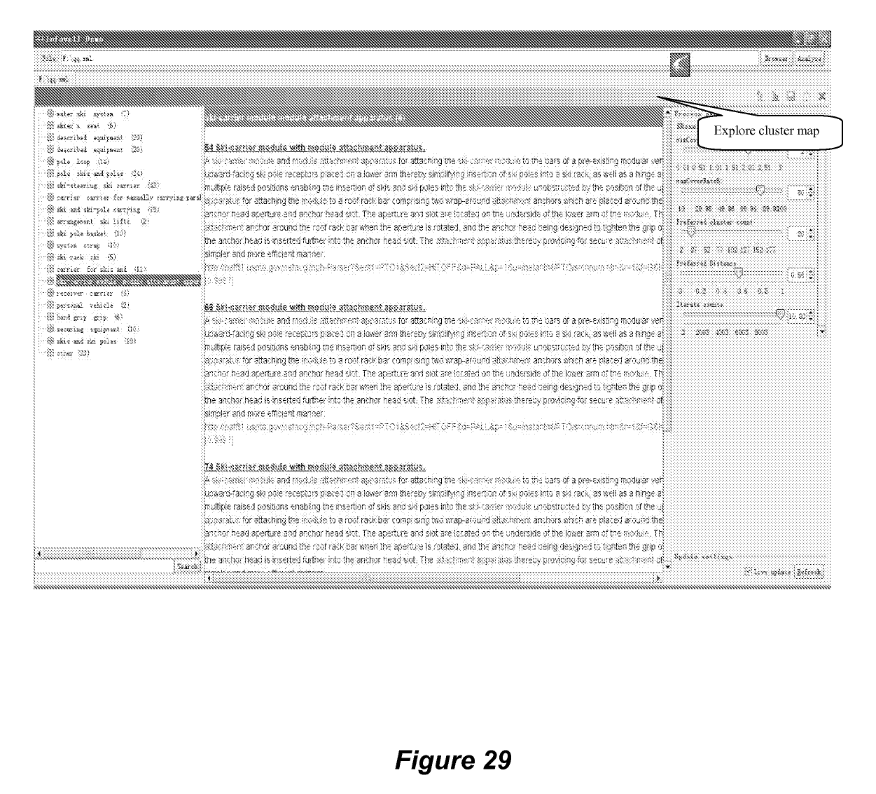

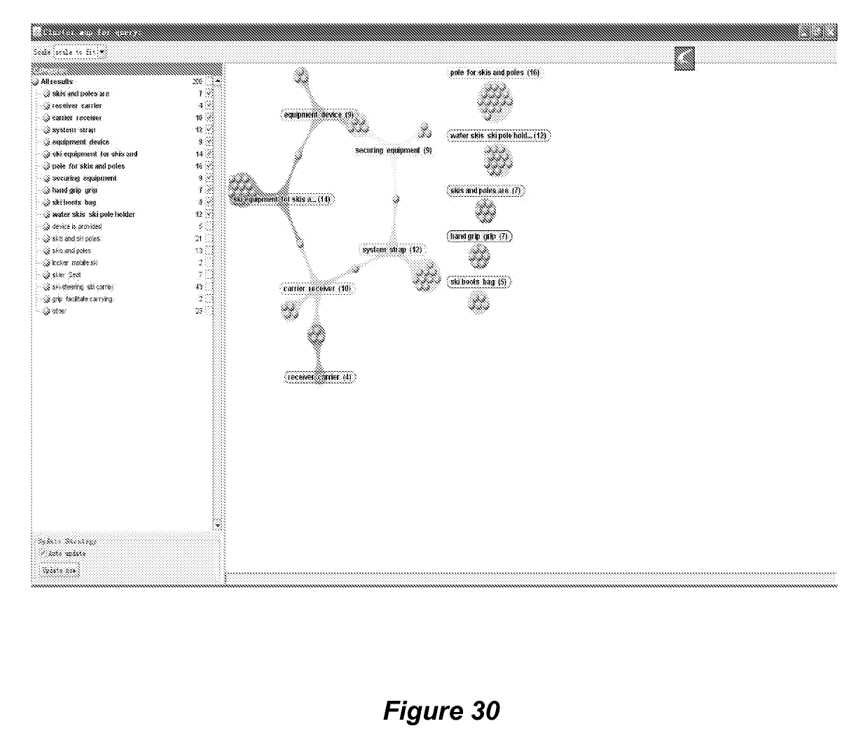

With the definition of distances and similarities, the classical clustering algorithms can all be applied. FIG. 29 shows the sample output from a simple implementation of such a clustering approach (K-mean clustering). In FIG. 30, we also give a graphic view of the inter-dependence of the various identified clusters. This is achieved via a modified K-mean algorithm, where a single document is classified into multiple clusters if there is a substantial information overlap between the document and the documents in that specific cluster. Labelling of each cluster is achieved via the identification of itoms that have the most cumulative information measure within the cluster.

FIG. 29. Output from a stand-alone clustering based on itomic-distance. Shown on the left panel are the individual clusters, with labeling itoms. One cluster is highlighted in blue. In the middle is the more detailed content of the highlighted cluster. On the right-most are the adjustable parameters for the clustering algorithm.

FIG. 30. Graphical display of clusters and their relationship. By click the explore cluster map button in FIG. 29 will pop up this window laying out the relationship of various clusters. Distinct clusters are joined together by colored lines indicating there are shared documents between those clusters. The shared documents are by a single dot in the middle where the two colored lines join.

The clustering algorithm can be extended to handle completely unstructured data content. In this occasion, we don't want to cluster at the document level, as documents may vary greatly in length. But rather, we want the clustering algorithm to automatically identify the boundaries of segments, and assign varies identified segments into distinct clusters.

We achieve this goal by introducing the concept of paging, and gap penalty. A page, is just a fragment of a document with a fixed-length that is provided. Initially, a long document is divided into multiple pages, with overlapping segments between neighboring pages (about 10%). We then identify the clusters of segments via an iterative scheme. In the first iteration, the input will be simply the short documents (with size less than or equal to the size of a page), plus all the pages from large documents. A typical clustering algorithm on this collection is completed. Now, we will have various clusters of short documents, plus various pages from long documents.

We then follow it by page merging step. In this step, pages can be merged. If a cluster contains multiple neighboring pages from the same document, the pages are merged with the redundant overlapping segment removed.

The 3rd step is a boundary adjustment step. Here a penalty is applied to all those non-contributing itoms for the cluster. Contributing itom for a cluster means they are shared by multiple documents and are essential in holding that cluster together. A threshold is identified in determining whether an itom is contributing or not, depending on its occurrence count in the documents/pages within this cluster, and the information measure of itself. In this way, we will adjust the boundaries inward, to segments. All the segments are deemed not in the clusters are returned back to the pool as individual document fragments. Document fragments can be merged if there are neighboring each other from the same document.

Now, we can perform the next iteration of clustering. The input will be all the clustered document fragments, and all the document fragments that does not belong to any cluster. We run the above process one more time, and the clusters, the boundaries for each document fragment will adjust.

We continue our iteration until 1) the algorithm converges, which means we have a collection of clusters that do not change in either the clusters or the boundaries of the clustered document fragments, 2) or stop after a pre-determined threshold or pre-determined number of iterations. In whatever the scenario, our output will be a cluster of document fragments.

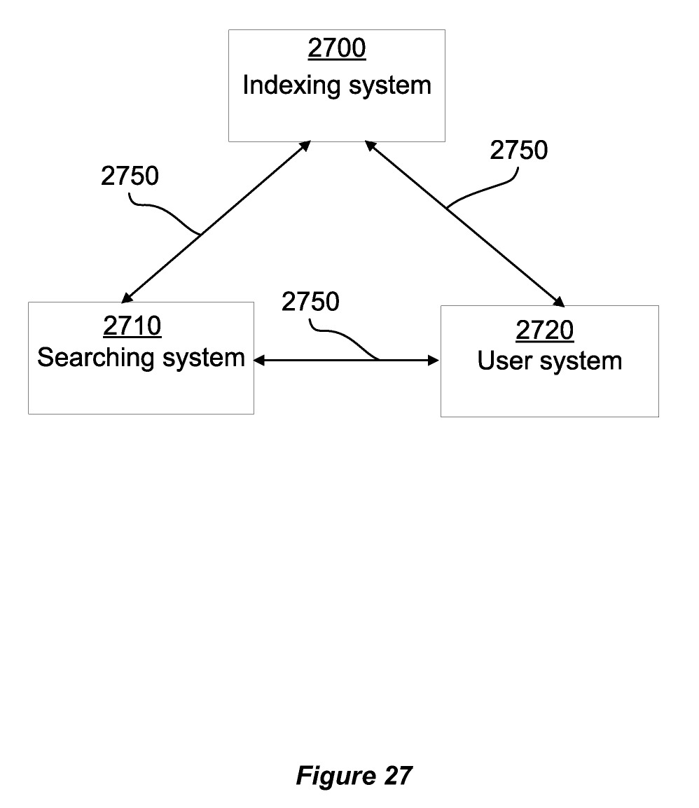

FIG. 27 illustrates a database indexing “system” 2700, searching “system” 2710, and user “system” 2720, all connectable together via a network 2750.

The network can include a local area network or a wide area network such as the internet. In one embodiment all three systems are distinct from each other, whereas in other embodiments the stated functions of two or all three of the systems are executed together on a single computer. Also, each “system” can include multiple individual systems, for example for distributed computing implementations of the stated function, and the multiple individual systems need not even be located physically near each other.

Each computer in a “system” typically includes a processor subsystem which communicates with a memory subsystem and peripheral devices including a file storage subsystem. The processor subsystem communicates with outside networks via a network interface subsystem. The storage subsystem stores the basic programming and data constructs that provide the functionality of certain embodiments of the present invention. For example, the various modules implementing the functionality of certain embodiments of the invention may be stored in the storage subsystem. These software modules are generally executed by the processor subsystem. The “storage subsystem” as used herein is intended to include any other local or remote storage for instructions and data. The memory subsystem typically includes a number of memories including a main random access memory (RAM) for storage of instructions and data during program execution. The file storage subsystem provides persistent storage for program and data files, and may include a hard disk drive, a floppy disk drive along with associated removable media, a CD ROM drive, an optical drive, or removable media cartridges. The memory subsystem in combination with the storage subsystem typically contain, among other things, computer instructions which, when executed by the processor subsystem, cause the computer system to operate or perform functions as described herein. As used herein, processes and software that are said to run in or on a computer, or a system, execute on the processor subsystem in response to these computer instructions and data in the memory subsystem in combination with the storage subsystem.

Each computer system itself can be of varying types including a personal computer, a portable computer, a workstation, a computer terminal, a network computer, a television, a mainframe, or any other data processing system or user device. Due to the ever changing nature of computers and networks, the description of a computer system herein is intended only as a specific example for purposes of illustrating the preferred embodiments of the present invention. Many other configurations of a computer system are possible having more or less components than the computer system described herein.

While the present invention has been described in the context of a fully functioning data processing system, those of ordinary skill in the art will appreciate that the processes described herein are capable of being stored and distributed in the form of a computer readable medium of instructions and data and that the invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system. A single computer readable medium, as the term is used herein, may also include more than one physical item, such as a plurality of CD-ROMs or a plurality of segments of RAM, or a combination of several different kinds of media.

As used herein, a given signal, event or value is “responsive” to a predecessor signal, event or value if the predecessor signal, event or value influenced the given signal, event or value. If there is an intervening processing element, step or time period, the given signal, event or value can still be “responsive” to the predecessor signal, event or value. If the intervening processing element or step combines more than one signal, event or value, the signal output of the processing element or step is considered “responsive” to each of the signal, event or value inputs. If the given signal, event or value is the same as the predecessor signal, event or value, this is merely a degenerate case in which the given signal, event or value is still considered to be “responsive” to the predecessor signal, event or value. “Dependency” of a given signal, event or value upon another signal, event or value is defined similarly.

As used herein, the “identification” of an item of information does not necessarily require the direct specification of that item of information. Information can be “identified” in a field by simply referring to the actual information through one or more layers of indirection, or by identifying one or more items of different information which are together sufficient to determine the actual item of information. In addition, the term “indicate” is used herein to mean the same as “identify”.

The foregoing description of preferred embodiments of the present invention has been provided for the purposes of illustration and description. It is not intended to be exhaustive or to limit the invention to the precise forms disclosed. Obviously, many modifications and variations will be apparent to practitioners skilled in this art. In particular, and without limitation, any and all variations described, suggested or incorporated by reference in the Background section of this patent application are specifically incorporated by reference into the description herein of embodiments of the invention. The embodiments described herein were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

What is claimed is:

1-100. (canceled)

101. A method for searching a database, for use with a data processing system, comprising the steps of:
the data processing system developing a plurality of preliminary queries in dependence upon a provided first query, each of preliminary queries identifying itoms to search for, all the itoms identified by each of the preliminary queries to search for being identified by the first query, and at least two of the preliminary queries differing from each other;
the data processing system forwarding the preliminary queries to a set of at least one external search engine, each combination of a preliminary search query and an external search engine yielding a respective set of preliminary hits; and
identifying to a user at least one of the hits returned from at least one of the preliminary queries.

102. A method according to claim 101, wherein the step of the data processing system developing a plurality of preliminary queries comprises the steps of:
identifying a plurality of itoms in the first query;
selecting a subset of the plurality of itoms in dependence upon an information measure of the itoms; and
selecting keywords for each of the preliminary queries from the itoms in the subset.

103. A method according to claim 102, wherein the step of selecting a subset of itoms comprises the step of selecting a predetermined number of the highest information measure itoms from the plurality of itoms.

104. A method according to claim 102, wherein the step of selecting keywords comprises the steps of selecting a respective particular number of the keywords for each of the preliminary queries randomly.

105. A method according to claim 101, for use with a first list of itoms each having an associated information measure, further comprising the steps of:
enhancing the information measures associated with itoms in the first list in dependence upon the frequencies of appearance, in the hits returned from the preliminary queries, of the itoms in the first list; and
ranking the hits returned from the preliminary queries in dependence upon the enhanced information measures.

106. A method according to claim 105, further comprising the step of enhancing the first list of itoms with itoms in the hits returned from the preliminary queries and not previously in the first list.

107. A method according to claim 101, wherein at least two of the eternal search engines differ from each other.

108-113. (canceled)

114. A method according to claim 101, wherein one of the preliminary queries is a preliminary Boolean search query.

115. A method according to claim 101, wherein a first one of the preliminary queries includes at least one compound itom having more than one token,
further comprising the step of returning, as hits returned from the first preliminary search query, entries in the database which each include at least one of the compound itoms.

116. A method according to claim 115, further comprising the steps of:
detecting, for each particular one of the hits generated from the first preliminary query, which of the preliminary itoms are shared by the 1^{st} preliminary query and the particular hit; and
ranking the hits generated in the first preliminary search in dependence upon an information measure of the shared itoms determined in the step of detecting.

117. A method according to claim 101, wherein the step of developing a plurality of preliminary queries comprises the steps of:
selecting a proper subset of the itoms in said first query in dependence upon a relative information measure of the itoms in said first query; and
developing a first one of the preliminary queries in a manner that considers itoms in the subset and ignores the itoms not in the subset.

118. A method according to claim 117, wherein the step of forwarding the preliminary queries comprises the step of forwarding to an external search engine itoms in the subset and not itoms not in the subset.

119. A method according to claim 101, wherein the step of developing a plurality of preliminary queries comprises the steps of:
selecting a subset of the itoms in said first query in dependence upon a relative information measure of the itoms in said first query; and
developing each of the preliminary queries in a manner that considers itoms in the subset and ignores the itoms not in the subset.

120. A method according to claim 101, further comprising the step of ranking the hits returned from the preliminary queries in a way that favors hits in which the sequence in which shared itoms appear in the hit matches the sequence in which the shared itoms appear in one of the preliminary queries.

121. A system for searching a database, comprising:
a memory subsystem; and
a data processor coupled to the memory subsystem, the data processor configured to:
develop a plurality of preliminary queries in dependence upon a provided first query, each of preliminary queries identifying itoms to search for, all the itoms identified by each of the preliminary queries to search for being identified by the first query, and at least two of the preliminary queries differing from each other;
forward the preliminary queries to a set of at least one external search engine, each combination of a preliminary search query and an external search engine yielding a respective set of preliminary hits; and
identify to a user at least one of the hits returned from at least one of the preliminary queries.

122. A system according to claim 121, wherein development of a plurality of preliminary queries comprises:
identifying a plurality of itoms in the first query;
selecting a subset of the plurality of itoms in dependence upon an information measure of the itoms; and
selecting keywords for each of the preliminary queries from the itoms in the subset.

123. A system according to claim 122, wherein selecting a subset of itoms comprises selecting a predetermined number of the highest information measure itoms from the plurality of itoms.

124. A system according to claim 121, for use with a first list of itoms each having an associated information measure, wherein the data processor is further configured to:
enhance the information measures associated with itoms in the first list in dependence upon the frequencies of appearance, in the hits returned from the preliminary queries, of the itoms in the first list; and
rank the hits returned from the preliminary queries in dependence upon the enhanced information measures.

125. A system according to claim 124, wherein the data processor is further configured to enhance the first list of itoms with itoms in the hits returned from the preliminary queries and not previously in the first list.

126. A system according to claim 121, wherein at least two of the external search engines differ from each other.

127. A system according to claim 121, wherein one of the preliminary queries is a preliminary Boolean search query.

128. A system according to claim 121, wherein a first one of the preliminary queries includes at least one compound itom having more than one token,
and wherein the data processor is further configured to return, as hits returned from the first preliminary search query, entries in the database which each include at least one of the preliminary itoms.

129. A system according to claim 128, wherein the data processor is further configured to:
detect, for each particular one of the hits generated from the first preliminary query, which of the preliminary itoms are shared by the 1^{st} preliminary query and the particular hit; and
rank the hits generated in the first preliminary search in dependence upon an information measure of the shared itoms detected.

130. A system according to claim 121, wherein the development of a plurality of preliminary queries comprises:
selecting a subset of the itoms in said first query in dependence upon a relative information measure of the itoms in said first query; and
developing a first one of the preliminary queries in a manner that considers itoms in the subset and ignores the itoms not in the subset.

131. A system according to claim 130, wherein forwarding the preliminary queries comprises forwarding to an external search engine itoms in the subset and not itoms not in the subset.

132. A system according to claim 121, wherein the development of a plurality of preliminary queries comprises:
selecting a proper subset of the itoms in said first query in dependence upon a relative information measure of the itoms in said first query; and
developing each of the preliminary queries in a manner that considers itoms in the subset and ignores the itoms not in the subset.

133. A system according to claim 121, wherein a first one of the queries requires the sequence in which shared itoms appear in the hit to match the sequence in which the shared itoms appear in the first query.
